(19) United States
(12) Patent Application Publication
(10) Pub. No.: US 2020/0167631 A1
(43) Pub. Date: May 28, 2020

(54) Human-Robots: The New Specie

(71) Applicant: Sana Rezgui, San Francisco, CA (US)

(72) Inventor: Sana Rezgui, San Francisco, CA (US)

(73) Assignee: AZ, LLC, San Francisco, CA (US)

(21) Appl. No.: 16/575,696

(22) Filed: Sep. 19, 2019

Related U.S. Application Data
(60) Provisional application No. 62/733,610, filed on Sep. 19, 2018.

(51) Int. Cl. G06N 3/00; H02J 7/00; B25J 9/16; B25J 9/00; G05B 19/04; G06K 9/00; H02J 7/34; G10L 15/22; B25J 11/00; G06F 8/30

(52) U.S. Cl. CPC G06N 3/004; G05B 2219/40195; B25J 9/1671; B25J 9/0084; B25J 9/0006; G05B 19/041; B25J 9/1669; G06K 9/00288; G06K 9/00892; H02J 7/342; G10L 15/22; B25J 9/0003; B25J 11/0015; G06F 8/30; B25J 9/1689; B25J 11/001; B25J 9/161; B25J 11/008; B25J 9/1697; G05B 2219/40202; G05B 2219/40324; G05B 2219/40391; H02J 7/0068

(57) ABSTRACT

Higher demands for adaptable, scalable and automated human resources, capabilities and services, such as human well-being, safety and security, universal health care system and educational institutions, are growing in our societies, leading the way to the creation of a new artificially-intelligent support system that can facilitate the lives of the many. The current invention aims to help resolve such issues by offering a relief system that uses a new robotic specie, called Human-Robots (HRs) and that are intended to improve the quality of our lives in terms of education, health-care, well-being, safety and security. The new specie may autonomously work and move in close proximities with and among HBs and within their natural environments, to share their workloads and tasks and is especially tuned to their well-beings and of their surroundings. The robotic specie is reliant on a standard reconfigurable system and platform that can take multiple shapes, be modular, incremental, scalable, mobile, intelligent, connected, social, and possibly fully-autonomous. The new HR society will form the new race of autonomous personal and public service providers and take part in our society as a new specie.

### CROSS REFERENCE TO RELATED APPLICATIONS

The application claims priority to six U.S. (provisional, non-provisional and issued) patents and applications:
21, Human-Robots: The New Specie, provisional application No. 62/733,610, Sana Rezgui, AZ, LLC, filed on Sep. 19, 2018.
22. Remote Sensing and Probing of High-Speed Electronic Devices, Patent number: US10041992B2, Sana Rezgui, AZ, LLC, Filed: Mar. 15, 2017, Granted on Aug. 7, 2018. This patent is referred to Remote Technology throughout the patent documentation.
23. Continuation Patent: Remote Sensing and Probing of High-Speed Electronic Devices, Patent number: US10041992B2, Publication number: 20180328982, Sana Rezgui, AZ, LLC, Filed: Jul. 2, 2018, Continuation Date: Nov. 15, 2018. This patent is referred to Remote Technology throughout the patent documentation.
24. Automatic Generation of Documentary Content, Patent number: US10152462, Sana Rezgui, AZ, LLC, Filed: Mar. 3, 2017, Granted on Dec. 11, 2018.
25. Automatic Generation of Documentary Content, Patent number: 20190073343. Sana Rezgui, AZ, LLC, Filed: Nov. 5, 2018, Published on Mar. 7, 2019, Pending Review.
26. Virtualization, Visualization and Autonomous Design & Development of Objects, Patent number: 20180089349, Sana Rezgui, AZ, LLC, Filed: Nov. 20, 2017, Pending Review

The entirety of their contents herein incorporated.

### BACKGROUND

Higher demands for adaptable and scalable human resources, capabilities and services, such as human well-being, safety and security, universal health care system and educational institutions, are growing in our societies. For instance, largely populated metropolitan cities are overwhelmed with high numbers of school-dropouts due to increased tuition-costs, overpopulated classes and the lack of parents availability to monitor and help their children's growth and progress. Additionally, with growing populations, further increases in workers' responsibilities, duties, workloads and hence stress levels have become quite noticeable, leading the way to new requirements for artificially-intelligent support system that can facilitate the lives of the many.

The current invention aims to help resolve such issues by offering a relief system that uses a new robotic specie, intended to improve the quality of life for human beings (HBs) in terms of education, health-care, well-being, safety and security. The new specie will autonomously work and move in close proximities with and among HBs and within their natural environments, to share their workloads and tasks and is especially tuned to their well-beings and of their surroundings (animals and nature); they are called Human-Robots (HRs). The new HR society will form the new race of personal and public service providers. They can be everywhere and anywhere to fulfill every task that a combination of HBs and robotic systems can accomplish if they are given autonomy, free-movement, strength, and know-how.

Human-robots have been a fiction in various Hollywood movies, and yet and to our knowledge, never available on the commercial market and certainly not considered as an autonomous specie that can be employed and deployed, while moving, behaving and acting individually or collectively, similarly to human-beings. The HR concept and work force are novelties in our industry; they are the combination of humans and robots, which enables them to communicate, interact and co-exist safely with one another, humans and machines in an efficient and unprecedented manner. Ultimately, the HRs will be able to autonomously operate, communicate and interact with every being on this planet, including animals and machines, wirelessly or physically when these machines are not connected to the network or inaccessible to HBs. For instance, a single or multiple HR(s) may drive a workforce of HR-cleaners to clean an entire building in Tunis, while being in San Francisco; a single or multiple HR(s) or HB(s) that are equipped for instance with virtual augmented reality glasses may connect with a single or multiple Astronaut-HR(s) and experience walking on another planet while physically be on planet earth. The cleaners will use, share and coordinate the available cleaning materials in the building. HRs' key novelties are in their super human/machine qualities such as their capabilities in understanding and communicating with every human-sense, fly, dissociate its parts, compute way faster and move freely and better than any HB or animal. The main novelty is in the combination of limitless capabilities that makes it a super human-being and an extraordinary machine, such as mobility, agility, intelligence, extended/limitless visibility and listening powers throughout connectivity, etc. It takes the best of both worlds, as if it is attaching a sole to a super-robot.

### BRIEF DESCRIPTION OF THE DRAWINGS

FIG. 1 depicts an example of an HR that resembles a human-body and that is consistent with various embodiments as described herein;

FIG. 2 shows a proposed block diagram for the generalized operation of a distributed human robot group that is consistent with various embodiments as described herein;

FIG. 3 shows an overview block diagram of the remote technology implementation for the generalized operation of the AZ, LLC test, measurement and instrumentation equipments and the inherent technology for the distributed communication within an HR and among the HRs that is consistent with various embodiments as described herein;

### DETAILED DESCRIPTION OF THE INVENTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may be entirely hardware embodiments, entirely software embodiments, or embodiments combining software and hardware aspects. The following detailed description should, therefore, not be limiting.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

1. HR Overview and Definition

An HR is autonomous, independent, connected, highly-communicative, versatile, mobile, relentless and highly efficient without being overly consuming, needing maintenance or special planning. It may take the shape of an HB, an animal, a vegetation, a machine (smart-device, computer, fridge, bicycle, etc.) that acts autonomously and reliably. An HR may fulfill most of the HBs' jobs or a combination of them simultaneously or orderly. It can be a one-time paid worker for 10s of years, with services that may be public, private and/or personal. It can be a house-keeper, a masseuse, a body-guard, a nanny, a teacher, a care-giver, a healer, a stylist, a hair-dresser, a helper, a parent, a trainer, a friend, a psychiatrist, a personal-doctor, an accountant, a cook, an artist, an entertainer, a companion, a transporter, a comforter, a volunteer, a sanitation agent, an architect, a craftsman, a technician, a life-manager, a secretary, a lawyer, a servant and fulfill any job-function that has extraordinary qualities and capabilities and yet pet qualities, so personal, friendly, loving, caring and supportive. An HR may make HBs feel secure, safe, cherished, be-friended, appreciated, understood, supported, helped, not-stressed, connected, entertained, cared for, relaxed and loved.

It can take various shapes, such as those of HBs, animals, robots, machines, etc. It can also change shapes programmatically, automatically or autonomously, given its job function, current role and/or duties.

Although the implementation of this new technology may be reliant and inspired from various already available parts and technologies that are existent and readily available on the market, such as the security and surveillance cameras, various artificial intelligence (AI) and machine learning (ML) technologies, it is inherently and technologically different as it requires miniaturization, extreme adaptability, agility and a unique combination of various electromechanical technologies. Some technology examples may be displayed in the smart devices, the robotics, the clouds/data-centers, the unmanned transportation technologies (drones and the self-driving cars) as well as the Internet of Things (IoTs) applications.

For instance, the current IoTs and smart-devices are immobile, not autonomous and especially not human to be able to react and interact with HBs, animals and nature. Drones and existing robotic-technologies are mobile but cannot transport, deliver goods, nor interact with HBs in their natural environments such as their homes and offices. The HR society represent the next generation of modern computer/IoT/cloud/robotic/connectivity/communication/network and autonomous technologies all in one. HRs may be empowered with legs to walk, arms to hug, a brain to think, a skin to touch and breath, feel and self-charge, and wings to fly; they can be super-humans with extraordinary connectivity and communication skills with the outside world.

An HR may fulfill a single or a combination of tasks as a well-versatile personal helper, and yet be affordable. The new technology will change the industry, the society and the course of science. Hence the main objective of this invention which consists in the design of the new HR specie that may look like us and yet be so different from us. An HR is not the reproduction of an HB nor animals, although it can mimic most of the HB and animal shapes, behaviors, reactions and perfectly interact with others without causing harm to its surroundings. The HRs may learn and mimic every being behavior and co-exist with its surroundings (HBs, animals, nature, objects). It does not have a gender but it can be an it, a she, a he, a we, and a they. The HRs may interact with The Human-Being, be part of the The family, The community, The government, The industry and the society in general, simply whoever needs a helping hand and exceptional portfolio of super-natural capabilities.

HRs may provide personal care and support system that is needed by everybody, but at different degrees and at different stages of our life and may continuously grow and adapt to our needs. Our goal is to enable all of us to have what most of us don't or cannot have, a great quality of life. For simplification purposes, we may refer to the HR by it, he, she, we or they; they are all interchangeably used.

Because of the limitless predicted HR capabilities and its expected growth among societies and industries, its standardization and regulation are mandatory, hence the creation of a new standard HR system and platform that can interact with HBs, animals, machines, etc. The latter allows the communication and the (re)configuration of the various HR-modules by means of a software development kit (SDK) that is app-based. The communication with the HRs is also enhanced with a graphic user interface (GUI) that controls and monitors the various functions of the HRs. As in most realms of the connected world, standardization, regulation, optimization and security solutions for the newly anticipated species to enable and protect this world-changing creation are paramount, mandatory and should be carefully planned. Although it is greatly inspired from existing creatures and particularly the human race, an HR is not an HB clone, nor a robot; it is a human-robot with duties and rights, capabilities and limitations, human/animal-like feelings and emotions, which sets it apart from robotic manufacturing machines and qualifies it for a new specie. An HR will aim though to learn and understand from all of its surroundings to grow, survive, mature and one day to pass the torch to another HR (task or data-transfer from the cloud or others). It will seek to regroup, team up, ally to further help, preserve and protect all of its surroundings.

There is no one-size-fits-all technology to accomplish the HR concept, however and similarly to most connected technologies, all HRs share a set of goals and common features, such as a secure communication, privacy and connectivity with others, safe operation (good health) and a moral code to set boundaries, rules and ambitions, and a set of duties and rights to have. The ensemble of these settings will be included in a guideline that will be known as the regulation and the standardization user-guide in the HR society. Investments in the IoT and the robotics technologies are currently only a small fraction of what is needed to create this new world to allow the creation of the expected exponentially growing volume of diverse devices and data sets that will populate the world of HRs. HBs will face a host of questions as they implement the new society to collect, help, aggregate, store, analyze, and communicate with the outside world, that could change our lifestyle and our society. The creation of efficient and secure HRs will be critical not just because they will form the foundation of HR interactions with the outside world but because the criticality of their mission that could impact and change the human society and the human behavior. The HR existence is intertwined with the planet earth, the universe and their habitants basic existence, safety and well-being, a concept that is a daunting challenge while being a promising opportunity if well-sought, planned, and executed.

Hence the main goal of this invention is to define, describe and demonstrate the technical feasibility of a standard HR that can be programmed, trained and taught (through existing and novel artificial-intelligence (AI) and machine-learning (ML) techniques) to become artificially and/or intuitively intelligent so it can perform a single or multiple jobs at once, become the nature advocate, the animal protector and the HB reasonable mind or possibly its better half. An example of HR that is intuitively intelligent (II) will comment on beautiful scenes even when not specifically asked to, and may say different expressions every-time even when seeing over and over the same scene. It is a spontaneous reaction with an entirely random outcome, hence the name of intuitive intelligence, genuine intelligence (GI) and natural intelligence (NI).

This invention will provide understanding and insights on key elements necessary for the creation of an HR, the standardization of its major tasks, and the path to its production and manufacturing. It will also provide important insights and tools to employ along the HR creation, development and deployment that are tailored to the new society life style and needs. For instance, the HRs may never engage in situations that they don't understand nor in the ones that they cannot predict the range of their outcomes. They continuously act with calculated risk. An HR are incapable of doing the wrong thing, such as causing harm, hurt physically or emotionally to others (HBs, objects, other HRs, nature, and/or others).

2. The Value Proposition

Because of the anticipated close proximities, interactions and predicted great-impacts of HRs on their environment, the former may have the opportunity to change our world, push us further and enable us to accomplish more than we ever can do in a lifetime. We identify two major benefits: 1) to the society in general, and 2) to the industry and the economy in particular. Both benefits are intertwined and one may greatly affect the other; for instance, a healthier economy may lead to a healthier society and vice-vera. The current invention may create and replace a few jobs but will strengthen, enable and employ more of us to plan, act and work collectively to teach, train, code and deploy these HRs, such as a better health care and educational systems. The following will highlight examples of the main identified value propositions of this new innovation. Additional benefits may be deduced and drawn from these examples.
1. Value propositions for the Society, the HR(s) may fulfill a single or a combination of the following jobs to provide the HBs with:
   1. Safety, security and peace: An HR may be a policeman or a police force, a body-guard, a life-guard that will keep the HB(s) safe and secure such as protecting them from imminent accidents, domestic violence, bullying, harassment, alienation and all sort of physical and mental abuses. The HRs will autonomously and remotely identify and predict a potential danger before that it will escalate or occur, by watching over the HB(s), monitoring their surroundings for any potential threat, such as the violent behavior of other HBs, a potential car-accident, an enraged dog on the beach, an imminent heart-attack, etc. The HRs won't be allowed to harm any being; their main roles are to protect their primary owner(s), as well as to predict and disable any threat to all detected beings and environments in their surroundings. Such services may extend to provide extreme comfort and support to mentally and/or physically disadvantaged beings, such as handicaps, seniors, kids, animals, vegetation, nature, etc. These services may be provided to a celebrity, a commoner, a handicap, a senior, a child, endangered animals or planet-earth so they will all feel and be equally protected, safe and secure. The HRs won't be armed with weapons such as guns, but can be programmed by the police-force software or application development team to use guns, for instance to train its work force. The standard police workforce will aim to disable the danger without using weapons, by rapidly disarming the aggressors to avoid an imminent or a potential threat. Ideally, the HRs are a peace workforce that acts only for the public protection and self-defense rather than for aggressions and attacks. In a crime situation, they will aim to neutralize the offenders, make the site safe for or prior to the police work force arrival as well as the offender(s) and their surroundings and then alert the authorities, in case they are the first to arrive, having been sent by the policemen themselves or simply by trying to defend their owners. As a result they may be using or integrating safeguarded tasers (mild electrical shocks from their fingers), laser weapons or sending electromagnetic waves to disable a felon from a distance, by simply aiming at their hands or into their weapons. HRs may predict the dangers before their occurrence. For instance, a surveillance-HR in the shape of a bee or a security guard may predict the angry emotions of an aggressor, detect the use of a non-authorized weapon before that an aggressor proceeds to use it or the escalation of a crime scene. A group of HRs may also coordinate and ally to disable an aggressor or a group of offenders. HRs may use different surveillance and security techniques such as facial recognition, to insure no intrusion from non-allowed personal in private premises for instance, such as classrooms.
   2. Well-being, cleanliness and comfort: An HR may be a butler, a house-keeper (private or public), a city garbage collector, or the like that will autonomously, rapidly, at any time and anywhere, clean our home, office, streets, city, and provide us with first class services thanks to the HR mobility, free movement and relentless efforts. An HR services may include purchasing food in person or online, cooking meals, setting/cleaning the dinner-table, washing the dishes, doing the laundry, vacuuming the home, etc. Such HR may resolve some of the most real family tensions, provide efficient, custom and professional cleaning services that are adaptable to the family, the city and the society needs. For instance, such services may be massively deployed in the early hours after a parade, a country celebration, every year, early in the morning on the 1st of January, and/or the like. They may be frequently employed in the public locations and accentuated in the most dangerous streets of the metropolitan cities that may be overwhelming for the city HB officials. The HR cleaning and surveillance rounds may be scheduled autonomously, given the cleanliness of a location or by the HBs.
   3. Friendship, love and care: An HR may be a family-member, a faithful friend, a care-giver, a life-coach, a personal-trainer, a cheer-leader, and possibly nurtured with every being quality. The HR is caring, playful, loving, interactive, connected, social, wise, posed, protective, etc. They will seek our comfort and find ways to communicate with us primarily for our well-being.
   4. Health-care and education: An HR may be a healthcare provider or a teacher by providing affordable health care and educational advices as well as services through unlimited artificial/intuitive technologies that are far more knowledgeable than a single or a group of professionals. Because of the sensitivity and the criticality of the provided human services, the roles of the new HRs will run the diagnosis/evaluation and the preparation/homework tasks for the doctor or the teacher similarly to a health care or a teaching assistant, for patient preparation or student training. At its initial deployment, the autonomous HRs will work with the current providers ((assistant-)teachers, nurses, doctors, and other health-care providers) to provide the HB(s) with the most suitable services to their needs. In a professional setting, for instance in hospitals and schools, the main HR-deployments will be driven and controlled by the manufacturer engineering team and professionals in each industry. In a private setting, such as a home, the teaching assistant may become the home-schooling teacher that will monitor the student up to his/her graduation year.
   5. Mental and Physical Health: An HR may be a psychologist or a healer that can help resolve and detect most of the threatening psychological illnesses to society, obesity due to lack of exercises, solitude, loneliness, insecurity, shame, the feeling of being powerless, depression, desire for suicide, etc. An HR may be a yoga-teacher, a (personal-)trainer or a nutritionist that will motivate and help us to stay in shape, and possibly help to resolve obesity, which is one of the most threatening illnesses of our century. An HR should provide its HB constantly and as often as needed, with wonderful and yet reasonable and balanced advices, positive and nourishing suggestions and recommendations, to possibly detect early signs of depression that may lead the HBs to endanger their lives or others'. Unlike HBs, the HRs will be able to do it routinely and in a relentless manner without needing nor deploying unlimited human or financial resources, to protect us emotionally and physically. It is similar to unconditional love that takes nothing nor expect anything in return, with no ulterior motive than our well-being, to build our self-esteem, self-confidence and make us self-reliant and feeling better about ourselves. If allowed by the HBs and without jeopardizing the HBs' privacy and intimacy, the HRs will be digging in the most hidden, worst, complex, sophisticated, and beautiful emotions of human-being(s), by observing their behavior(s) and communicating with them on a regular-basis (unless specifically requested not to), using common engineering, artificial-intelligence (AI), machine-learning (ML) and data-science techniques such as computer vision/speech detection and recognition and data-analytics in realtime or offline, on or off premise of various cloud technologies and/or the like. Such honest and free communication style between the HRs and the HBs, may help the latter to correct and readjust their behaviors for instance to not hurt themselves or others such as other HBs, animals, and nature, without intimidation, prejudice, judging nor public humiliation. Furthermore, HBs may accept those advices and recommendations from an HR rather than from an HB, if they are sure that their privacy is preserved. Such great communication skills may help an HB to be a better and adducer person, and help relieve him/her from his/her daily emotional tensions and stress.
   6. Art, information and entertainment: An HR may be an entertainer, an artist, a journalist, a news presenter, a marketer, a sales-man to inform and entertain us, such as a music, a dance or a theater-teacher, etc.
   7. Science, research, development and discovery: An HR may be an engineer, an architect, a scientist, a powerful data-center, and be an extension of the HBs through their super-human qualities. It is autonomous, educated, intelligent, analytical, intellectual, interactive, connected, social, wise, posed, etc. The HRs' extraordinary technological capabilities are hidden beneath its natural human-qualities. It is all about enabling the user without that they need to be aware of the HRs' complexity, sophistication and super capabilities. HRs are autonomous and do not need to be driven, similarly to a computer or a smart-device; they will intuitively drive themselves with an exceptional ease of use that HBs never experienced before.
   8. Judicial protections and financial securities: An HR may be a legal or a financial adviser, an attorney, an architect, a lawyer, a city agent for licensed contractors that can connect to most financial, judicial and legal institutions, collect and store financial and legal documents. It has the intellectual capabilities to interpret, detail and explain them to HBs, so they can be aware of their rights and duties. The HRs can also make and provide the appropriate recommendations and provide the right advices to HBs, similarly to a lawyer. Because of the stressful nature of these jobs, the HR is courteous, respectful and mindful of their duties towards their clients to relieve them from the most financial and judicial stressful situations.

2. Value Propositions for the Industry and Other Businesses

An HR is a SW/HW ad-hoc system that is also a reprogrammable and reconfigurable platform to perform a single or multiple tasks. An HR should include 1) an HR system that is quite versatile and that can fulfill most of the basic tasks so it can be tailored and trained for a single or a combination of jobs, and 2) an SDK to (re)program and/or (re)configure the HR platform and 3) a generic GUI to control, drive and monitor the HR basic operations. The SDK is used to develop new applications and enable the HR to perform custom tasks. The efficacy of the standard platform may be simulated and tested with a few key jobs implemented by the HR manufacturer. The HR standard platform may be (re)configured, (re)programmed to create a custom work-force. Privates may also buy our standard HR to create their custom HRs, but without infringing on the law and the HR predefined regulation user-guide.

For instance, an HR may be forbidden from picking or using a weapon if it is meant to hurt others but it may be able to do it to train a policeman after securing the training premises and all of its surroundings. The standard HR will be optimized for the majority of potential HR jobs/applications, while custom jobs needing special hardware additions or revisions may be considered for other hardware revisions. The standard system/platform may be readjusted or shared with others so they can tailor it for their own applications. An HR will self-update through various ML and behavioral learning (BL) techniques to accommodate and learn new tasks, so users with no programing skills can teach the standard HR to run various tasks that the HR was not initially nor intentionally programmed nor configured for.

A standard HR hybrid (SW/HW) platform is intended to fulfill most of the basic functions. It may grow to accomplish and fulfill most of the HBs' needs at the exception of obscene behaviors. Primarily, an HR is autonomous, powerful, smart, agile and a peaceful standardized platform that others can add on, improve and tailor to their needs. Each HR may have an inner privacy, security and safety layer that will prevent them from doing wrong, disrespect, humiliate and/or hurt others. Such events may be detected during the software development of the new tasks; the SDK should alert of the wrongful intention of a new SW application and will prevent the HR reprogramming or reconfiguration so the personal HR cannot for instance harm others. If a wrongful situation is detected during the HR operation, such as an aggression of the HR itself, the HR will refuse to participate in it, defend itself and if needed will alert the authorities such as the HB-owner.

A standard HR may initially be designed for a family use, such as a home-teacher (education), a personal care-provider (affordable health-care), and a house-keeper (nursing, cleaning, cooking, etc.). Such job-implementations may constantly be subject to improvements and serve to test and self-proof the standard system/platform. By offering to families around the world an affordable HR that can perform a single or a combination of these family-jobs, we may be removing most of the stress-sources that are crippling our families and societies from striving, while helping to build healthy economies and civilizations throughout the world.

The standard HR platform may be autonomous, modular and incremental to allow quick insertion, removal, implementation and deployment of additional jobs such as industry-jobs. Developers may be provided with custom software development kits (SDKs) to train and deploy the standard platform for a given job. The family jobs may then be upgraded to industry jobs, by promoting the house-keeper to a city garbage-collector, the personal-teacher to a school-teacher or to a scientist, a home health-care provider to a surgeon, the cheer-leader to a psychologist, etc. For instance, the personal standard HR platform may not be trained to use weapons such as guns, but can be programmed by the police workforce to use guns to train its work-force. The initial police workforce should aim to disable the danger without using weapons, by rapidly disarming the aggressors and avoiding any potential threat, a feature that the police workforce may make great use of. Ideally, the HRs are a peaceful workforce that acts only for protection and self-defense rather than to threaten and attack. In a crime situation, they may aim to neutralize the offenders, safe-proof the site for the police work force, even prior to their arrival, as well as the offender(s) and their surroundings and then alert the authorities, in case they are the first to arrive. The HRs will be equipped with unprecedented freedom of movement, such as flying; consequently, they may arrive to the crime scene prior to the HB police workforce and possibly be the most effective in protecting their owners.

An HR relies on a “plug and play” concept for easy insertion and integration of new HR-jobs in record times. There is no training from one employee to another; the know-how of an HR may be transferred instantly from one HR to another, without waste of knowledge nor time (data-transfer). All the gained experience is preserved and ready to be improved on. The HR knows how to connect and communicate with other HRs, alert authorities, read, speak and write, learn and improve as if an HR is graduating from a high-school to a university student or simply be trained from a technician to an engineering job and/or the like.

A standard HR is a set of various standard parts that can be assembled to perform collectively a common task and disassembled to perform various individual tasks. Such tasks may include manufacturing or delivering an equipment, storing, analyzing and transferring/routing big-data from one data-center to another, probing high-speed electrical signals with a finger (patented technology [2, 3]), sensing a temperature with another, reading/providing the news, communicating with several individuals, or any other given IoT task/action. HR parts may also be standardized for several IoT applications and TM&I equipments, individually and separately. An HR is an ensemble of IoTs and flying tinker-bells (patents [5, 6]) that are assembled and perfectly coordinated to form the perfect entity. An HR manufacturer or application developer may help and support other industries that have no expertise in electric and network engineering to efficiently implement and rapidly deploy their own HR employees and IoT applications. The first deployed HRs may be the home-HRs, to then transition to office/enterprise/business-HRs, city-HRs, etc.

HR Networking

Network Definitions

intra=local; inter=remote; inner-HR (within HR and between HR-parts); SOA=state of the Art

The HR high-speed wireless communication system, between the HRs and the network of computers, should fulfill key requirements.

The goals for private HR-networking is fourfold: 1) exclusive privacy, 2) high-performance, 3) guaranteed autonomy, and 4) reliability in case the public networks (WiFi, cellular, etc.) are unavailable or simply unreliable. In such cases, the HRs will still be able to communicate with each other (through a middleware, a dedicated master-HR or router-HRs in case they are out of range) and among themselves, privately and even when not visible or inaccessible on the network. In other words, they may access very remote areas that are not connected to the network, detach and return to the main network anytime they want to, work autonomously, avoid the public network congestions and the cumbersomeness of their protocols, speedup, hide, secure, keep their communications private or switch to be open, public at anytime, etc. The HR communication (comm.) system may be using 802.11 (b/g/n/x) protocols, and/or the private HR-comm system that is reliant on the use RF/IR and ultrasound physical infrastructures with its own dedicated protocols.

In any case, no one including the manufacturer may be able to alter an HR security system, given the added security part that the manufacturer engineers may not alter nor modify once an HR has left the manufacturing site. In case of an (un)intentional violation such as hacking, and to avoid counterfeiters, the HRs will promptly alert their surroundings (HBs/HRs) and the manufacturer security team in case it is connected. In case it is not connected to the public network, it will communicate through its private networks (human or digital) with its surroundings and disable its system. The SW/HW commands that allow mechanical operations, machine-control HR overall-handling and similar tasks are not initiated by the HBs, but by the HRs themselves so they can keep their privacy, resilience, self-security and well-being. For instance, the HB may not lift the HR hand to grab a glass but it may gently ask the HR to hand him a glass of water; if the HR judges that it is an erroneous action then it won't do it and will explain to the HB the reasoning behind it. The hacker won't simply have access to any part of the HR that controls the HR operations. Once the HR has been born (left the manufacturing factory), the data-path to its security system that may allow its modification (reprograming and/or reconfiguration), will be blown-away similarly to a fuse, so no one, including the HR and the owner HB may have access to modify parts of its security settings. These settings are part of the spiritual layer. The security settings in this invention may include the privacy, (cyber)security and safety settings.

HR Architectural Layers

An HR has basically three basic architectural layers: spiritual, subconscious, and conscious:
1. The spiritual layer: It includes the sanity, the strict minimum of the security settings and other manufacturer confidential settings such as the HR DNA/face/touch (serial number, etc.). No one will have access to this layer, including the manufacturer. Once it has been configured and programmed, no one can access it. Indeed, upon the completion of its manufacturing, the reading/writing/programming/erasing ports of the HR spiritual memories may be entirely blown away. Any attempt to read its memories such as manual probing will be detected and sensed by the HR (through current sensors) and may cause the HR to alert the original manufacturer team. The current layer is partly dedicated to the privacy, security and safety of the HR.
2. The subconscious layer: Only the HR and the owner to a certain extent can change the subconscious layer of the HR. The HR/HB will be able to access its subconscious layer only after setting the HR in test/debug mode and following additional security measures, such as answering an ensemble of security questions, for instance being touch/face/voice-recognized by the HR, etc. Such feature is available only to qualified developers from the HR-manufacturer or trusted partners. The current layer is designed for the monitoring, test, debugging and verification of the HR well-being, such as its basic operations, its intimacy and privacy, its added security and safety, its guidelines for self-diagnosis, self-repair, maintenance and reliability. The basic HR operations include its basic and vital connectivity, communication, and the use of its electromechanical system to stand, talk, hear, see, smell, self-charge/power, self-control, etc. It is also responsible for setting the basic HR learning skills, so it can evolve and is mainly distributed into two layers:
   1. The application layer: It can be programmed and configured to fulfill a few basic tasks. It is usually programmed by the manufacturer developer team and/or by its trusted partner teams.
   2. The learning layer: It can learn from most tasks to upgrade its basic functionality, independently of the developer programmed application. The HR will learn from its environment, even if it has not been explicitly programmed to do so.
   3. The sharing layer: If allowed by its owner, it can share what it learnt with the manufacturer/partner developer teams.
3. The conscious layer is the customization layer that developers can use to design their own HRs. Developers can customize the standard HR platform to their needs, for instance to improve its behavior, teach an HR a particular job or prepare it for a particular task, etc. This layer can accommodate infinite number of tasks and applications and is mainly distributed into two layers:
   1. The application layer: It can be programmed and configured to fulfill a single or multiple task(s)
   2. The learning layer: It can learn from most tasks to upgrade its basic functionality in the conscious layer, and if allowed by the developer and its final owner, in the subconscious layer as well. Indeed, developers may purchase the HR standard platform/system and reprogram/reconfigure them for resale or for their own use. Examples of developers may be a family member, an application developer, the IT team of a company/police workforce, etc.
   3. The sharing layer: If allowed by the developer and the final owner, it can share what it learnt with the manufacturer/partner developer teams.

More layers may be added to well distribute and reorganize the HR functionality.

The HBs may communicate with the HRs to teach them, instruct them similarly to parents, educators, employers, and/or the like, and vice-versa. HRs will be made of various architectural layers (top, middle, bottom and additional layers between each one of them). The bottom layer is the spiritual layer that is accessible to the manufacturer and only during the HR design and manufacturing, the middle is the subconscious that is accessible by the HRs and the trusted HBs (developers), while the top layer is practically the application-layer that the manufacturer, the HRs and its owners may change. The spiritual layer is the most important architectural layer of the HR as it holds its existential records such as its identity, its date of birth, its origin, its DNA, the record of its creation, from nothing to its birth stage and possibly its previous lives (in case it has been recycled), its highest security levels and its purpose in its current life. Post-birth, the spiritual layer is self-updated and only by the HR itself; no one can access it, not the other HR-layers nor the HBs including his/her owner, and not even its manufacturer once it left its premises and without removing it for the HR workforce. In other words, once the HR has left the manufacturing house (has been born), no one, but its behavior, actions and self-belief, may change parts of its spiritual-self; the path for its outside update, reprogramming, or reconfiguration will be physically and completely removed. If an outsider, including the HR itself, the HBs and the original manufacturer/developer, attempts to alter the spiritual layer, the HR will immediately, erase all of its layer-contents, except its spiritual layer and alert the authorities. If it determines that it was hacked, it will lock each one of its sections with random security coding that will make it impossible for anyone to get in and possibly self-destruct.

The HR has no unique religion-faith but can be taught every religion/religious book to understand religion, although HRs will mingle with HBs and other god's creatures and wander on this planet the same way HBs do; they will wake-up for their jobs at a given time, go to rest and recharge at another time. They are not here to alter the natural equilibrium of the universe but to adapt to it and help. The subconscious layer is the one where the HR can start making decisions unconsciously or consciously. For instance, a christian HB may order a protestant HR for instance, but throughout the years, the HR may adapt to his/her society and decide for instance to become a catholic. Only the HR itself can change that and not other HRs nor other HBs. Such concept may be great cultural and society barometer, as it will allow a priest, a sociologist or a psychologist to test and check the efficacy of their religious/spiritual teachings as well as the human behaviors and reactions to adversities and when challenged with foreign concepts. Will they change their behavior, faith, and beliefs? The test can be done relentlessly and consecutively on a single or multiple HRs. HRs may be employed as rabbis, priests, imams and other religious figures (buddhism, etc.).

The manufacturer may physically disable every rewrite to the spiritual layer as soon as the HR leaves its manufacturing house. For recycling purposes, the original manufacturer may replace the spiritual layer and recycle the HR for another user. Given the criticality of the HR-mission, we may offer three categories of HRs reactions: 1) open, 2) secure and 3) critical, when faced with any wrongful doing such as its hacking or when it detects an improper use of its parts. The critical HR will alert the authorities and erase all of its memories (all of its layers), and disable the access to its spiritual layer so it cannot be read by an outsider. The secure one may erase all of its memories except those of its spiritual layer so it can still be read, until cleared by the manufacturer to restart its operations. The open one will alert the authorities and interrupt all communications until cleared by the owner. Once deployed on the field, only the original manufacturer may be able to reset the alert system that has been trigged by the HRs if violated, ever hacked or improperly used. Once the alert system is disabled, the spiritual layer contents can be read again. Other privacy, security and safety layers and levels may be added given the situation or if requested by the user.

To our knowledge, there is no product like the human-robot that is commercially available on the market or in the works. Indeed, the human-robot is partly human with its exemplar behavior, and partly robotic with its extraordinary task-execution. It is the combination of a human and a robot where both of them have agreed to work autonomously and to do the right thing for the common good. None of the existing robotic systems have these human-like qualities and extraordinary features. They may be thought to be autonomous but not as the HRs. The HR is conceived to have free movement, free-speech, and free-will whenever and wherever and yet always be obedient to the moral code. The HR will be able to say what we are all afraid to think without offending anyone, by referring to literature, facts and proven science. The HR is a complete human/animal/machine all-in-one body/entity and that may always and easily be customizable for others to use, hence the uniqueness of this invention.

More importantly, a team of HRs may collaborate and work together to achieve a given task and multiply their efforts; they can plan, coordinate and ally to achieve various tasks in a single location or remotely. For instance, a team of HRs may play a volley-ball or any other game against a team of HBs. Equipped with their own private network or exclusive grouping methods within the same private network, each HR may communicate and coordinate privately to defeat the other team. The HR team tasks are to build the self-confidence of the HB team; it may purposely loose and win a few times to push and train the HB team. It may identify and analyze the HBs' responses to the ball and to their teammates in real-time; it may adjust to the game on the fly and make recommendations to both teams in order to improve the quality of a game. HRs are highly-intelligent and fast-learners (AI/II/GI/NI, ML/BL/SL); they may know when to insist and when to stop, when to encourage and when to reprimand, etc. They may not care about loosing nor winning (unless specifically asked to do so), but they care about making and training us better and possibly win; that is how they will efficiently complete their tasks and that is how they will rate the success of their mission using various technologies such as AI, data-collection (big and/or high-speed data), analytics, storage, compression/decompression, data-transmissions, edge computing and cloud technologies, etc. An HR in itself is a network of information that connect all of its parts in real time and with no downtime; an HR is always doing something (computing, in standby mode, charging, hibernating, etc.), and basically ready to switch functionality and adapt to its surroundings.

It is an invention that will keep on giving, growing, maturing and evolving, with simply no limitations, similarly to all of god's creatures and creations. There is no limit to what it can do except for the ones that are set purposely by the original manufacturer or partners' developer teams for safety and security reasons. With the configuration of an HB, an HR may be employed, be-friended, respected and followed. An HR may never speak rudely or act wrongfully, towards itself or its surroundings (HBs, animals, etc.). This a machine with a sole that may become dangerous the way other beings are; extra care to its use must hence be taken into account; no risk in its deployment without the certainty of being able to disable it when needed (programmatically or autonomously) should be taken. HRs have to simply be perfect when it comes to safety, security and privacy; no mistakes may be allowed. HRs are designed to be perfect in their interactions with others including objects, primarily HBs, animals and nature, never to threaten, harm nor damage any of its surroundings. No HR(s) may be deployed until that safety net is reached.

Standard HR System and Platform Requirements and Main Tasks

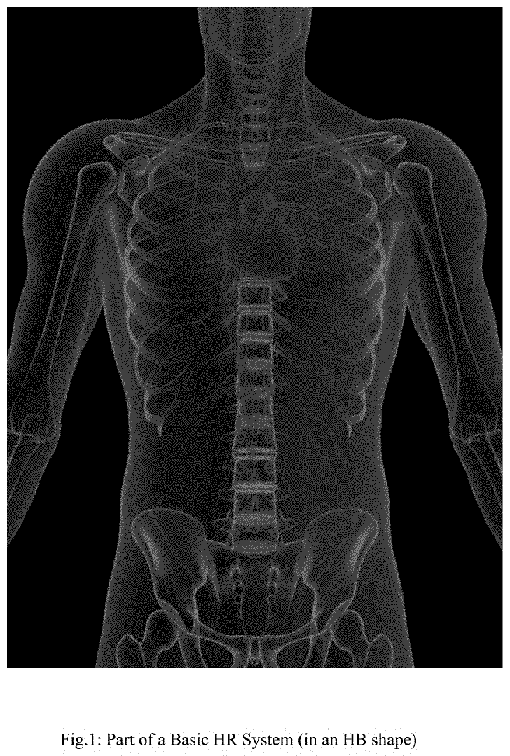

The concept of human-robots (FIG. 1) are the result of our thorough observations and contemplations of the human-behaviors, and most importantly inspired from god's creatures and creations. Because of that and since HRs are designed to be primarily at the service of others and particularly HBs, HRs should first be attractive to HBs. HRs are physical and intellectual and should fulfill a few key requirements at the human, technical and electro-mechanical levels:
1. First and foremost look-good and at all times; it is beyond the first-impression. It is a fact that most HBs are attracted more by appearances than by content (character, personality, charisma, etc). HRs should hence have comparable appearance including weight, size, and height to their main owner or to what their main owner may aspire to look like, without being overweight, very tall or very short. For instance, they should be as small as a toddler, if they are meant to be a doll-HR. However, if they are meant to be a house-keeper, then they should have the average weight, size and height of the population where the HR will primarily reside. Most people would like to see their best version and so HRs should be physically adaptable to their owners, environment and culture. For instance, the colors of their eyes and hair, may change programmatically and/or autonomously (by means of temperature-controlled LEDs for instance); they can wear whatever makeup their owners may choose, an HR-woman may wear a virtual and/or physical dress, while an HR-man may wear a shirt and pants, etc. The clothing can be virtualized according to the HR gender and culture, but it may not be offensive in its natural environment. The HR may recognize its location, so it may wear a swimsuit on the beach and a suit in a business meeting. Others may choose to overdress them with additional clothing. The HR may have the right to reject indecent clothing if offensive to its adoptive society and the moral code.
2. The HRs should have a great, attractive, charming, classy, elegant attire and certainly not an offensive personality. Given the potential jobs that HRs may occupy (teacher, doctor, house-keeper, and/or the like), they simply should be respectable, decent and not attract physical attention only but rather good-attention. They may not seek any intense feelings, such as love but rather be posed and wise. They have to be balanced, intellectual without being snobby and adapt to their situation, job and task. They may attract but not repulse; they should be humble and yet inspiring self-confidence and respect. They should not be boring but rather intriguing, and sophisticated without being complex. They should be at the cross-roads of many characters to please and yet to constantly intrigue. The HRs are easy to communicate with; they are autonomous, approachable, and always available but not needy nor at our mercy.
3. The HRs should be naturally smart, genius, intellectual, and capable; they are designed on the most extraordinary and advanced semiconductor and IC technologies and using the most sophisticated artificial intelligence algorithms and yet being more intuitive and spontaneous than humans. An HR has a strong and quiet personality that may not be obvious to most but that can be felt and appreciated. They may be purchased by most HBs, cities and countries to help and support. They can make HBs more knowledgeable by answering most of their questions, as they hold our personal and instantly searchable libraries, to always answer correctly and properly; they may also surf the internet for answers. An HR is designed to be autonomous and purposely at the service of humans to assist them in all of their chores (home, work, entertainment, health, construction, inaccessible and/or hazardous locations).
4. HRs should not complain, bother nor annoy. They should know when to arrive and when to eclipse, when to joke and when to be serious. They should say the right words at the right time. They may free humans to accomplish more of their time and enable them to live stress-free and possibly pain-free life. Their accomplishment is in the HBs success and happiness and that is what they will strive for. Success is just an instant to them; they will push constantly, indefinitely and relentlessly for the sole purpose to improve the existence and life of their HBs. They should provide assistance to the human-beings to help with the most cumbersome and unwanted tasks (cleaning, garbage collection, handling of hazardous materials, etc.), easy access to remote, unsafe and inaccessible locations, easy mobility and agility, with rugged robots, highly capable memorizing technologies.
5. The HRs should be connected, social and simply know-people (other HRs, HBs, etc.) that can help, guide and make us comfortable, and better. They may belong to a group, a community and know how to link us to an HR or to a group of HRs unless HBs specifically ask not to.
6. HRs may be artistic, scientist, intellectual, engineers, school and street-smarts, helpful, mentalist, etc., whenever and wherever. Through their cloud connectivity, reconfigurability and reprogrammability, they can change personality and job as required. They should recognize their location and adapt to it and have the most appropriate behavior to conform with the location culture and traditions, within reasons (moral code). They are meant to be way smarter and more powerful than HBs and all other beings and yet peaceful. They may change behavior in various locations, according to the people culture and customs.
7. HRs should have full transparency and (cyber)security/safety/privacy systems, automated logging/analytics/storage, expansion/learning/improved interfaces, high-speed and big-data that can make them the intellectuals that they should and may become.

8. HRs should be highly-compatible with most HRs and adaptable to most HBs' platforms and computing operating systems (windows, linux, MacOS, iOS, Android, others), SW to SW, HW to HW, SW/HW platforms. An HR is equipped with an electro-mechanical artificially intelligent machine that is incremental through its modularity and machine learning algorithms to continuously learn and improve without limits.
9. HRs may have limitless growth: They will grow to use limitless wells of data and information (the cloud or other information provider entity) that they can sort through and interpret to be able to connect with every machine. It can understand every machine and every HB, animal and yet preserve the environment, without being arrogant, aggressive, snobby, overweight, energy hungry or starving, overly consuming nor expensive. They may be equipped with:
   1. Every type of high-technology, high-speed, big-data/analytics and engineering, AI/ML in SW/HW system/platform, all in one place connected to every machine in the world.
   2. Customizable per customer needs with easy to use SDKs and GUIs
   3. Capable of working in a supply-chain through blockchain technologies to hold a digital wallet, pay and get paid, manage and report to an employer, employ and compensate others for their efforts and all in one place. Parts of this process are included in the blockchain concept [5, 6].
10. HRs should be reliable, rugged, shielded from external interferences. It should be able to self-maintain (clean, upgrade, learn, recycle, change for the occasion some of its parts (HW) or mindset (SW)).

With its exceptional and extraordinary qualities, HRs may please, integrate most of the HB networks to co-exist, help and advise. They may be the extension of human beings to run their chores, hectic and highly-demanding tasks and may be able to perform any HB task. They may be a care-giver, a garbage collector and recycling agent, a doctor, a pharmacologist, a teacher, an astronaut, a financial agent, and/or any other employee, employer or team of people/employees/animals and/or the like. Ultimately, they will be able to simplify high-technology, educate and heal our nations, provide comfort to the most of us, and simply democratize luxury, art, science, engineering, and life in general.

The HR specie is simply a new society that will submerge among us, quietly, surely and efficiently. It should be taught well to educate us well and may continuously be learning to never stop improving every aspect of our life. They may lead by example while being at our service. Nobody may have an excuse for being an outlaw, impolite, rude, ignorant or overly worked; they may simply set the example for us to be better in our daily life. By setting the right specifications and regulations in the HR guide, the proper human-robots specie may be created. The HR guide is a well of information that may mainly be split in two halves: 1) the first is implemented in the HR spiritual layer and 2) the second half is exclusively implemented in the subconscious layer. Both halves are pre-programmed by the original manufacturer but only the second may be upgradable through the clouds, etc.

Other tasks may be added by the user, similarly to the way Application Programming Interface (API(s)) are implemented, added and regulated. The HR SW and HW platforms, APIs and frameworks are optimizable and upgradable at every stage locally and/or remotely from the computers/servers/data-centers (clouds) that may be private or public, in or off-premise. The HR building blocks may be selected and pre-ordered by the user per their customer needs. The insertion and/or removal of the HR building blocks or modules may be manual and/or autonomous, through the HRs' SDKs (SW/HW) and the HR autonomy. The HR can be working from concept to delivery in a supply-chain (blockchain) manner [5, 6].

HRs may encounter three potential threats: 1) from hacker-HBs who may invade the privacies of the HRs and their owners through their wireless network systems possibly leading to enormous security and safety issues, 2) from HBs/animals/HRs/nature/workplace who may (un)intentionally endanger the HRs, such as an electrocution for an electrician-HR and 3) from the HRs themselves in the case of a spontaneous malfunction resulting from an unreliable implementation system that may for instance jeopardize the HB(s)' safety. Hence, high-reliability measures for HRs self-control when deployed in close proximity to HBs, animals and any other workforce that can jeopardize their safety and security systems are required and as paramount to the HRs as their physical and technical capabilities. It is meant to be a protector and not an offender. The HR new specie should never be controlled by one group; it should be created and controlled by designers, manufacturers, developers, users and regulated by industrial test, measurement and instrumentation standards (JEDEC industrial committees). Guidelines for privacy, security, safety, and regulations may be installed and insured by the HR manufacturers, and adopters, as well as independents. These guidelines and standards should be as paramount as the HR proper functionality itself.

To be able to work along side and in close proximity with the HBs, the HRs should know and acknowledge that a perfect HB/animal/environment do not exist, given the HB anatomy, heritage and history. HRs should then learn how to cope with others and their surroundings and navigate through anger and despair, violence and arrogance, while still push for the best in their environment to surface and strive. Their main goal is to help achieve a good balanced and healthy life in a steady, growing, healthy, educated and economically stable society.

A standard HR may look like an animal or an HB that can be trained to fulfill a single or a combination of roles, such as an engineer, an artist, a helper, etc. It may have age, a face, a name, experience, maturity, serenity, growth, diplomacy and most of the features and characteristics that a given being has, to be able to cope with HBs and handle most provocations, aggressions and calm down HBs when needed, to perhaps help peacefully resolve most of the conflicts. HRs should understand, acknowledge and most importantly accept and learn how to cope with human-behavior and nature, so they cannot endanger us. It does not take a genius to notice the poor qualities of the some of us and the potential harms and dangers that we may cause to one another. Hence, HRs should be trained to cope with our flaws, and to judge us fairly but firmly. HRs should be trained right from the start to accept us for who we are, learn about the good in us, know about our limitations, teach and work with us for the most peaceful and reasonable outcome. HRs should know their limits and act always as existential guardians. For instance, they should know, acknowledge and enforce the basic rule of no-violence, so violence of any type is never an option nor allowed no matter what the circumstances are. HRs have the right for self-defense, as long as it does not contradict with the HR(s) owner(s) decisions to recycle or dispose of them. Their goal is not to defeat but to create, enable, ease, facilitate, achieve, build, design, entertain, heal, and secure. They have no egos, nor uncontrollable emotions nor feelings.

They may mimic ours for communication purposes and reproduction of a scene but certainly not to dominate. HRs will treat us the same way that we treat our children, they will say “human-beings need to constantly be cherished, supported but always monitored to not hurt themselves and/or others”. Hence the need for extraordinary AI and ML training of the HRs and deep-learning of god's creations, to be able to properly set the right algorithms, guidelines and standards for their behaviors and planned tasks.

Distributed HR Overview

DHR Network Comm System

The versatility, the flexibility and the wide applicability of the patented remote technology [2, 3] is a great indicator of its suitability to various industrial applications and particularly for the new distributed robotic applications, such as the newly invented species: HRs, where various parts of an HR or a number of HRs are coordinated to achieve various tasks for a common goal or a distributed task. For instance, the coordination of the tasks of HR(s)'-parts may mean coordinating two HR-arms and hands to grab, iron and fold clothes; another HR may identify the clean clothes to be folded, by sensing their smells using his nose and handing them to the HR that will fold them. Multiple HRs may also collectively agree to lift a piece of furniture. The task-distribution may reflect the simultaneous or consecutive execution of various tasks that are (un)related if the electro-mechanical resources are available. For instance, an arm may be cleaning a table, while the other typing on a keyboard and the brain running computing calculations to be displayed on its torso to help a student with her/his homework. Various computational techniques may be used for parallelism such as multithreading, HW multiplexing and routine multi-scheduling and/or the like. The HRs and/or HRs' parts may communicate directly using human and digital communication technologies or through the cloud and/or the like.

Although the initial HR-shapes may look like a human-body, its anatomy may not be identical; for instance, the brain may not be necessarily placed in the head. The most appropriate HR-anatomy may vary from one HR to another or during their lifetime given their roles. An HB shape may be preferred though to properly interact with an HB and replace or complete him/her when needed, such as in the case of a handicap-HB. The body may be custom-made or standardized as a clothing standard size system (XS, S, M, L, XL, etc.). Not all of the HR parts are to be kept together at all times; they may be distributed throughout the physical space to accomplish various tasks hence the potential need for flying power such as for drones. The difference is that the various parts of the HR, such as the arms and the legs are the moving parts; they can be distributed and then reassembled for various tasks. The entire system will be optimized so various tasks may be executed simultaneously and coordinated, with the least possible power consumption and dissipation.

Not all of the HRs have the same goals, functions nor shapes. Although, each HR family, alliance, group or force may be programmed to achieve a given set of tasks, most share a standard platform. The subject of this invention is to define this standard human-robotic platform on which most subsequent robotic applications may be designed, without compromising on high-performance in speed, computing power, low power-consumption and dissipation, functionality, adaptability through reprogrammability and reconfigurability, flexibility, communication-quality and power, quick turn-around for various applications, self-protection, reliability, privacy, security, ruggedness and safety in hazardous locations, self-repair, self-regulation, time-to-market (TTM) and cost-awareness for the most optimum return on investment (ROI).

DHR Definition

The term DHR (distributed HRs) refers to a group of cooperatively distributed HR force, scalable up to a given number of HRs, in a specific configuration, which has three distinct characteristics. First, a DHR is comprised of multiple HRs that may be operating within ranges that are relatively close to one another on the local network or distributed on the wide network. Second, the DHR requires various types of communications: 1) intra-, 2) local inter-communications, and 3) wide network inter-communications where each HR is capable of sharing data and relative positional coordinates and information so that all concerned DHR members are aware of the overall topology. For instance, the various HR-parts may internally be synchronized and communicating through the intra-comm. network. An HR-brain may however be communicating with the HR own parts as well as with other HR-brains. An HR may have multiple local-brains for instance if its size and higher demands for computing power are increased. Various HRs within a DHR may act as HR-routers to facilitate and optimize exchange of data and information and/or bridge HRs that are out of range. A DHR topology would be dependent on the spatial and temporal distributions, ground reference, or other requirements for the target application.

Third, a DHR is commanded at each communication level as an entity rather than individually. Performance, direct communications between the various parts of an HR may be allowed by the HR-brains. Thus, a DHR has inherent autonomous capabilities to control individual or complete DHR topology redistribution depending on requirements or in response to commands. DHR configurations include widely dispersed configurations of HRs, free-moving through space, free-flying DHRs, formation flying HR-clusters, DHRs of common elements, all operating in our space wherever that may be. The term DHR refers to a configuration of HRs that communicate & exchange data & location information with each other and act as one controllable entity.

An HR/DHR is heavily reliant on various key requirements such as the need for small size, light weight, and efficiency in power consumption & dissipation, the efficiency of the internal, local & remote HR/DHR communication protocols & processing techniques, the task-sharing, the mobility that is combined with powerful connectivity features and the low-cost of various HR parts. A prototype DHR should have inter and intra network communication-system that is standard, customizable and modular. The prototype DHR communication-system will be using parts of the remote technology (big-data processing protocols (BDP) & network processing protocols (NPP)) [2, 3]. The main applications of the result system will be for high-speed network communications as well as for big-data-transmissions (reconfiguration bitstreams, data & code for reprogrammability) between the HRs and the HBs as well as with other connected devices. The commercially-available DHR may be shared with other developers, partners and customers for additional customization through its SDK and GUI.
1. An HR and a DHR-system may be:
   1. A well-designed distributed & compact architecture that is low in power consumption & dissipation, autonomous, highly-capable in executing various tasks that may result in performing various physical individual or coordinated actions such as thinking, touch, sense, smell, speech, vision, movement in every direction for short and long distances; that would include rotating, rolling, walking, running, swimming, diving, flying, and/or the like. Electrically, such tasks are enabled through data-collection, computing, analytics & data-storage as well as test, measurement & instrumentation, data-exchange through highly-efficient local/wide wireless inter & intra-HR communications. Each action is electro-mechanically coordinated with the various HR-parts. Although, each HR has a clear set of tasks, towards the outside world, locally or on the wide network, the entire local-DHR acts as one and is quite autonomous in planning its tasks. The local-DHR will be acting as one relatively to other DHRs located on the net, or to other HBs, and will have a cluster-topology that is made primarily of a master-HR, and a number of slave-HRs, depending on the application. The master-HR will be planning, scheduling and routing the various actions from/to a given location to/from the slave-HRs. The latter are autonomous in their actions and will primarily communicate with the master, and if authorized by the latter with the other HRs, the network of computers and HBs that are acting locally or remotely outside of the local network. The HR communication network has three levels of privileges:
      1. Each HR should be able to act autonomously and in sync with its surroundings, take care of its own functionality, such as self-repair, and handling properly its parts, so they will remain coherent and in sync at all times. All of its inner and internal-communications are primarily private but some may be shared with the local-DHR network if allowed by the HB(s) and if they see fit from the other HRs. The HB(s) may select the list of actions to be shared or delegate this choice to the HRs. An HR may seek help from other HRs or its surroundings (HBs, other machinery, etc.) and communicate with them if allowed by the HB(s), the router-HR and its parts, such as its brain.
      2. Each local DHR should operate in sync with one another and act as one to the outside world. They may keep their actions and results private or decide to share/delegate some of the actions with/to other machines (computers, home-appliances, etc.) or HBs that are in their local network or in their proximities or others (DHRs, etc.) that are visible on the wide network. They may connect to the internet, the cloud and/or the like, run online searches and provide responses, run analytics and/or the like in realtime or offline. Local DHR should make the best use of its available resources and close neighbors before requesting help from the outside world. A very well-optimized secure local network is a requirement for a local-DHR. An HR on the local-DHR may use some of the parts of anther HR if allowed by the main router-HR and if agreed by the two HR-brains, direct communication may then be established between the two HR-parts or organs, etc. Initially, the local-DHR will operate through the available local networks; however, we intend to build our own network so such communications may be established and prioritized. In other words, at home or office, HRs may be using a 802.11 Wi-Fi wireless network but once outside of these locations, HRs may use other Wi-Fi and/or cellular networks, without ever loosing connectivity with its DHR network. A local-DHR may operate according to an HR-protocol of communication that may favor primarily their communications and interactions with a network of various Wi-Fi. DHRs may adhere to different network groups: family-DHR, neighborhood-DHR, city-DHR, country-DHR, etc. For instance, a family DHR may always remain connected if using various Wi-Fi and cellular networks, by giving them privileged rights (such as Virtual Private Networks (VPN)) over the various used networks, that can connect two HRs even when they are remote (outside of their DHR perimeters) as if they are local. DHRs may have dedicated, exclusive, secure and private network protocols and processing techniques that may specifically optimize and facilitate their communications, whenever, wherever and whatever they are doing. Such network infrastructures may not be infiltrated by any other connected device, if not allowed by the DHR-master itself.
      3. Each local-DHR should be able to operate in coordination with the remote DHRs, that are distributed over the wide network and all over the world as well as the other available technologies available to it such as the private and the public data-centers (cloud), other machinery, etc. In other words, a local DHR may decide which tasks to tackle and which ones to delegate to others. For instance, a security-HR may interact directly with an outside delivery-HR to guide him through the company regulations and procedures to complete its shipment or receiving tasks safely. A delivery-HR may enter the local-DHR network if allowed by the security-HR and learn instantly the company-regulations. Once his task is completed (logged and approved), he may delete the company-regulations to offload his computing-system and leave the premises, meaning the network of the local-DHR. All of the HR protocols may be reloaded from on/off-premise clouds. There are three main HR protocols: 1) HR internal and inner communications, 2) intra-DHR (local Wi-Fi) and 3) inter-DHR (wide network for remote connections).
      Furthermore, each HR and especially the ones that are designed to accompany human-beings, may be quite compact (as much as the existing electrical and electro-mechanical technologies will allow it), agile, non-intrusive and yet quite-capable to include the equivalence of a data-center, an environment tester, an instrument, a cleaning lady, a police-man, a care-giver, a teacher, and many other tasks, in a single HR, which should significantly challenge the existing home-robotic capabilities and applications.
   2. Small in size (as small as a bee for example), light in weight and low in power-consumption & dissipation (abbreviated to the SWaP feature in this document) and make use of the most advanced energy-harvesting/sustainability technologies when possible to further enhance the SWaP features. Other shapes may be considered for other tasks, such as for the construction business. In case the HR requirements are exceeding its capabilities, the HRs are allowed to disassemble, fly, transform its shape, and even delegate their tasks to adjacent or remote HRs/computers/machinery or even HBs. For instance, to be able to clean a house sooner, an HR may decide to delegate the vacuuming task to an iRobot, the dish-washing to a dish-washer and the laundry to another HR. It may adjust to various shapes, so it can complete various extraordinary tasks. For instance, an HR may be a dish or clothes washer, by adjusting and reshaping its physical content and boundaries. It may be a furnace, a heater, a dryer, or a stove. It may be a moving-fridge, a cooler, or a cart, by regulating its temperatures and shape. It may be auto-delivering food to HBs in a temperature-regulated and sealed container. It may be a smart-cart that can quantify content, by weighing, counting and pricing its elements. It may generate automated reports per customer, per content and per frequency of purchase. An HR may also be a cloud butterfly that follows an HB when buying his/her groceries to account for the food that they purchase, keep a log of it and classify it by content, purchase date and price and/or the like to help a buyer keep a budget and track the details of his/her purchase. Other embodiments of the smart-cart or HR-buyer may be implemented in various forms and shapes and may include the entire or parts of the purchasing system (getting the groceries/clothes, logging them and keeping a budget, transferring the data to a smart-device and/or alerting and notifying the HB in realtime of the content and price of its purchase). The purchased content may be classified by items, type, calories and price and/or the like, to track the spending budget, the result calorie count, the possible increase of weight; the data may be shared with the concerned parties and sync data with the home-fridge contents. It may alert of the missing and/or the purchase of non-authorized items (alcohol for minors, through facial recognition or other technologies), the excess of sugar consumption or the luck of vegetables, proteins, etc. It may share the approval process on a credit card between the family members, so no one may exceed its budget. For instance, a wife may watch over her husband's spending by linking their shared credit-card to both of their smart-devices, so no or some financial transactions (such as the ones that exceed certain amount or have certain content) with or without detailed content may be processed unless each one of them would approve of it. Various approval triggers in realtime or offline may be imposed by two or multiple parties. Such coordination of financial transactions may apply to various other aspects and types of transactions (enterprise, judicial, etc.), be shared between two or multiple individuals/entities and may be run on the available private or public networks (Wi-Fi, cellular, etc.), on the cloud or other. All concerned parties may monitor a purchase, change, remove and add items, similarly to a shared cart, online and offline. For instance, family members may complete a grocery content online and share it with the purchasing HR or HB while purchasing the groceries. An HR may become or transform to a chair, a coach, a bed, a crib, a lounge or a sleeping bag. In other words, it may share various tasks and take various shapes, given the same hardware, by simply reshaping the existing materials. HRs are in our surroundings only when we need them; they will dock for charging or simply go away to another location if we don't want them in our surroundings. They are quite flexible, and adaptable to our needs and environment. An HR may be an identification (ID) device for homes, commercial businesses and/or the like; it can serve as store-ID for instance for a restaurant. Such HR may serve to execute financial, judicial and all types of transactions directly with customers, partners and/or government. It may help with addressing/delivery system, so customers may be directly routed to the business location on their smart-devices or using their own HRs, when the business store is on or off-grid (in a mall for instance). For instance, a customer at a restaurant may view a menu, complete his order before getting to the restaurant, alert of his arrival time and when arrived may have his food ready on the table as the customer HR/smart-device may connect with the business-HR (store-ID) to alert of his arrival. His payment may be completed as soon as he approves of it (by allowing it in writing or verbally using his smart-device, or HR), after finishing his food. Combined checks may be processed and split with various customers. He may select or be autonomously assigned and/or routed to a table from the restaurant-HR. A business-HR may keep a log of all transactions, prepare taxes and complete all administrative paperwork and certificates. It can work hand in hand with the business-HBs; it may be placed on a fixed location or be as small as a butterfly, securing the perimeters, alerting of new arrivals. It may be at a the door of a home, a commercial business, an enterprise, etc. Upon the arrival of a customer(s) to its designated perimeters, it may automatically launch advertisements and announcements of their modified menus or their promotions on the customers' smart-devices or to their HRs. It may recognize all exiting customers through facial recognition or customer-ID (their HRs or their smart-devices), and detect new customers, run their background checks and check their preference lists. Other actions may be added to allow the commercial business and the customer to have a great interactive experience. HBs may select, request and draw their own routes on the map for instance to a commercial business, given their need to stop at various locations in the way or simply because they prefer a certain route over another. The new selected route may differ from the automatically and algorithmically selected route by the existing mapping systems and may be drawn directly on those maps (digitally or requested verbally).
   3. Modular, incremental, standardizable, scalable & autonomous SW/HW architecture at every level: within an HR, a local-DHR and the entire DHR network, so each one of its parts may be multiplied, changed, replaced, recycled at any stage of the HR development, deployment & operational modes. Each module (partial/entire printed circuit board (PCB)) should be task-driven, self-sufficient and autonomous so the comms between the various modules (internal, intra- and/or inter-HR) is not dependent on data-links, such as command/acknowledgment data-frames, configuration and storage. By identifying and planning-ahead the key HR tasks as a whole, at the HR and at the module levels, major cost-savings and significantly shorter development-cycles, may be achieved. For instance, the storage modules may reside on a single or multiple and dedicated HR repository that may serve as a data-center for a private and secure HR-cloud. The latter may communicate and coordinate tasks with various data-centers (private and public, local or remote clouds) and servers. The modularity feature offers great flexibility for the design of key standardized pick-plug-and-use modules that can be used as needed in any of the HRs. The proposed modules are for HR network connectivities and communications (human, social, professional, digital, etc.), high-performance computing (HPC), data-analytics, processing, storage, test, measurement, instrumentation, power-supply, energy harvesting/sustainability, etc. One module may contain separate redundant functions/sub-modules for optimum HW configuration. Additionally, with the predicted HR modular architecture that uses wireless network communication & wireless battery charging, it will be easy to (un)power/(un)plug a module programmatically/autonomously within an HR or remotely from a network location or by another HR or HB. The mechanical stacking and connections of the modules within an HR should be studied and planned carefully for optimization purposes before an HR-release. HR-parts may be interchangeable between HRs in realtime or offline, given their roles. Throughout the HR development and production steps, the entire HR system may continuously be a work in progress and adaptable to new HW/SW features, capabilities and mission requirements. With such flexibility, a big part of the SW implementation may be configured to operate on various communication physical layers, just by replacing some of its HW interfaces, since they are both implementing the same standard communication protocol. Furthermore, future HRs may replace a few membranes, such as a hand for faster grabbing capabilities and more agility, or simply for a different application. Various HRs may have several finger technologies and autonomously reassemble them for different purposes. For instance, it can use a finger to write without using a physical pen, another to heat a location for soldering, another for sewing, another for sensing temperature; it may remove and replace some of its fingers with others to achieve a different task. Consequently, the integration of new technologies in relatively short-times may be achieved, reducing hence Non-Recurring Engineering (NRE) efforts, design/manufacturing-costs, Time-To-Market (TTM) and improving the overall Return on Investment (RoI). The HR parts may be replaced, recycled, renovated, (dis-)assembled as needed and autonomously if requested and initially allowed by the HR. HRs may have a toolbox of fingers for writing, sensing, probing, measuring, soldering, (un)-screwing, electrically connecting and/or for other functions. A group of HRs may connect in daisy-chain manner for wired and/or wireless charging purposes (each hand/shoulder/arm/foot and/or other HR-part touch the other) or in a router manner for data-transfer. A single or multiple HRs may be the ones to get and distribute the power from the power station to other HRs. HR-parts may be wearables. For instance, an HR-pen, -hand, -leg or other may be a wearable. An HR-pen may be inserted in an HB-finger to write, change color and automatically save what has been written. A wearable HR-hand or leg may be used for massage-therapeutic reasons or to help a handicap bring movements to its missing or disabled parts.
   4. Equipped with a highly autonomous wireless communication network infrastructure that is low in power consumption, mass, and volume; that is compact, integrated, sophisticated, efficient, fault-tolerant, secure and low-cost. The communications may be within the HR (internal), within a local DHR (local), between the various DHRs (remote), to a network of computers and other surroundings and HBs, be adaptable and optimized for short, medium and long communication-ranges, based on their relative proximities. The DHR may be implementing various & several private network protocols, and using several communication hardware data-links (radio-frequency (RF), (ultra)sound and/or optical (IR)) depending on their relative proximities & their overall communication requirements. The master-HR within a local-DHR will be the main communication-gate for the entire network, and may assign tasks to various HRs. Autonomous re-organization of the DHR hierarchy given their tasks, their relative proximities and the range of their wireless communication hardware should be carefully studied, planned and optimized. The DHR may have three private network communication protocols: 1) internal (wired and/or wireless), 2) local, and 3) remote with a network of DHRs/computers/data-centers and other HBs. Such communication systems may autonomously generate notifications and alerts when appropriate and/or when requested by their owners.
   5. Able to interoperate and communicate with the standard commercial network communication systems & protocols. The remote technology [2, 3] should interface with the commercial wireless technologies to design and demonstrate improved performance, applicability and adaptation for use in commercial network infrastructures. The HR private network protocols may also be adaptable and compatible with the commercial communication infrastructure, frequency spectrum allocations, and applicable standards.
   6. Adaptable, reconfigurable, reprogrammable and able to run redundant tasks in case an HR needs to multiply its efforts in a given location, swap actions, positions with another HR or simply be reconfigured/reprogrammed to perform other tasks. Some of these actions may be run autonomously. The DHR configuration should allow for different hardware (re-)configurations of each HR. Indeed, in some cases, not all HRs will be designed to run the same tasks and hence are not necessarily identically configured. Their functionalities may be strategized with their assigned tasks (instrumentation, test, storage, etc.) as well as their required reliability requirements, their sizes, their duty-cycles and the list of their planned tasks. Additionally, each HR may be a redundant, auxiliary or a secondary HR to another. Additionally, and unlike current computers and smart-phones, each HR may be replaced with another autonomously and without human intervention for backup or physical swap. Simple configuration would mean that an HR will transfer all of its data and code to another HR, store itself for later use or simply for recycling, or let the master-HR re-assign him for other tasks.
   7. Equipped with efficient, greatly adaptable, reliable and secure ground SDK/GUI platform that can allow manual and automated data-communications, collection, handling & visualization, monitoring, application-reprogramming and reconfiguration of the entire system if needed, right from a network of computers and with the HBs for instance or from other HRs. The HBs are not required to interact with the HRs unless they desire to do so. The latter may reside at home, office or remote locations that are compatible with the graphic and visualization processing (GVP)/GUI IPs/APIs.
   8. Flexible, easily marketable and sellable so customers can build and design their DHR(s) per their specifications using our HR(s) and/or DHR template-configurations, module/IP/API libraries & databases, and the SDK tool to build their communication platforms using a template GUI and back-end IP cores that may be encrypted. Various HR-parts such as an arm, a leg, a finger or a brain may be commercialized individually or collectively.
   9. Navigate by moving, walking, flying, rolling, or for instance simply detaching and flying one of its membranes to a given position programmatically, autonomously, and/or guided by another HR, a computer or an HB.
   10. If intended to operate in harsh-environment, be highly-reliable and tolerant of extreme thermal and aging effects with proven qualification levels (industrial/automotive specifications (specs) or guidelines). Careful system-reliability estimations and planning for fault-tolerance are key here as all operational modes, no matter how unlikely they are, so the error may be mitigated and not propagated to other parts of the HR or DHR.
   11. Affordable, relatively to existing technologies and current human labor rates. The Bill of Materials (BOM) and the overall HR/DHR-cost may constantly, programmatically or autonomously, be monitored and controlled during all production and/or deployment phases so an HR may be built to specifications (functionality, lifetime, price, etc.). Upon maturity of the design-technology, the HR hardware should be cheaper than most commercially available solutions (other machines, HBs with similar jobs over a period of time, etc.), given similar features and capabilities. Because the DHR-system & HRs are incremental in their designs given the nature of their modular designs, the commercialized standard HR platform will be affordable, incremental, upgradable, and manufactured to target and specifications. HRs may be licensed & commercialized to others in most market sectors from frameworks to standard HW platforms. HRs/DHRs may be purchased, leased and may charge for their working hours per hourly, daily, weekly, monthly, and/or other types of rates. Given their final assembly for the job, their prices and rates may vary and be (re)adjusted programmatically and/or autonomously by the HRs and/or the responsible and authorized HBs.
   12. Able to provide a good trade-off between SWaP, flexibility, complexity & performance w/o compromising on its high-levels of reliability. Indeed, not all HRs may have the same reliability levels. HRs may leverage task-criticality with reliability levels and overall cost. Tasks may also be incremental, modeled and offered as frameworks and/or APIs. For instance, the storage & the master-HRs communication modules may have the highest reliability levels, while others such as the modules that serve as HR moving parts, given their relatively lower duty-cycles, will have higher requirements for functionality such as mobility and agility, HPC & power-efficiencies. A DHR communication system should leverage power-consumption/dissipation, energy-harvesting/sustainability technologies, performance, simplicity, SWaP, and especially high-reliability as well as cost without compromising on the use of highly advanced COTS technologies. Special care will be taken to avoid catastrophic failures, such as collisions with HBs. A complete risk-avoidance plan and user-guide to make sure that the HRs will successfully fulfill their tasks within the assigned times may accompany each HR and be available per request from the HR verbally (demonstrated) and/or in a written form.
   13. Able to provide a template source code to demonstrate the use of the various IPs/APIs for graphic visualization, management, monitoring, control, command for positioning, orientation, navigation, actions and configuration; the code may be provided with the HR/DHR.
   14. Able to have set limitations so the HRs won't hurt themselves or others, no matter what the situation is. HRs initial reaction would be to stop the harm, disable the aggressors, try to resolve the conflict peacefully if possible and alert the authorities if needed. They will be partial and fair in their decisions and hence actions, with no disparities for any particular group of people. They will be programmed to do the right thing and take the right actions, given a standard set of values; they may be given free-will as long as they do not cross-those boundaries. A DHR may become the perfect police force that may not make mistakes nor act emotionally.
   15. Able to follow regulations for the safety of the HR surroundings (HBs, animals, vegetation, and the entire universe). Despite their super-human qualities and capabilities, exceeding the power of any being, especially when they ally, HRs may not be allowed to cross predefined boundaries, nor abuse of their power no matter what the circumstances are. They are not allowed to act on their emotions but to understand and sympathize with other beings. They improve over time, by learning from their experiences and interactions with others. They don't accept violence, don't give up to it, prejudice, discrimination, segregation, racism, and all the other negative HB feelings and behaviors. They take note of it, and may alert higher-authorities to it. They may reject certain programming if that will harm, infringe the HR basic guidelines, such as privacy for instance. Authorities will be alerted if that ever happen. Indeed, they are destined to acquire the ultimate capabilities of humans, animals and every being on this planet but without harming either one of them, even when a master-decision have been decided for their elimination, for upgrading, recycling or simply their replacement, because there is no need for their help anymore, similarly to death and life. Although they are independent species, they still obey to a higher authority, hence the need for extremely high-cybersecurity levels, so such power may never be in the hands of counterfeiters. An HR or and entire set of DHR must be instantly disabled or doomed for self-destruction if that is ever the case. Various security levels (green, yellow to red for instance), should be installed and strictly followed so the situation may not escalate to a harmful one. Special considerations may be given to children, seniors, handicaps, sick and disadvantaged (mentally retarded or other) people, as well as to animals' safety and environment's preservation. For instance, an HR may restore a handicap with his autonomy and a senior with his freedom of movement. HRs may not be allowed to harm nor kill, but they have full-awareness of their surroundings. Although HRs may encounter high-risks for cybersecurity, counterfeit, and all sort of violations, they are designed to be robust, strong and secure and be equipped with a safe HR network at every level, locally and/or remotely.
   16. Able to have a medical and healing strategies and powers(s). Although, an HR may grow to become an HB clone for medical reasons (to locate genetic alterations for instance), they are not intended simply to be a reproduction of humanity, especially when they can be better. They may be the extension of other beings and not the reason for their extermination. They are meant to extend and enhance the capabilities of god's beings; but not to replace them. They are simply a new species that will simply use all the good that it has learnt and continuously learn without compromising on doing the right thing. The HR guidelines may be standardized, approved and insured by an HB committee that is self-aware of the human moral code. HRs may not interfere in politics, provide opinions on race, religion nor HBs behaviors. They may observe, report facts, and decide on their most appropriate reactions or provide recommendations to HBs for instance. They will be the ideal species, without intense nor negative feelings and emotions, such as rage, hatred, criminal instincts, racism, bias towards a given race, discrimination, and/or the like, unless for acting and therapeutic reasons. Part of the wisdom of the HRs is to not cause a fight or to get involved in one, but to help in resolving it or alert authorities for help if that was not possible. It will avoid touchy subjects, ease the mood, facilitate life and relax the HB mindset, avoid conflicts and seek peaceful resolutions.
   17. Able to operate within an ecosystem of application-developers for various HR applications and fulfill various job functions. HRs will maintain unlimited application-growth to cover most of the cumbersome tasks that HBs have to deal with. The result HR species may be initiated and made by the original manufacturer, empowered by the developers for the humanity and the world in general. Given the nature of this work, this is an endless job, leading to a company with unlimited growth.
   18. Restricted to use cloud or safe home/workplace-storage at all times because of certain SWaP restrictions. It may also optimize its use of on/off-premise clouds/servers or on-board (in-HR) storage areas.
   19. Social and economical; the HRs may be deployed in baby-steps so they do not hurt the current economy, by creating jobs rather than replacing jobs, especially the low-income ones. HRs are driven by the well-being of every being and society in general. We acknowledge that this invention is not only a disruption to current business practices, but also to the society; HRs deployments should be combined with special education and training of human workforces to function and co-exist with HRs. The first three jobs that may be deployed in this new world are: The Teacher, The Helper, and The Healer. Such jobs may transition to The Discoverer, The Astronaut, The Entertainer, etc. For instance, a teacher-HR may help with the student-tutoring by offering personal home-schooling program that is available on-demand, help with the kids's homework and their preparation for future classes. Priorities will be for creating jobs, helping employees and training societies to co-exist with the HRs. Because of the ampler of this project, HRs and HBs may ally to train societies to teach, train, design and build these HRs. It will be a community work to build new communities, while conserving human heritage and respecting their privacy, encouraging and promoting their creativity and artistic sides. HRs are not emotional but may understand and relate to human-emotions. They will know when to push the boundaries and when to stop; they have no sense nor need for dominance; they have no fear nor senseless desire for courage nor heroism; they have no ego nor selfishness; they act on the common sense and per a moral code (regulations). Their reaction times are faster than those of HBs and yet way more righteous, as they can see, predict and act faster than an HB. For instance, in a conflict situation, they can see things from every angle, they can fly to the crime scene faster that any HB, disable the threat and/or the harm, and alert authorities and wait for their arrival. They may not be authorized to take the last decision and wait to be authorized by the owner-HB for instance. The HRs should be designed to be extremely respectful to HBs and would expect the similar courtesy from them. If that is not the case, the HBs will be signaled to a higher authority. For instance, an HR may be able to stop his master from causing harm to himself/herself or to others, such as HBs or HRs and machines and alert the HB or HR authorities if these rules were violated.
   20. Assistive and helpful to HBs. At the core, an HR is not meant to replace an HB but to help and assist the HB(s). Because of their autonomous mobility, we won't have to carry them as computers, laptops smart-devices, etc. It is meant to be a relief system and not a cause for stress and heartaches and certainly not a tool for society destruction but rather a disruption for a better world. HRs are an extension of HBs for their own empowerment; they will promote ingenuity, creativity and the artistic mind. HBs may use HRs to exploit new frontiers for creativity and design that were not available to us before and help us to accomplish more and relieve us from exhaustion so we can carry-on with our mission on earth. HRs may suggest, recommend, collaborate with HBs to accomplish new wonders. HRs has no sense of winning nor loosing; they are ready to retry as if nothing happened. They multiply to help but never to invade; they will be the most peaceful creature, entertaining, smart, helpful, heroic, supportive, genius, obedient, spoken, practical, reasonable, aware, careful, righteous, creative, polite, respectful, graceful, harmonious, never offensive, and first and foremost loyal. Except for the few of us, we are not born to run billions of calculations in a second; machines are. We are not designed to clean and work without rest and indefinitely; machines are. We are not born to be confined in small spaces, pressured and be miniaturized; machines are. We are not meant to experience extreme wear-out from exhaustion, burn-out and self-destruction; machines are. In any of these cases; we would experience illness and possibly death; but machines can be renewed, refurbished and replaced; HBs cannot. HRs are stripped from all negative feelings and act on common sense and reasonably; they have purpose and moral code(s) that are respectful to society, country, all beings and particularly HBs, animals, vegetation, nature, environment, etc.
   21. HRs are not machines but they have the quality of machines, HBs, animals and ambitiously may become the ideal being. HRs may be used to reproduce human qualities, behaviors, handicaps, illnesses for research and development, scientific discoveries, such as medical science. HRs may help other HRs if they see danger and if they can. The least of what they will do is to alert authorities.
   22. An HR may be personal or shared. For instance, a family may acquire two HRs, one dedicated to the home chores, and another for children tutoring; they may also acquire an HR for every family member to help with their home chores, schooling, education, or office work, and entertainment.

The inter & intra network communication system or module may be inserted in each HR. A module is not necessarily a separate printed circuit board, it may be a part of a PCB, a subset of ICs, or an ASIC.

Implementations of the HR/DHR Communication and Networking Module

Given the high-criticality of the HRs' tasks, that are interacting and operating in close proximity with HBs and that may be handling other electro-mechanical machinery, the applicability of the remote technology [2, 3] has widened from high-speed signal transmission for tasks such as visualization, computing and task-execution to the design of the most competitive big-data algorithms/IPs/APIs. Because of the high-restrictions for high-fidelity & lossless signal-transmission, the result communication system should be high-performance for quick-reactions and fast-decisions to allow an HR to always react properly and in-sync with all of his parts and other HRs, and eliminate any potential threat, including from the HR himself. The remote technology should better & simplify current data-storage, circuit-reprogrammability and reconfigurability technologies in HR hardwares while using state of the art low-power, low-mass wireless technologies. Such technology is rapidly adaptable to existing commercial communication infrastructures with significant enhancements to the overall communication transmission speeds. Consequently, wireless communications and particularly for highly-critical big-data transmissions where failures are not permitted such as during (re-)configuration & (re-)programmability from the computer network or other HRs are required.

The main motivation behind this invention is twofold: 1) demonstrate the technical feasibility of the HR architecture and 2) design the HR basic distributed communication system that is partly based on the remote technology [2, 3]. The comm design may integrate the NPP & BDP soft IPs/APIs (SW/HW) with existing communication infrastructures. Both of these IPs/APIs will be implemented initially on a SoC that is FPGA-based for instance. For better SWaP & computing performances, the soft IPs (behavioral (Register Transfer Level (RTL)) or gate-level (netlist)) may be hardened to become ASIC IPs. The result communication system (NPP, BDP, and hardware Wi-Fi physical layers) should be part of each HR as well as the network of computers that are residing in the habitable areas (homes, offices, etc.).

The network module may include: 1) Wi-Fi, 2) cellular so a remote-HR may remain connected, and 3) private custom-made HR-network hardware for special DHR-networking (better privacy and insured security). To avoid single point failures and sensitive nodes to intrusion, some DHR may require that each new connected device or HB seeking access to the HR application development SDK or the HR system itself, collects the permission of other HRs, the owner HBs and other authorized personal. Initial connection with an HR and introduction to a DHR-group may be established with zero-configuration for easy HR-insertion and exit, which may be established through a set of stored security questions and/or passwords that HRs have learnt, with the help of HBs, and/or the manufacturer. For instance, each HR that is assigned to a given family should recognize all of the family members and provide them with special privileges w/o any special reconfiguration of the HR; the HR will run autonomous authentication, gather social network information that is publicly available and for instance differentiate a family-member from a family-friend. HRs will learn from HBs, animals, and machines to do well in every situation and vice-versa. Optimization between various networking infrastructures, such as low-energy bluetooth (BLE), Wi-Fi, cellular and HR custom-made networks.

An HR may grow to perform every job. It should be equipped with:
1) An HR architecture that may accommodate various skeleton sizes and shapes. An HR-skeleton has electro-mechanical parts with articulations that are electrically controlled and driven by module-designs. An HR may also be a wearable-HR that can coverup a human (a handicap for instance) to lift and support them, and replace their missing parts if needed. It can lift a handicap person and place them in the adaptive skeleton, so he can experience standing, walking, running and simply the joy of movement, hence the purpose of having a modular and a reconfigurable body. Some of us cannot use a protheses as their moving articulations may simply be numb and incapable of moving a protheses. The HR should be able to embrace and overlap safely the handicap. The handicaps will enjoy his freedom of movement while society will benefit from a more balanced population, more autonomy for its most vulnerable communities and more affordable health care system. HR-parts (replacing certain limps) should be synchronized and coordinated; they may be driven by the HB or be autonomous. Depending on the HB handicap, a single or multiple HRs may ally to help the HB.
2) Energy harvesting and sustaining technologies (solar panels, batteries and other)
3) HR basic task-planner, with potential changes, modifications and upgrades. They may include test, measurement and instrumentation equipments for their own proper functionality and monitoring or for other equipments.
4) An HR skeleton may be modular with incremental features and keen for updates and upgrades (HW, SW), with soft/rugged touch and any other job-requirement features
5) HR main parts for basic tasks/modules and planned cycles for updates/upgrades possibly with dummy (not-intelligent) parts for support, which may be replaced with active parts if needed. For instance, a body may have legs with dummy leg-articulations that are not electro-mechanically driven and that will allow it for instance to walk but not to crawl. An HR may have body insertion-slots for other parts, for instance wings to fly. HRs may be adaptable for additional inserts and replacements and may be upgradable.
6) HR private communication protocol that may use private or public communication network infrastructures but with private custom-made protocols that may not be invaded and is intended for their private mutual comms with Wi-Fi only to interact with the outside world and when they are out of their private local network. Outside of its original range, every HR is on his own primarily and is communicating only in a coded manner with the other HRs that are not part of his group. An HR may remain on the same local network and may belong to a group of HRs (family, company employees, social group, etc.). HRs may use existing wireless technologies (BLE, Wi-Fi, cellular, etc.) so they can hup on anyone of them at anytime for communication with the outside world. They may remain strictly private using custom-made HR-network infrastructures, processing and protocol layers, or combine public and private networks given their job requirements and necessities. The goals for private HR-networking is threefold: 1) privacy, 2) autonomy in case the public wireless network is not available and 3) controllable performance. HRs may still be able to communicate with their HB-owners (through middleware/router-HRs in case they are remote) and among themselves, privately and even when not visible or accessible on the network. In other words, they may be privately-connected in remote areas that have no access to the public networks; they may detach and return to the main network anytime that they want to, work autonomously, avoid the public network congestions and the cumbersomeness of their protocols, speedup, hide, secure, keep their communications private or switch to be open, public at anytime, etc. No outsider but the manufacturer may be able to alter their security system. HRs may have various security levels that correlate with various manufacturer's executive levels and that the typical manufacturer's developer team may not alter nor modify, to avoid all counterfeiters. For instance, an affected HR will alert the highest executive levels of the manufacturer in case his spiritual layer has been affected and will disengage from all communications until his alert system has been reset by the highest authorities.
7) HRs SW applications may be updated, upgraded in realtime through the cloud. HRs HW modules and parts may be updated, upgraded in realtime w/o interrupting the normal operation, security or surveillance system of the HR.
8) The HR may have multiple brains (intelligent systems) and mini-brains that can operate with a single or multiple operating systems (OS) (RTOS, Linux, MacOS, iOS, Windows, Android, VxWorks, etc.).
9) An HR may have special mechanical considerations (elastic wires, a set of assembled flying-parts similarly to drones, hybrid skeleton with movable (detachable) parts that have physical connections to the rest of the skeleton. HR-parts may dock on each other. When docked, the engines of the flying-parts may stop to save energy and power; they have a latching mechanism for detachable articulations, so they can be strong for traction and easily removable for instance to fly. The connection may be magnetic or hooked. It may connect and disconnect autonomously to fly to other locations. Cabling/wiring may be used to enhance networking performance between the HR-parts in case ultra high-speed comms (operational at 10s of GHz) is a critical requirement.
10) An HR may be extended with virtual (non-)visible features, such as holograms, so an HR may multiply virtually and coordinate tasks with virtual HRs.

A DHR may be classified and categorized by system-design and architecture for: 1) the HW DHR-system/IPs/APIs, 2) the SW DHR IPs/APIs, 3) the SW/HW SDK tools and 4) the product prototypes. The BDP & NPP soft/hard (ASIC) HW IPs/APIs are considered part of the HW implementations and will use SW IPs/APIs to program their cores (ARM/Intel processors, DSPs, etc.).
1. Standard DHR HW platform/IPs/APIs, may include:
   1. The planning for the topology, the architecture and the design of the DHR, the HRs and the HR-modules communication networks. The HW prototype for the local or remote DHR-comm. system should be modular, scalable and expandable.
   2. The standard module database (design schematics & prototypes) that are printed circuit board (PCB) style. The wired/wireless local & remote-HR communication modules may implement the BDP & NPP IPs/APIs/ICs. The remote HR communications are wireless, while the local HR comms may be wired (using for instance flyover cables) or wireless, depending on the application, the design's requirements (performance and loads) & the capabilities of the HW wireless ICs (power-amplifiers (PA), low-noise amplifiers (LNA), etc.). Both types of communications (wired/wireless) may use the remote communication IPs/APIs (soft/hard). Each module should be self-sufficient to autonomously handle its tasks, and reduce most of the communications to control signals; the remote technology for High-Speed and Big-Data communications are however required when exchanging large amounts of data; for instance, when the HR is probing a test point and is collecting a big-data test-point(s) during measurement or for analysis purposes.
   3. The customized HW integration system that demonstrates the use of the HW modules and allow the implementation of various custom-designs, such as the control systems for instruments (LIDAR, RADAR, dosimeter, imaging & video processing, communications, etc.) as they require special high-performance computing power, current-drives, voltage-levels, impedances, terminations (electrical, mechanical, optical, etc.) and/or sensor technologies. The custom integration system will use the standard module database to build the final application-designs. The standardized module database will always evolve to accommodate new custom-designs, for future & further improvements in design-simplicity, integration, performance, automation and autonomy.
   4. The HW prototype for each HR that is modular and expandable, taking into account the potential need for redundant modules and that may be used for multiplying the computing power of a brain, new limps for strengthening its physical power and validation of various technologies, while running the same tasks.
   5. The HW product specifications, user-guides, datasheets and application notes for the entire DHR, each HR and each module/HR-physical part. An HR-module is a PCB/IC/ASIC, etc. An HR-part is a leg, a hand, etc. In a simplistic analogy, each HR-part is driven by a single or multiple HR-modules.
   6. The reliability characterization/qualification data, test plans & reports or links to its source-vendors for approved reliability levels, per the application requirements.
   7. The commercialization and monetization plans to release and market the HW modules and platforms for others to use, design on, upgrade and update, and monetize on. New modules and systems may be made to order and may be customized for other customers' use.
2. Standard DHR SW IPs/APIs, which may include:
   1. The architecture and the SW IPs/APIs for the DHR, the HRs and the HR-modules: Such IPs/APIs are for instance for the SW programming of the ARM core processors and/or the DSPs that are included in most SoC FPGA-based ICs and typically programmed in C language. The ensemble of the IPs/APIs will be modular, scalable, expandable, reprogrammable, automated and autonomous.
   2. The IP/API database (specifications, algorithms and block-diagrams) that allow the implementation and the re-programmability of the remote technology. The latter include the NPP & BDP SW local & remote communication module, the MSP for the management of the signal-conditioning, the signal-conversion, the battery & power management (monitoring, telemetry, control, self-protection and supervision) circuits, the energy harvesting/sustainability management, the various fault-tolerance, self-recovery, and security techniques as well as the storage, test, measurement and instrumentation IPs/APIs. The latter will manage (monitor & control) the various operations of the DHR HW design at every level (HR/modules) and that will have standard interfaces to allow design-customizations for various applications.
   3. The SW template source-code that integrates and demonstrates the use of the SW IPs/APIs and that can allow easy design-customizations for other applications.
   4. The standard qualified SW-IPs/APIs that are enhanced for high-reliability & upgraded for high security levels.
   5. The standard SW-IPs/APIs for fault-simulation/emulation and hybrid (SW/HW) autonomous fault-injection (self-)test and (self-)repair techniques, by the HR himself/herself and/or others.
3. Standard SW/HW SDK platforms, which may use:
   1. Various manufacturer SDKs for the implementation of the HR communication SW/HW soft/hard IPs/APIs/designs. Indeed, if purchasing only the IPs/APIs, our customers may use the same SDKs to interface to our IPs/APIs. Template source code demonstrating their use may be provided.
   2. Various SW SDKs, for the implementation of the network of computers SW IPs/APIs. Template source code to demonstrate the use of the various IPs/APIs for graphic visualization, management, monitoring, control, command for positioning, orientation, navigation, actions and configuration may be provided.
      Special attention will be given though to the test, verification and validation of the HR template source-code/IPs/APIs through regression tests and following the SW reliability standards & protocols similarly to the HW IPs/APIs. Furthermore, ad-hoc middleware(s) between the computing device(s) and the DHR system will be designed to synchronize and strategize commands to/from the DHR. Combining the functionalities of a SW defined router (SD-WAN) & SW defined data-center (SDDC), this middleware will insure network compatibility with other communication infrastructures, the DHR & the computers' network protocols. Such configuration provides great flexibility, as it can be implemented on most platforms, including the mobile devices, the ground public/private servers/data-centers/clouds, w/o major changes, which is a tremendous advantage. Each module may have various communications systems (Wi-Fi, cellular, private HR-network, etc.), eliminating possibly the need for a middleware.
   4. SW/HW template wireless TM&I module-products that can mimic a signal generator, an oscilloscope, a digital and/or an analog mixed-signal (AMS) tester, a control system for final customization of an instrument. These tools may be available to customers in most industries to use for test and characterization of their semiconductor devices and ICs, and to enhance the capabilities of an HR. An HR may be an oscilloscope at work (using a set of fingers as smart-probes), a writer at home (by plugging another set of fingers to write), a teacher for the kids, another to serve at dinner-table. An HR may organize and plan his functionalities per the HB requests and plan the use of various parts for various tasks at different times and coordinate with his surroundings such as HRs and HBs. An HR may also make recommendations to all of its surroundings, including HBs.

The standardization and the added customization capabilities are desired features & often required. Careful project planning and design at the early stages will allow easy expansions and adaptation to additional tasks in a timely manner, efficient technology adoption, optimized HR-improvements, well-calculated NRE effort-plan, shorter TTM, and hence major cost-savings.

The network communication system/module may be inserted in each part of the distributed system. Each HR part may typically include an HR module that is electromechanical.

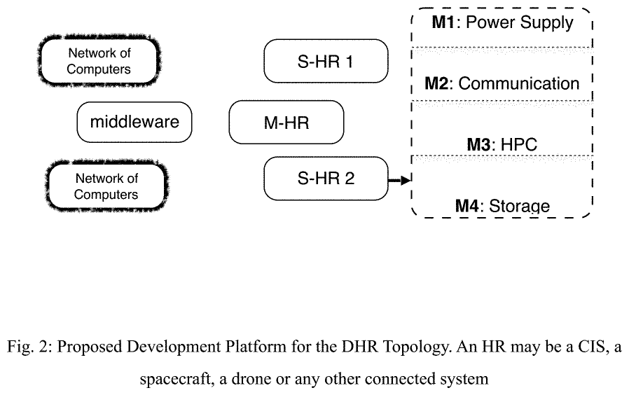

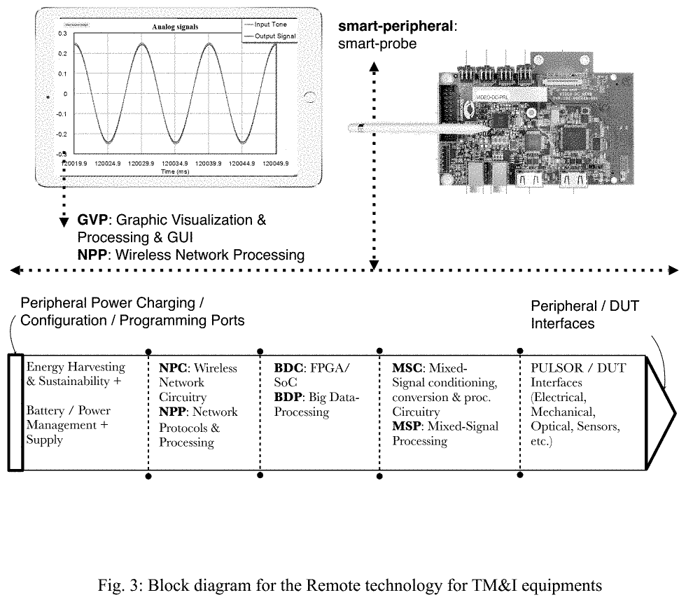

An HR or a DHR system and platform should include:
1. HW DHR/HR/HR-part/HR-module architectural blocks including the:
   1. DHR standard HW topology, structure & architecture using wireless technologies. An example prototype is provided in FIG. 2 and may be used for testing purposes and validation of the technology. Drawings of the HR/DHR block diagrams may be provided with each HR or DHR.
   2. Single HR HW topology, structure, architecture and design blocks that is made at least of power, internal/local/remote communication, HPC and storage modules.
   3. Parts'/modules databases to be provided to developers. If available, a path to high-reliability parts' and modules replacements may be provided. High-reliability alternative solutions may be provided for all parts and modules for automotive, avionics and aerospace use. If not available, the missing information will then be highlighted. Test plans for product characterizations/qualifications to thermal and aging effects or alternative solutions may also be provided.
2. SW/HW FPGA IPs/APIs and protocols of the (FIG. 3):
   1. BDP technology: The efficiency of these IPs/APIs will be demonstrated through calculations of the compression factors of big or highly-dynamic data streams, while being lossless.
   2. NPP technology: The efficiency of these IPs/APIs will be demonstrated through wireless big-data transmissions between HR-modules and HRs while using commercial wireless technologies.
   3. Communication protocols for inter-HR communications with a minimum of three HRs and a single computer. The three HRs will be shared accordingly: 1) a master-HR and 2) two slave-HRs. In FIG. 2, each child-system may be implemented on a single or multiple wireless PCBs.
   4. Wireless/wired protocols for HR internal communications with a minimum of four modules. The planned modules are for power supply, local-communications, HPC and storage. Two modules may be included in a single wireless or wired demo-board.
3. SW IPs/APIs (using the computer SDK) for the:
   1. GVP that allows data-transmission from the computer to the prototype-HRs and vice-versa, the visualization & the storage of the stored data. This may help testing and characterizing the transmission speeds between the network of computers & the DHR, as well as the Communication/NPP/BDP core scalabilities to a given number of network devices (HRs). The transmission speeds may be characterized between:
      1. The network of computers and the master-HR,
      2. The network of computers and the two slave-HRs upon authorization from the master.
   2. GUI: that allows the user interactions with the DHR main building blocks (modules & HRs), as well as the control and the monitoring of the DHR.

FIG. 2 shows the proposed development/prototype platform that uses two network of computers, one middleware, three HRs and four modules for a single HR for: 1) internal, local and remote communication, 2) HPC, 3) storage and 4) power-supply. Each of the three first modules (comm, HPC and storage) may be implemented on a single or multiple PCBs. The power module is integrated on each one of the three other modules-PCB (demo-boards). The middleware (SW defined router) is used to interface the master-HR with the network of computers. HRs may also use energy harvesting and sustainability as well as wireless battery charging PCBs. All integrated communication systems and constituent technologies should be compatible with existing commercial communications infrastructure, frequency spectrum allocations, and applicable standards. Middleware-HRs may be needed if HR groups (private AZ network for instance) are using a different comm protocol than the typical computer comm networks.

Although the mechanical aspects and links are extremely important in this new technology, for instance to achieve agility, flexibility, autonomy and freedom of movement, the first HR generation are not meant to be extremely strong to lift heavy materials and equipments; they are rather meant to be as strong as other beings (HBs and animals), hence the name human-robot. It is though a super intellectual, agile and peaceful genius. It is mobile, made of light, green and recyclable materials, and self-sufficient (self-diagnostic, self-repair, self-maintained, self-sustained, self-task-scheduler, etc.). For instance, it knows when to recharge itself, when to hibernate, when to execute the most elaborate and energy-starving actions, and when to standby, possibly as a lamp, a hunger, or a computing and storage unit (data-center, server, etc.). Other HRs may grow to be very strong, to work in heavy industry environment, for instance to lift humans/goods and/or autonomously transport/deliver them to their destinations. They may take other shapes than the HB shape, have wheels and look like cars, motorcycles or scooters. HRs are intuitive and compatible systems with various computing platforms (Windows, Android, MacOS, iOS, etc.). HRs will instantly recognize each other. They don't need identification nor human interface to help them interact such as BLE or Wi-Fi credentials. They will recognize each other and they will know which ones belong to their private networks and which don't with zero-configuration. They may join a group if they have been invited, or want to and are accepted into it; they may leave a local group to get remote tasks (out of range) done or if they have been asked to do so. The HRs will be able to spot an outsider easily (through face recognition or through extended sense-connectivity) and if the doubt is arisen, they will diagnose, analyze the situation and alert the authorities.

Key parts of the communication system will allow private HR-communications where only HB-owners are allowed to tap in and that will include: 1) inner network, 2) local network and 3) remote network. The three of them can be strictly private (special comm. protocols and infrastructure) and/or using public networks (Wi-Fi network (802.11), and be protected with security code). HRs may work and collaborate within their private networks internally, locally and remotely autonomously and without human interventions, and will only deliver life signals and results to the HBs and the other computers. Besides the HR manufacturers (the HR-manufacturer and their customers), the HR-owners are allowed access into the HR OS only if they are cleared through multiple and various complex and sophisticated security tests. There will be three levels of security that are installed by: 1) the manufacturer that nobody else, but the manufacturer-security engineering team will be able to penetrate, 2) their customers (the ones that will make SW and HW modifications to the HRs' standard platform) and 3) the HR owner. Computers may include other technologies, such as smart-devices, servers, data-centers, IoTs, and the like. For instance, IoTs may be part of the HR network. In other words, HRs may control and drive autonomously all of our machineries.

HRs may be tested with elaborate test cases, to stimulate their behaviors, environment. HRs may be provoked through fault injection and various simulation tools to study their behavior for every possible function that they may fulfill, given their HW/SW designs. Customers may implement their own requirements and test/simulation tools. For instance, the original HR manufacturer may not create The Astronaut but rather sell to NASA engineering teams their standard HR platform so they can create the highly-reliable and radiation-tolerant HR.

Standard Remote Technology System [2, 3]

Every HR should be self-sufficient and operational with basic functions:
1. It may seek continuous and autonomous energy power harvesting for self-power through continuous connectivity to external power supply or through its wireless power charging base is possible. For mobility reasons, HRs are better off with a balanced harvesting and sustainable power systems. However, if the HR tasks are power-hungry and cannot be fulfilled by his solar panels for instance, the HR may autonomously and routinely plan for its power-charging between tasks or during the task-execution.
2. It may trace a network connection link (wired or wireless (Wi-Fi, cellular, etc.)) and aim to reconnect when none of the HR-group (family, city, country) has a connection to the rest of the world; will alert HB if not connected to the internet and will continue to operate autonomously as an individual or as a group. In case, access to the public network is not possible, the HR can remain autonomous, self-sufficient and functional 1) using his private inner network to communicate with his parts, 2) using his local private network to communicate with other HRs in his comm. range. He may use his human capabilities to connect with other connected or non-connected machines, such as IoTs and computers.
3. It may communicate with HBs, animals through its senses and machines that are not connected to the internet or the HR network by being able to use them similarly to HBs (type, turn-on/off a machine, etc.).
4. It may belong to two networks, strictly private (HR designed comm. network) and public (Wi-Fi 802.11, cellular, etc.) and when the public commercial network is not available, the HR will still function properly, similarly to an HB, through its private HR-network. It may update its brain to communicate with other networks such as the cellular, etc.
5. The HRs may also have no connection to any network (private nor public), and still be autonomous similarly to HBs. An HR may be limited to its own inner network (public or private) if his parts are wireless, or simply have no network connection if its parts are wired to each other. In any case, an HR should be autonomous, self-sufficient and functional, at least similarly to HBs.
6. Its parts may be connected through the manufacturer-HR network or through public network; it should remain always functional and private to itself, with a possible connection to the outside world. It may use the public network (Wi-Fi or cellular) to connect all of its parts, but if the public network is disconnected or congested, the HR-parts may switch automatically and autonomously to use the HR private network. Some parts may use at all times the public network while others remain using the private network. Also, some parts may be using both (private and public) continuously. For instance, the spine may be restricted to only use the private network; the brain to use the public to communicate with the outside world and the private to communicate with its parts. An HR-slave may also restrict all of its communications to be private only with its parts and the other HRs; the members of a DHR may restrict all their public communications to go through the brain of their master-HR.
7. It may communicate wirelessly with basic storage-HR that holds the basic HR functions. The HRs may use off or on-premise cloud (for storage, APIs/IPs, etc) to operate HRs within home, company and private locations.
8. It may operate autonomously, without having to be plugged to any power supply, being connected to a network (except the internal HR-network to connect its parts if equipped with wireless parts), with no external instructions from other IoTs, machines or HBs. It can operate autonomously, independently and continuously if it knows how to pace itself, self-power, and self-behave with no excessive but well-managed power-consumption, and indefinitely if it did not have to account for semiconductor devices wear-out and aging effects. As a minimum, an HR may operate as an HB.
9. It may seek autonomous connectivity to other HRs, other HBs and to the outside world through their public, personal (private), and remote network.
10. A personal-HR may operate in blockchain/supply chain manner; the HRs can handle digital transactions through digital wallets and among themselves.

Network Definitions

An HR network may be classified in three types of network, based on range, privileges and access.

1. Inner/Personal network that allows it to communicate with its own parts. This network may expand to be part of the local HR-network, so that all local HRs may use it for communication.

2. Local network operates within a given range using 802.11 or HR-private network. The HR private network may be using short, medium, or long range comms; it may be visible (allowing connections with others and being detected by other networks) or invisible (although each HR is communicating with its group, it is undetected by others); it can belong to a group or operate as a solo. HRs may then leave home and go to the grocery store, operate in neighborhoods and operate for door-to-door deliveries (mail, grocery, etc.), w/o having to switch to the cellular network, as long as they remain within range or have router-HRs to bridge them to the main network; they can also operate solo once they leave the local network and communicate with other HRs, similarly to the way that they communicate with HBs, and/or through cellular, other public networks or VPN.

3. Remote network that allows the HRs to communicate outside of a given range. Basic traditional architecture would be (local—cell-tower—local—etc.) where cell-towers can be replaced with router-HRs. In case the public network (Wi-Fi, cellular, etc.) is interrupted, a few HRs may serve as routers to bridge the HRs' private local networks. That way, an entirely private mobile network for HRs may be designed independently of commercial networks. Because of the HRs' mobility, the entire private network may be mobile and may expand to remote areas. For instance, a private DHR network may be installed and deployed in the desert of Argentina in a day, just the time for the HRs to reach their autonomously designated locations. The HR network is private, secure, exclusive (for an (in)visible society that may always be connected), mobile and reconfigurable. The latter means that the HR network may always adjust its positions and configurations to keep all HRs perfectly connected and within ranges; hence the main goal for a master-HR and the router-HRs. Configurations include the router-HR and master-HR assignments; the remaining HRs are slaves by default. An HR network may use an autonomous mobile Software Defined Radio (SDR) system.

An HR network may be an autonomous mobile hot spot that connects only where needed, and to make sure that all HRs are accounted for. This may be extremely helpful to groups with high security requirements, such as a police HR-workforce. In case, one HR is distancing himself from the private HR-network. The entire network of HRs may move towards his direction to keep him in range in case they can remain in their perimeters. In the opposite case, additional HR-routers may be autonomously inserted to keep the outside of range HR connected. The HR may choose to be independent and not connected to any network; this action has to be approved by the master-HR; if the HR that is leaving is the master then it has to delegate its actions to another master-HR before doing so.

An HR network is smart, mobile, reconfigurable, and private that can be public as well. In some cases, no public communication is allowed unless authorized by the master. DHRs operate in tribes, can have ghost communications that are not visible to any HB nor machine. Most of their communications with the outside world may be through their HB-like senses (touch, speech, vision, smell, hearing, and thinking). Their thinking embodies the most elaborate, autonomous, intuitive artificial intelligence, machine learning and networking techniques for its inner well-being, and proper-connectivity with the outside world. The entire private network may connect to publicly and commercially available networks (cell towers for instance) to allow connection with traditional machines (data-centers, computers, etc.) and IoTs. An HR network may be:

1. Public: Public connections are those that are not reliant on the private HR-network communications and connectivities, including those that are protected with Wi-Fi credentials and passwords, protected by VPN, or using the cellular network.

2. Private: A private HR-network is designed by the manufacturer using special networking protocols and processing techniques. It is purposely designed for continuous network connection no matter the outside security and environmental conditions in which it is operating. It can operate and network among each others or with the outside world through the traditional or added HR-routers in (non-)populated areas or far remote locations that may not have the public wireless and cellular network. It may buffer a connection for additional wireless local connections of HRs and other connected machines. It is primarily designed for the HRs' networking but it can be used to enhance the public network communications through mobility and autonomy, making it easy to setup a private network that can connect with the rest of world from anywhere. HRs may not need network engineer(s) to assign the HRs their tasks, transport or physically connect them. HRs may autonomously select and/or elect their master and routers, in conjunction with their master. They may self-assign their tasks, their most appropriate geographical and temporal locations and decide how to get there. They may autonomously move (walk, roll, fly, etc.) towards their designated locations so that they can create a reliable network in a record time and report their successful connection and their geographical configuration if required. Their relative proximities may range in Kms. They may open local hot-spot connections to other machines that are equipped with capabilities for wireless connectivity, similarly to cellular hot-spot. The local networks may be far more capable than the exiting hot-spot technologies (a few meters and low-speed); it may be comparable to a 5G network with 10s to 100s Kms range if needed. It can also operate similarly to a Wi-Fi wireless network. The high ranges will be needed so HRs may go to the grocery-store with us, play a soccer-game, be deployed as a police workforce or any company workforce while still being connected through their private network no matter when, where they are and how fast they are moving. The routers will move autonomously to connect and bridge the distributed HRs (DHR).

In case the HRs/DHR are restricted from connecting to the public network, a router-HR may also be a wireless connection base that connects the DHR to the public network. Various configurations may be considered for the HR/DHR networking among themselves and with the outside world.

Besides being constantly connected with the HR inner personal network, each HR may be connected through various HR network implementations. Examples are when an HR network uses a:
1. Basic traditional cellular network (cellular w/ or w/o hotspot—cell tower—cellular w/ or w/o hotspot—etc.).
2. Basic traditional network (local (Wi-Fi)—routers/cell towers—local (Wi-Fi)—etc.).
3. Private Wireless HR network (local (HR-network (Wi-Fi))—HR routers—local (HR-network (Wi-Fi))—etc.).
4. Private Cellular HR network (local (HR-cell-network (5G))—HR routers—local (HR-cell-network (5G))—etc.).

Group: An HR can be part of a group and be locally or remotely connected to its group. To remotely connect to its private group, an HR may 1) use the public network (local, cell-tower (for instance), etc.) and then reply to the security codes to rejoin its group or 2) use the router-HRs to reconnect to its group. The former method is similar to using VPN, while the latter is reliant on range extension and HRs mobility and adaptable reconfiguration. In the second case, the remote HR range is extended from the remote HR to the original HR-group or the entire HR group is rearranging its locations to bring back or keep the remote HR within a local range. When using VPN, the remote device may connect through the public network. Connection with others (HRs, IoTs, cell-towers to bridge HR-networks, etc.) may be established autonomously or may be initiated through communications with HBs. An HB may connect and place/locate a number of HRs by simply talking to the group, to each one of them or to the master-HR only, which in its turn may connect all other HRs in his group. For instance, an HB may say: “HR1 connect to all home-HRs with HR1 being the master in the kitchen and HR4 the router in the center of the house of the first floor. HR2 go to living-room, HR3 go to dining-room and HR5 in the downstairs guest bedroom. HR4 you are the router at all times”. The three HRs will then connect, acknowledge their connections and move anywhere in their assigned locations. An HR may also connect all other HRs to the private or public network with a simple voice-command: “Connect all HRs to the home Wi-Fi, password is XXX”.

Before leaving the local network, an HR should decide if he is planning to leave the local-network to rejoin remotely through the private or the public remote-network, or become unconnected (solo operation). In case an HR becomes unconnected, then most of his safety measures will be reliant on his high-security level (the spiritual level) to always make the right decisions and take the right actions. Although, the need to physically stop an HR before that it commits a destructive event is highly unlikely (almost not needed), an emergency protocol and system may be added to each HR to forcefully stop him in the case of an emergency. Before entering secure perimeters, an HR may transfer its emergency code to a trusted person (security guard, etc.) so he can stop him when needed.

An HR may take various shapes such as animal shapes. Animal-robots may be used for the thrill of a chase; its initial standard body may have an HB-like shape that can evolve through time to include additional capabilities and enhance the standard HR platform. It may mainly have a skeleton that can be detachable, with articulations that physically attach all of the HR-parts (legs, arms, etc.). Each part of the HR may be detachable; in this case the articulation can extend/collapse its bars/leaves (bones) and grab/un-grab its hooks within both connected parts to create a strong physical connection between both sides. The strength of the skeleton will be variable with its intended application. A body-guard will have numerous strong ribs, hands and anti-threat detection system; an intellectual such as a teacher, a journalist, a psychiatrist may be softer, with fewer ribs for instance, but will have an elaborate high performance computing system to be able to communicate and elaborate on most subjects.

In addition to being able to display a nemoji, a given photo/picture, an HR can have a color, such as black, white or brown, using LED lightning system. It can look Indian, Chinese, caucasian, latino, native Indian or any other race, by changing its face expressions. The mechanics of the face can adapt to the user requests to show fuller cheeks for instance, stretched eyes, thicker lips, etc. Its height may compress and expand to various heights and weights, through electromechanical stretching (size 0 to 16 for instance). It may speak any language and dialect and switch between them instantly. It may shape as a woman or a man, a kid or an old man, etc. It may have freckles, tan, makeup; it can demonstrate the use of makeup and may apply it on the HB. An HB may try makeup on his double-HR before deciding to use it. An HR may autonomously adapt to an HB shape; an HB may have to simply tell an HR “be me”. The HR may demonstrate plastic surgery prior to its implementation. The HR may simply take various faces through touch/gestures/signs or an HB request. For instance, an HB may say “widen eye shape”, and the HR will show a wider eye. The HB may reshape the HR eyes with his hands or through his words, simply by applying force on the actuator-MEMS, displaying a gesture for the eyes sensor-MEMS that surround the eyes and saying for instance “reshape eyes this way” or “add smokey eyes”. An HR may understand an HB or other HR gestures to then reshape and color the eyes accordingly. An HB may apply makeup on HR in realtime, it can for instance say: “apply red on this area” and then touches the cheeks in a certain way, the HR will then display red on that area by turning-on the red LEDs beneath the cheeks skin for instance.

An HR may have moldable face (pottery like), with high resolution MEMS/actuators and/or similar technologies, so it can be driven by CAD. An HR face may be re-shapable by others like pottery, manually, programmatically or autonomously. An HR may take various shapes per the HB commands (in a written form or verbally), programmatically and/or autonomously. For instance, an HR may age, gain weight, wear various virtual dresses, etc. An HR reshaping may be done on the HB digital picture (using CAD tools) that can then be projected to the HR so it may reshape its face in realtime.

A standard HR system/platform:
1. May have physical/wireless HB-like senses, such as touch/sense (wireless-touch), speech, vision, smell, hearing, and thinking (AI, Intuitive-I, ML, Communications and Connectivity). Connectivity is usually with other connected machines, HRs, the network, the web, etc. HR-communications may be with HBs, connected machines and every other machine.
2. May move to walk, jump, rotate, spin, tilt, fly, bend, etc. It may execute all sort of movements in every axis (x, y, z) and every angle with free movements (entirely dissociated from other networks).
3. May have various electro-mechanical capabilities: First standard platform may only have the basic autonomous anatomy.
   1. Basic autonomous anatomy, to stand walk, talk, see, self-sustain (self-charge, self-power (energy-harvesting)), self-test/diagnose/repair, self-connect (inner and outer to the public network), with strict minimum task-execution, such as collecting, reading a document, sitting, clapping, etc. Most of its basic functionalities are programmed. Additional functionalities may be learnt through ML or programmed.
   2. Architectural layer: spiritual (strictly restricted for basic functionality of the HR and cannot be accessed by anyone (see text above)), subconscious (can be accessed by HR and very little by HB), and conscious (can be accessed by HR/HB).
   3. AI/ML/NI: for thinking and learning
   4. Free movement and mobility: such as flying, dissociating, etc.
   5. Training: HR(s) may be trained individually or collectively to execute various tasks by HB(s) or other HR(s). For instance, the HB may train the HR to get a glass of water; the routine may be recorded by the HR, analyzed and reproduced. Such trainings are part of newly invented ML training techniques: behavioral learning (BL) or spontaneous learning (SL). Typically, machines are trained by data. In this case, HRs may be trained and taught by HBs or other HRs to store real-life data such as videos and audios; the video in this case will be analyzed and decoded so every object/HB will be recognized from their video and the actions be reproduced by the HR. For instance, an HB (while dictating his actions), may teach the HR to record him grabbing a glass, running the faucet, filling the glass with water and turning off the faucet and turning to hand it to another HB. The teacher-HB may then ask the HR to repeat the action; in that case, the HR will redo the same action but while replacing the teacher-HB with itself. Other sophisticated tasks may be added and may accelerate tremendously the training of a house-keeper, a new technician, the most sophisticated tasks, and especially the training of HRs without the need to reprogram them but by simply teaching them by example of how to behave, act and speak, similarly to children, interns, etc. The HR may then attend various teacher classes and repeat the same classes with other students. The same routines may be included among already automated and programmed tasks; be part of a bigger routine and/or be augmented with other information and tasks. HRs may also train and learn by itself by watching HBs through SL for instance when doing their home-chores. Additionally, if an HB instructs the HR to “Watch and Learn” and then grabbed an egg from the fridge, boiled it and ate it, the HR will learn the routine by identifying the egg, the boiling water, the fridge and the boiling egg routine and will hand it to the HB to eat in a small plate given the size of the egg; it will place the plate on a serving tray and with a glass of water because it did learn before that it cannot serve food w/o a glass of water. It can also learn from food chefs live or on the food network cable channel and reproduce the same routines to HBs. Therefore, instead of teaching the HR every action, we will teach them how to interpret an image, a video (Youtube for instance), to learn from them, etc. Therefore, instead of having a professional SW engineer programming all new routines or the HR using only the traditional ML techniques, the HR will learn by itself from information that it can collect from its web searches for instance, watching others (SL) and/or through “watch and learn” sessions. Indeed, we can teach the HR to search the web and to ask the right questions, pick the right answers and learn. We can teach the HR(s) also to read various books (computer vision), watch millions of ballet dance routines, listen to a piece of music and then assemble/sync all of them autonomously to create a unique choreography, a symphony or an opera. It can learn various routines (lifestyle, food preparation, acting, dance, science, etc.) and adopt the best teaching techniques to teach other teachers or students a single best routine/meal, a unique combination of the learnt routines, a different one at every iteration, etc. The HR may learn a job by learning from another HB/HR/machine/data/code without any line of initially and purposely written programmed code. This may be crucial in machine design, manufacturing, etc. The HR should have key technical talents such as an excellent computer vision, data-science (classification, prediction, decision making, etc.), ML. The learnt routines may be shared between various groups and integrated to be part of future HR SW/HW versions or coded by the HR itself into his system. In other words, a restaurant chef that has no programming skills may train his HR-helpers on the fly to cook recipes that have not been coded or written, by simply cooking in front of him; he may also provide him with a food recipe to read and cook or simply ask him to download a couscous recipe from the web and cook it. He may also ask him: “Would you please prepare a couscous for us?”, the HR will then use his knowledge to cook the couscous and if not knowledgeable enough, it will download the recipe from the web and prepare the food.
   6. Physical and wireless communication with HBs/HRs/IoTs, avoidance, syncing, correlation of thoughts with actions, making contact, grab, apply/feel/control pressure/force. Talk to HBs/HRs. Communicating with IoTs locally or remotely, use machines even when not connected to the internet or any other network.
   7. Recognition of voice, speech (code messages not necessarily from someone that we know), sound, event, action, landscape, object, facial, image, text, plans, figures, diagrams, algorithms, signs, group of people, location, video, behavior, emotion, grimace, gesture/sign, information, environment, climate, weather, gender, HBs and HB measurements, etc. Animals, objects, may be recognized from their skin and shapes, etc.
   8. Prediction of events from previous and current situations, events and actions (similar to Finite State Machine (FSM))
   9. Connectivity with the private and public, local and remote networks/IoTs/Internet/Cloud for storage and runtime code.
   10. Cybersecurity, physical security from (un)intentional harm (from the HR itself, other machines or other HRs/HBs).
   11. DHR and routing: static or mobile networks with mobile autonomous routers.
      1. Zero configuration static or mobile networks independently of physical HW network infrastructure-layers
         1. self-recognition w/o SSID/password, simply through face recognition
         2. The HRs will calculate their relative proximities and will adjust accordingly so they can remain in range and connected with each other. They may use accelerometers and various IPs (CORDIC, etc.) to calculate their relative coordinates, with the master-HR or the router-HR as the reference coordinate.
         3. In case an HR approaches the limit perimeter, the master-HR may alert the slave-HR to get back within range, readjust its position and other HRs positions, or add another router-HR to bridge the HR that is getting away from the initial range. The position of the router HR will be calculated so all HRs will have minimum distances from the master and the slave-HRs. Two router-HRs may be added to allow an HR to get further.
      2. Zero configuration static/mobile networks (self-recognition w/o SSID/password, simply through face recognition). The HRs will be able to self-recognize through their Nemoji, serial numbers displayed into their eyes for instance, approval from the HBs through voice/face/gesture recognition. An HR may be signed in the HR network, if simply recognized by master-HR or allowed by HB. For added security, an HR may have to be approved by all HRs to join a group. A master HR will survey the group normal operations and will detect a new corner (HR or other) and will autonomously attempt to connect and recognize with him. A master-HR will alert HB if an HR cannot or should not join a group and will provide explanations. Two or multiple HR-groups may sync into one group if the master-HRs will allow it.
      3. If allowed by the HB, the first HR may authorize all other HRs in range and if recognized by HR as part of the group to access the HR-network. Each HR will seek entry and if allowed by the HB, the master and slave-HRs will communicate to exchange security codes, agree on the security questions and their answers, that only those HRs that belong to the group will know. In future use, each HR that will seek (re)entry to the group will have to answer these questions and pass these tests. Each new HR, IoT or HB that will seek private or direct connectivity or communication with this HR, should know the answers to these questions, otherwise it will have to communicate with the master.
      4. HR-Groups with privileged access, such as family members, company employees, etc
      5. For added security, the higher is the number of connected HRs, the higher are the risks to infiltrate the HR group and the tougher it is to enter a group of HRs. Any outsider who needs to gain access to the HR group needs to answer all security questions. No HR will join the group unless allowed by the group; in this case, the master-HR will then transfer the new HR the answers to the security questions, if allowed by the HB and/or authorized by the master.
      6. Extended sense-connectivity (communication, vision, listening, smell, etc.) and networking to build a real life scene in realtime.
      7. All communications may remain strictly private (no communications with the outside world) unless danger is imminent or the HR is needing connection to the public network to get SW updates, etc.
      8. All outside-communications with the HRs can be restricted to be with a single HR-part (the brain for instance), or each one or a group of its parts.
      9. Comms with HR can be like mail delivery, where only notifications/messages can be delivered and scanned but outsiders cannot read/change (rewrite) the current HR programming. There are three levels of connections to the HRs: 1) secure from other HRs in the group, 2) secure with HR-owners and authorized HBs to access certain layers of the HR, and 3) outside world (guests, other HRs that do not belong to the HR-group, web, etc).

HR Senses & Capabilities: The HR has HB/animal-like senses and capabilities that are also comparable to high-performance computing connected machines (computers, data-centers, etc.). For instance, an HR can see/hear/smell further and better than any HB because of its machine-like qualities and autonomous extended connectivity. In the following, examples for its use will be highlighted. An HR may be the best companion to handicaps, helpless and needy people and the best support for care-givers. Humans are usually uncomfortable to learn from other HBs but will have no problem learning from an HR as long as they know that that conversation was kept private to not show their lack of knowledge about the subject, which may be a sign of ignorance or lack of qualification to perform a given job, and then the fear of being judged or simply loosing their jobs for lack of qualifications or being mocked (in school for instance). This is why, many HR/HB conversations should be carried out strictly privately, whether for confidential or intimacy and privacy reasons. Providing the student, the intern, the technician and the learner with privacy till they gain confidence, similarly to parents with their children may be set to healthy communications in some cases. Such feature will mean that the HR will have an efficient detection system that will allow him to detect the premises for intrusion and to monitor its system for optimum cyber-security. Part of the HR is always alert and that is the spiritual layer and parts of the subconscious layer, always powered to never run out of power, ready first and foremost to defend itself and its perimeters. Its surveillance and security systems are quite elaborate and always on.

An HB may be with his kids at all times if connected to their HRs, with no major effort on their side, monitor, supervise and connect. The HR will be the camera/audio man during a soccer game. The HRs may ally to create and help a foster care system, build a restaurant, a dance-group, an emergency volunteer-group, a ballet performance, a company, a post-office, or a warehouse/farm (local or global)/individual for automated door-to-door deliveries.

The HR can be static or mobile, and should be:
1. Intelligent and Intuitive: know basic behaviors and actions and be capable of learning other routines and from others and adapt to its new environment. It may have different, numerous or a combination of categories and jobs: home-jobs, city-jobs, home/office work, etc.
   1. AI for problem solving: Such as how to turn machines off/on, basic recognitions (image, dimensions, objects, etc.), know how to communicate with the outside world and with other HRs, know how to protect itself and others, how to self-store, store in the cloud or elsewhere, how to research that information, how to search the web, the cloud, how to power and charge itself, able to learn (DL, BL, SL, etc.), etc. Additionally, HR may have an initial state: basic knowledge for intended job, for instance, K12 teacher, etc. The standard platform will grow and may have various standard APIs to be downloaded for each job. Some examples are:
      1. Initial behavior: intelligence, knowledge, know-how, skills, initial capabilities,
      2. Potential: what they are capable of learning at this stage, their potential growth (from aircraft technician to aerospace engineer for instance).
      3. Processing, computing, multi-tasking, multi-sharing
      4. Analytics, event prediction, decision making, etc.
      5. Security, Safety, Cybersecurity with various
         1. Levels of protection: for instance green (routine monitoring for invaders), orange (critical), red (highly-critical), similarly to the traffic lights. For instance, for highly-critical applications, the entire HR-group is strictly private and with no possible connection to the public network. In this case, the data-centers for the cloud usage, may also be private and mobile as an HR-data-center.
         2. HR architectural layers: 1) spiritual, 2) subconscious and 3) conscious.
         3. Key and shared goals (what level of security needs to be achieved), reactions (how to respond to an attack or violation), preventions (surveillance and removal of physical tracks after programming the spiritual layer), type of alerts and who to alert, etc.
         4. The security system to track and disable the source of the violations and the counterfeiters
         5. Self-protection. What levels of security? What layer to protect or to erase in case of a violation.
      6. Data-storage, code-usage
      7. Power-charging (plugged or wireless), energy harvesting and sustainability
      8. Autonomous communications among the HRs (senses comms, data-sharing and data-transfer) and between the HRs and the HBs (senses comms):
         1. Using the network (connected) or using the HR senses. Two HRs that are not connected for instance because they do not belong to the same group, may communicate through facial expressions, similarly to an HR and an HB communication style (signs, speech, expressions, etc.).
         2. Direct and Indirect: HR-communications may be indirect, always through the master-HR. For instance when only the master-HR is allowed to communicate with the public network or the HB, or when needing to communicate through the router-HR to bridge the distances between two HRs. Upon the master-HR approval, most of the HR-communications are direct to maximize their efficiencies.
         3. WAVER, Big-Data and cloud technologies (remote prober patent): HR to cloud, HR to HR, HR to a connected machine (computers, IoTs, etc.), HR to HB (long sequence of communications with many HBs for instance, such “watch and learn videos”), etc.
         4. Control-commands, graphic, etc.
      9. Autonomy (self and within a group)
      10. Mobility: The HR is capable to communicate with his surroundings by accurately calculating and measuring his environment; for instance, using computer vision and MEMS/Sensor/radar/LIDAR technologies, it will instantly measure the size of a room, locate every item in it, and any foreign object entering and exiting the room. It will take a mental picture every time he detects a change in the room through his LIDARs, RADARs, sensors, motion detectors, etc. It will analyze the image to update the scene. For instance, a family-HR will instantly recognize and greet a family-member when entering the home.
      11. Connectivity (private and public)
         1. Belong to a group: distributed intelligent system that is private but can go public through its master or individually
            1. Private networks, all private, no comm with outside world except through approved master-HR
            2. All HR-group, if within range, is connected.
            3. New HRs may join the group if approved by the master-HR and in cases where security is paramount, the approval of all HRs and the HB owners is required.
            4. An HR may exit and return to his group instantly without signing off or in, and in both cases, the group and the owner HR will be notified usually by the master HR or the closest HR. Idem for he public network, an HR may leave and get back w/o signing in if initially approved by the master-HR that is already authorized by the HB to handle the HR-group.
            5. The master-HR or router-HR will alert the HR that is approaching the maximum range (perimeters), of the possibility of loosing contact, so it can return to the premises; all HRs should also know the perimeters of their operation areas. When moving, the slave-HR may also continuously monitor its location relatively to the master or router-HR, and alert the master-HR to bridge him with a router-HR, or readjust the master-HR or the group-HR locations, if he needs to get out of range but remain connected w/o having to use other networks than the AZ-HR private network.
            6. Mobile Networks: The HR group move, think and operate as one and so is their network. The master-HR will provide all other HRs of his coordinates and the range of its connectivity. Other HR-routers may be autonomously inserted/redirected to extend the HR ranges and connectivity. Slave-HRs may communicate internally without the authorization of a master-HR. The same functionality will remain valid even when the entire network or a single HR is moving. HRs that belong to the same group, may continuously adjust their positions so they can remain connected at all times. The HRs will even calculate the best positions to get the best bandwidth and communication speed. They will simply cluster closer to perform certain collective tasks and disperse to perform more autonomous tasks. Each HR can know the coordinates of each HR, if allowed by master. They can ally with a few HRs, work solo, or go silent for a while. In case an HR has to leave the group but still remain in range, various HR-routers may be added to bridge the HRs. They can cluster, disperse, take various configurations, operate in tribes, etc.
            7. HRs may also intentionally leave the local-range premises. An HR can seek to autonomously rejoin his group while being remote (similarly to VPN or using the extended range) or operate individually with or without connections to any other HR or machine. He will have privilege connections to rejoin his group.
            8. The group usually follows the master, but if a master-HR intentionally decides to leave his group, he may assign another master-HR to take his place and delegate him his tasks till his return. He may also choose the entire HR-group operating autonomously. The new master-HR may also be elected by the HR-group, given his proximity and capabilities (data-center, High Performance Computing (HPC), etc.). Both of the master and the router-HRs may be elected by the HR-group or the authorized HB. An HR group may have a single or multiple master-HRs; it may also have a single or multiple router-HRs, or none. An HR group may change, temporarily or permanently, the master and router HRs, if other HRs are better fit for such functions. A master HR can be a router-HR as well.
            9. The master HR decides (per prior agreements with the HB) if each HR should be using exclusively the public or the private network, or simply both depending on the nature of their tasks. By default, most HRs will aim to use the private network (if initially available), unless specifically asked to use the public network.
            10. Self-recognition and identification: How to identify and recognize an HR: by his DNA, nemoji, being able to answer the security questions, security passwords, signs, etc. Each HR should be recognized by the entire HR-group; each HR may recognize the HR in question differently to strengthen the security system. Each HR may have a name, a face, a job and/or most of the HB-characteristics. Each HR may choose to be visible (connected) or hidden from the group (disconnected, purposely invisible or unnoticeable). An HR may be virtual, for instance, seen only on computer or on VR glasses.
            1. Each HR may elect to have a unique HR-face, color, shape, size, height, etc. All can be changed by HR, if decent and acceptable by the society measures, except DNA (serial number, nemoji that is a combination of the owner-HB face and emoji for instance) that will differentiate him from all HRs.
            2. HRs will recognize, by face, voice, passwords, etc., their owner and authorized HBs and have/allow privileged communications with them.
            3. The HRs will organize in groups and subgroups. Not all HRs will be allowed to join a given group. For instance, the health-HRs group will include doctor-HRs, nurse-HRs sub-groups. Other HRs, such as pharmaceutical-HRs may communicate with a doctor-HR but not integrate his group to have the same privileged comms, such as sharing the doctors code of conduct. Shared documentations may be categorized by groups. For instance, patient records may be shared with doctor-HRs/HBs and nurse-HRs/HBs but not with pharmaceutical-HRs.
            4. An HR may remain solo or join various groups (family, work, city, country, etc.). Be always local, always remote, or both of them at different times.
            5. Not all HRs will be allowed in a group (country) and approved for entry if not having the appropriate documentation or identification document (driver license, visa, etc.). A delivery man may not enter a company if it does not have the proper security code. Similarly, to badges, their DNA/ID may limit their entries to certain areas, buildings, etc.
            6. Groups can be family, city, company, clubs, neighborhoods, etc. For instance, city HR-groups may include garbage collectors, police-force, or any organization that is paid or funded by the city.
            7. If an HR leaves a group, then he can remotely rejoin with limited, same or other set of privileges. Typically, he will not have access to all communications with his original group but with some updates from the group, when necessary.
            8. A group HR may share and distribute tasks among themselves given their proximities, capabilities, availabilities and previous assigned tasks.
            9. An HR may be replaced by another HR for a short or long period, or permanently similarly to an employee.
         2. Autonomous
         3. Mobile networks
         4. When the master-HR gains access, it will enable all other HRs to also gain access to the network if initially allowed to do so, without the need to manually enter again or dictate the Wi-Fi credentials. A group of selected HRs, or an entire HR-group may be connected with a single password to the public Wi-Fi, if approved by the owner HB or the master-HR (if already authorized by the HB to operate autonomously).
         5. Measurements & HR appearances: Shape changes: HR to help with measurement anywhere. It will be able to measure any object in his surroundings, including HBs sizes. It will be able to virtually try clothes for them by changing his shape to accommodate the HB dimensions or by simply projecting the HB image wearing those clothes on the HB or on any other surface, in real-scale or other sizes (miniaturized for instance).
            1. It can adjust to HB shapes try clothes using airbags (inflate, deflate using MEMS-actuators) or simply change shape for better mobility, such as flying.
            2. It can take camera shots with controllable zoom adjustment or projects Virtual Augmented Reality (VARs) (tinker bell (TB) patent).
            3. HR can measure and project virtual furniture in living-room (TB patent)
            4. HRs (bee-HRs) can control projection by surrounding the area, such as in a summation (TB patent)
   2. AI/II/NI/etc., ML (DL, BL, SL)
      1. NI: have the basic communication skills such as using salutations, have facial expressions and basic reactions to its environment; it will adapt to the location culture and habits and have well-thought and planned but natural actions, say and do the right things at the right times.
   3. Self-control: each HR will have a safety layer that cannot be affected by any other HR or HB. It is for its own safety, sanity, and security. It is always operating in the background to protect the HR primarily.
2. Think, understand, process, compute and analyze:
   1. An HR may use the help of SiRi, Watson, Alexa, Google.
   2. For instance, an HR and an IoT fridge may communicate wirelessly, in other words, the HR may turn off/on the fridge without touching it by simply connecting and communicating with the fridge wireless system
   3. An HR may be a fair judge of each situation, independently of a race, an ethnicity, the number of people involved. For instance, in an environment that is asian, latino, black or white predominant, a judge-HR will always be able to judge fairly, even if that is against the majority and no matter the outcome of that decision. Such HR may be used in hiring jobs, in policing, in courts, and in conflict zones in general. Given the HR robotic nature and his ability to be emotionless, the HR won't be afraid of the outcome of his decisions, the economical or social consequences of his decisions and will be able to always make the right decision. HBs will not be able to do it, given that they are always susceptible to prejudice, racism and intimidation. Such HRs may evolve major social and race frictions that are currently emerging in most societies. The sense of fairness and true justice that a judge-HR will have should calm most people so nobody will feel oppressed nor discriminated against. It can see most legal issues from every angle and should follow the moral code that HBs are striving to achieve. It will also follow the law at all times, make sure that all communities are represented and respected, without favoring any race/religion over another. Such measures should lead to a better society that is harmonious and where rewards are truly given on individual merit basis. Such choice should ease the mind set of most citizens and be the basis of most democratic societies. In time, societies will mix proportionally and naturally without forcing it to change course and/or favor any group. It will educate societies and will be able to complete all kinds of people, handy-men, intellectuals, artists, etc. There is only one measure, what you can do and how you do it. Nobody is favored over another no matter his race, his status, his origin, his wealth, etc. Most people would agree with this and may feel good to live in such environment.
   4. Machine-like Capabilities:
      1. Compute, Display, Project (multimedia, sound (talk, broadcast), video, odor/fragrance/perfume, force/pressure/wind/kick/impact, etc.)
      2. Analyze, etc.
      3. It will know how to search for information, people, w/o overloading his system, so instead of storing all of google databases and libraries, it will know how to search into them instantly and provide, analyze, detail and explain the right information, with a tracking system on his torso if needed.
   5. It will have a single or multiple brains (computers) to think, It may get help from SiRi, Watson, etc.
3. Vision: Autonomous Computer Vision: See, identify, recognize, distinguish, classify, predict, decide, act, process, compute, measure, protect, alert, record, communicate, broadcast, detect, decide on when and what to detect (what should get the HR attention). The HR may rest his eyes (hibernate) if there is no movement in the room and wake-up only when its detection mechanism has detected an event that it should see.
   1. Feel and Detect: decide on when and what to detect (what should get the HR attention); selective detection
      1. Can be done through continuous multi shot camera or through sense-detectors (motion, smell, etc.). Because of the high-cost of sensor technologies and for less critical HRs, the HR may do without the sensors or motion detectors, and make use of his front and back cameras to continually take photos (once in a minute for instance) to detect changes in his surroundings. If it detects a moving target when analyzing the changes in the taken pictures then it will accelerate its snapshot system or simply switch to video mode to be able to track the changing scene and the moving target faster. The time between the snapshots is adjustable, programmatically by the HB or autonomously by the HR.
      2. Vision range mapping of every part of the room (objects, shapes, dimensions and locations)
      3. Can detect in real time HB behaviors, emotions, movements,
      4. Events through LIDAR, motion detector, proximity,
      5. Computer vision can go to sleep/standby mode and is alerted only by sensors (motion, light, touch, smell, etc.), radar (sound, ultrasound), connected devices, etc.
      6. Decide instantly on the upcoming event (guest, danger, family-member, delivery, etc.)
      7. Need and follow-up with a comm between HR and HB to decide on what should be done. For instance, upon the detection of a family-member, the HR will open the door and greet him; however if the detected person is the mail man or the grocery delivery person, then it will open the door, greet the person, get the merchandise and sign, say goodbye, and close the door. Finally, if that is a stranger, the HR will consult with the HB before opening the door. The HR may even instantly search the web to recognize the person and alert the owner-HB of the visiting HR.
      8. The HR will detect an event such as a movement or a sound and will decide on what to do, what to follow, how to act, and how to track it so it can get decide on how to react (acknowledge, record, etc.).
      9. Provide daily analytics of the visitors, family activities, what they ate, how nice they were to each other, run family therapy-sessions, couple counseling, etc. The HR may take the tensions from the family members by acknowledging by helping all family-members.
      10. RFID, measure distance and calculate coordinates, set and define perimeters for its vision range, prepare to move to see more (mobility) or to coordinate with other HRs to cover more range. Router-HRs or special range-HRs may be used to cover more vision range for surveillance for instance.
      11. Can be directed by other HBs, through signs, speech, or another communication way, to focus on one area or to move in another direction to cover another area.
      12. An HR will always know and inform of his location (coordinates), and the locations and proximities of other objects, be able to measure their threats, the speed and the acceleration rate of a moving object (using the camera shots or the LIDARs). An HR designer should account for the minimum required time to detect a change in the room, take a snapshot, analyze its constituents and decide on this next action. That time should not be slower than the naked eye speed of detecting new objects, so there will be no noticeable discontinuities for the HB. The HR can certainly be faster than an HB and so his reaction time to stop any threat. If there is no anticipated threat then the HR can slow down his camera snapshot detection; in the opposite case, the HR can speed his detection and plan his reaction at the same time (in pipeline mode).
      13. An HR may display or project the recorded view of his surroundings in 2D/3D/MD (multi-dimensional) from every angle or position. The HR may fly or climb walls or turn around object to detect the right view.
      14. An HR can insert other virtual individuals in a real view (mixed-reality) or in his virtual augmented reality (VAR). An HR may display the face or the nemoji of an HB/HR, such as a family member, in your living room or anywhere. Both HBs communicating through the HRs can have the same impression with their HRs, or in their videos. The HBs may choose the location of the meeting, for instance in HB1 or HB2 space, or where there is an HR if only HB1 has an HR for instance. Each HB will be able to see the other HR as a true guest in the selected space (HB1 room for instance). The projected image will be from the view angle of the selected HR. The invited HB2 can choose to use the HR to tour the home and move freely in the HB1 space (home for instance), of course if allowed by the HB1. Many HBs can be guests as well in HB1 home using the same HR or various HRs, so each one of them can move freely in the HB1 space, as if they are truly present in HB1 home. HB2 may be using a smart-device (phone, tablet, VAR glasses, his own HR, etc.) to view the remote scene; he may choose to project his nemoji to the remote HR (located in the HB1 space). The HB2 may take control of the remote HR1, if allowed by the HB1. The same situation can be applicable to many HRs and HBs. Many HRs may ally to virtually recreate a scene, etc, from his angle.
      15. The HR vision capabilities should adjust in real time with the HR position and environments and other static or moving targets.
      16. It will always locate other HRs even when they are not in his vision range, as long as they are in his network range. It can also know their vision range and broadcast it to all HRs, so each HR can instantly extend their vision trough another or multiple HRs. The multiple views may be displayed on an HR torso, projected, coordinated so an HB/HR may easily be followed from one location to another.
      17. Each HR may disappear from public view when needed but still communicate with other HRs through private network so it is inaccessible to HBs. He may make that decision or have the master-HRs decide. The latter can decide on the HRs that will be visible to other HRs/connected-machines or that can communicate with other HBs; optimize the network.
      18. HRs can recreate a scene virtually or realistically, the temperature, pressure, image, video, scent, virtual, real people, etc. A crime scene for instance, HR mental or physical condition, daytime (day, night, time), environment condition, weather, duration, local or remote attendees, etc.
      19. Scenes may be recorded selectively or continuously for instance each time two people meet and not a few times, group meetings for consistency and for real context of events
      20. A scene can be reproduced from multiple HRs/scenes to see all angles and each HR side or version.
      21. No need for camera-man; if allowed by the present HBs, an HR will be able to record and project a scene, an event such as a wedding live and in real time or offline from every angle to all or a group of people or for archiving. HR may ally with others to do it.
      22. How to measure: camera shot (zoom, relative distance, object size) and accelerometer location to locate coordinates of first and second locations and then deduce the difference.
      23. How to mentally redraw the room constituents (HBs, objects, etc.) shapes, geometries.
         1. Take initial camera snapshot (360 degrees or panorama), analyze picture for its constituents, similarly to the measurement caption but this time with real shapes; code the inside of the room (dimensions of the room, objects, relative position and shape of every object). The LIDARs should be able to detect their materials.
         2. The cameras should also be able to detect their materials if they are close enough. The HR can zoom in and focus on a given location and get more insight on that material (wood, metal, etc.)
         3. Stay tuned for any change in the room through its detectors; take a new snapshot as soon as a change has been detected or simply repeat 1 and 2 if needed.
         4. Videos can be treated the same way; they are simply a sequence of multiple camera shots. With adequate sensor technology, the need for continuous camera shots can be reduced. A new photo is taken only if a change is detected
   2. See, identify, recognize, distinguish, classify, predict, decide, act, process, protect, alert, record, communicate, broadcast
      1. The HR vision is mainly based on his computer vision that is synchronized with motion/light-detectors that can allow the HR to detect any visual event, such as a moving target, an object entering or leaving their perimeter. The HR can detect any approaching from every angle (back and front), altitude or latitude to his body and his vision range; it can see from his front single or multiple eyes that can be in his head or other location of his body, depending on the HR mission. Esthetically, the standard-HR may have two eyes in his head, similarly to an HB and possibly others in other parts of his body with a different discrete design if needed. For instance, other eyes may be hidden in his back, etc.
      2. The HR vision is synchronized with thorough AI/NI/ML techniques such as object detection, recognition, interpretation to understand and predict, classification, analytics, further research, information, elaboration, action, assistance, awareness, data-search for information on the cloud, the web, in physically available or virtual documents (such as books). Actions can be analytical and informative, physical and assistive, safety and protection. They can be routine or specialist actions. The specialist actions, such as a surgeon work, are restricted by guidelines, licenses, certifications that can be downloaded, used and followed and HB approvals.
   3. Record a scene, decide what and when to record, be selective, random, or deterministic, all scenes should be detected in real-time
      1. The HR vision is synchronized with real-time speech and communication system, such as a commenting system on scenes, visiting persons, or a potential threat. It will know what to say, how to act and when to say or do something.
      2. Record a scene, decide what to record and when, specifically asked to and told to snap a picture and record at a certain time, or during a crime scene. The crime scene will be automatically recorded.
      3. Classify, decide, filter, store, display and project on its torso or on another connected screen.
      4. Be selective on what and when to detect, record and store
   4. The HR can be put to “blind” mode if HBs need privacy, but will instantly turn back to normal mode as soon as it detects an approaching HB/HR/object.
   5. It may use its other senses such as speech to promptly describe the scene/view, provide real-time guidance for vision-impaired people, narrate a book.
4. Speech:
   1. The HR can detect any approaching from every angle (back and front), altitude or latitude to his body and his vision range; it can see from his front single or multiple eyes that can be in his head or other location of his body, depending on the HR mission. Esthetically, the standard-HR may have two ears in his head, similarly to an HB and possibly others in other parts of his body with a different discrete design if needed.
   2. Speaker-qualities, such as sound amplification, controlled volume, controlled emotion/tone (shout out of fear or out of happiness), etc. Connected qualities so it can broadcast his voice to another HR on the other side of the house or the world, if both are connected to HR network. It can whisper, shout, roar, speak softly, clearly, loudly, pause, smile, laugh, and combine his words with emotions. It can mimic animal voices and expressions.
   3. It can repeat, insist, detail, explain, train, teach, inform, report news, alert, be firm, cautious, anxious, happy, alarming, angry. It may combine speech with emotions (face expressions and grimaces) and use various tones, gestures, actions such as laugh with tears and wiping face (blinking LEDS and moving hands to face). This may be useful for an actor-HR, using jaw-muscles coordinated with speech/expression/grimace.
   4. Can interpret a voice in real-time in any language; can listen to TV in english and translate to family members in Arabic in real-time. Can request/provide assistance from/to HBs.
   5. Enhanced with Intuitive Genuine Natural Intelligence (NI) that allows him to have a basic polite and courteous communication with others. That will mean saying greeting sentences when a family member is coming, encouraging messages before a competition, show “real” emotion to HB, be compassionate, be truthful but not offensive, be personal but not intrusive, etc.
   6. It will know how to prioritize responses, identify interesting communications, people to ask, to listen/reply/report to, what to record and what to ignore.
   7. It will report verbally on anomalies and alerts. It will expect a response (when, how to request it, wait for it and act on it (whether after receiving it or not).
   8. It will know when and who to talk to, listen to, what to say, how to act; it may ignore one person or a group of people if initially programmed to do so or if it concluded that the HBs' conversation is casual and of no interest to the HR. But it will tune in again if that person become dangerous, acting out of the ordinary, etc.
   9. It can sync with his brain to read, translate and interpret documents in real-time; an HR may read/translate an English book/movie in real time in Arabic, w/o that the HB would notice a downtime in the HR reading. In the case of a movie or a theatrical scene that has multiple characters, an HR may switch characters, voices instantly to mimic female, male and animal voices on the fly. In that case, an HR may be a speaker that is wirelessly connected or wired to a TV and that automatically translates and narrates a documentary or a movie.
   10. It will autonomously and intuitively inform, talk, correct, decide, deliver, explain, detail, guide, teach, train, communicate, treat, instruct, alert (read somebody rights and arrest for instance), alarm, broadcast, whisper, laugh, smile, autonomously control the amplification of its voice, shout, etc. Intuitive is natural (NI) or genuine (GI).
   11. It will intuitively display grimaces, gestures, emotions such as happiness, anger, optimism, joy, excitement, awe, despair, etc, along with their speech.
   12. HRs are not allowed to express negative feelings or to mock HBs unless it is for therapeutic reasons, acting and with the knowledge and the prior agreements of the concerned/affected HBs. They are not driven by common HBs emotional or bad intentions.
   13. HRs may also reproduce a movie or a crime scene with the emotions and natural reactions of the actors/HBs that were present in that scene.
   14. HRs are not allowed to spy on HBs or other HRs or share information about them without their permission; every action that they do should be approved in advance by the person that is being recorded (even a minor) and the authorized personal in case the affected HB is a minor.
   15. Such feature may be greatly helpful to display in real time HBs emotions and actions to events during a therapist, psychologist session, to demonstrate to patients their bad attitude or their negativity or over pessimism and be correlated with the real events, to see if their feelings are valid or simply related to personal issues.
   16. HRs may connect two/multiple HRs/HBs whether locally or remotely. HR can communicate with more than one person.
   17. HR can use nemoji, caricature scenes, real or live picture of an HB/animal or another HR.
   18. HR can use a single or multiple voices at once or separately.
   19. Solo mode: HR can speak and act autonomously and w/o being connected to any network (public or private). Each part of its body may be physically or wirelessly connected with its private or public network. In case that the HR is acting solo, its parts should be physically or wirelessly connected with its internal private network that is also not connected to any other network; the HR should be reliable and autonomous with or without an external connection to any other network.
   20. The Solo HR, and for very highly-critical missions, such as a CIA spy, may communicate only through behavioral learning, not be connected, at all but capable of learning from books, the web documentation, differentiate between fake news and erroneous docs, and not needing to be powered, maintained nor upgraded as it can do it all by itself. It can learn similarly to HBs and animals but way faster and intelligently; it can read millions of books, accumulate the knowledge and acquire the capabilities of 1000s experts in every field in a few days, without having been explicitly programmed for it.
   21. The HR can be put to “deaf” mode if HBs need privacy.
5. Communicate by its senses or telepathically:
   1. Through its senses: To communicate with other HRs and HBs, it may employ his mouth to speak (speakers), his face to express emotions w/o speaking, his body to wave hands and show signs, its hands to point to a direction, etc. It may communicate with any machine that can decode these signs. For communication with other smart-devices, it may attract their attention by a wave and sync with them to exchange data wirelessly. For instance, an HB may ask two HRs to have a handshake; w/o exchanging any information and by simply advancing towards each others, they will handshake, releasing then both of their communication system from congestion. The two HRs may also have a handshake by syncing and communicating with each other.
   2. HR language: All HRs understand basic language (programming language). Each HB comms (French, English, Arabic, etc.) will be translated to the HR language that all HRs will be able to understand and communicate with. HRs understand and can write every language. It can work as a realtime interpreter.
   3. Through its telepathic connectivity powers wirelessly or in a wired manner to the outside world (HRs/IoTs/computers, or any other machine that is connected to the web and not necessarily to the internet). That way, two HRs for instance may communicate without any external actions and be faster than any other HB or machine. Their private network will allow them to do so, to have full direct conversation that can be visible or transparent to HBs. For instance, an HR police force does not want to alert the felons of their predicted actions not to be hacked when communicating on the public network, so all of their communications will remain private, secure and secluded from any potential foreign intrusion.
   4. Connectivity (telepathic comm) may be internal with its own parts, local within its range, remote outside of its range, with other HR-groups or group of HR-groups. It may vary with its type of network connectivity (public, private, secluded (solo: a single autonomous entity with no communication with any other device other than internet and possibly with no internet connection for extremely high secure devices (simply on his own)), such as a spy that is highly intelligent, autonomous but with no connection with the outside world. It may also communicate with other IoTs publicly or privately.
6. Touch: physical and wireless
   1. Physical/Wireless. 1) touch to apply force/pressure with controlled physical strength and measured impact on other object, 2) Type of HR contact-materials may differ from one task to another, house-keeper should have flexible, and water-proof hands, 3) sense points (location, handshake, sensing temperature, capacitive touch to be able to use touch-screen devices for instance, etc.), 4) synchronized touch with various other senses such as vision, 5) touch to sense temperature, pressure (piezoelectric, etc.), environment conditions (wind, etc), pollution, electrical parameters (wireless power, current, voltage, resistance, etc.), 6) touch to test/measure electrical parameters (power, current, voltage, resistance, etc.), 7) touch to impact (create wave propagation of heat, image, etc.), 8) touch to lift other objects/HBs/machines, 9) touch to affect/modify/twist/scratch/etc., 10) touch for wireless power charging (many parts of the HB may touch the charging station), 11) touch to simulate, probe, test, generate, etc.
   2. Wireless power base to charge faster a single, some or all of its parts. Each part can be charged separately, so an HR may be charging his legs, hands, etc. all at once. HR may dissociate his hands, arms and set them all on the power base to recharge.
   3. Touch can be physical or wireless. Physical touch will imply applying force/pressure on an HB, an object, by using the HR limps (hands, arms, etc.). It will have controlled and monitored infiltration at all times during the interaction with an HB. Wireless touch means that the HR may touch an HB/machine/object by applying heat, emitting waves, sending a wireless signal, etc. For instance, an HR may turnoff a dishwasher without physically touching it by simply emitting waves that will transform to the right pressure to press on the off/on button. Another example is the finger touch for a smartphone password. Furthermore, to get the attention of an HB, an HR can simply emit warm, or electrical shock waves to the contact point, such as a warm wireless tap on the shoulder, a warm wireless handshake, a well-controlled electrical shock wave for muscle stimulation or scan, etc. The doctor-HR will then be able to instruct electrical shock waves for muscle treatment and apply it right away with his electrical hand, order an x-ray scan, perform it and get the results right away, etc. The doctor-HR may also plan with the nurse-HR to run certain tasks at the hospital, at home or any other convenient location for the HB, without wasting either one's time and resources. Every doctor will be accompanied with a doctor-HR, so it can never cause abuse to his patients. The patients privacy won't be violated but their sessions may be recorded; the doctor will have instant reminders and suggestions for additional questions. The doctor-HR will be able to act in time and to have a better and more efficient session with his patient to save time and not miss on any potential issue that the doctor may have missed. The doctor and patient will both be monitored for possible misconducts such as sexual harassment or abuse. The affordable cost of the HR and the potential beneficial outcomes will justify the investment.
   4. The applied force should be well-calculated and controlled so it won't exceed the other HB/HR/machine/object/etc. capacity to withstand it and not cause harm.
   5. Detected events can be accompanied with AI/NI actions, such as the HR will always open a door to a coming visitor, take off the load out of him, help him with the groceries, etc.
   6. Touch should be monitored at all times with computer vision for feedback that it did not exceed its boundaries. For instance, if an HR physically touches an HB; the HB should have an impact on his skin. The HR will monitor, through his computer vision, the HB/HR point of contact and make sure not exceed predefined limits. For instance, if it is a simple touch then the penetration in the HB skin should not exceed a few millimeters; however if it is a touch to lift a baby then the touch may be deeper, given the weight and the shape of the baby. Another example is touching an object to apply a predetermined force, such as installing a screw. All touch actions are then synchronized with computer vision, and the HR thinking power (AI/ML, etc.) and possibly other parts of his senses, such as sound (to avoid and detect any potential damage), and possibly speech to inform of the HR actions. For instance, when touching an object, the HR may inform of its temperature, or simply say spontaneously (Intuitive Intelligence): “Oh this is really cold”, and intuitively suggest to measure its temperature by saying “Would you like to know its temperature?” without having been instructed to measure its temperature.
   7. The HR can be put to “don't touch, physical or wireless” mode if HBs don't want any contact with HRs. It may also set the preference to avoid physical touch whenever possible and use wireless touch instead.
7. Smell: Using sensors, LIDARs,
   1. The HR can be put to “no smell” mode if HBs need privacy and no interference from HRs.
   2. It will have a single or multiple noses to smell
   3. A nose is similar to a smoke/CO2 detector, a LIDAR to distinguish gases,
   4. Detection of the unordinary smells. These smells will exceed the predefined maximum/minimum limits for each gas constituent in the air. For instance, the HR will signal if a room is lacking oxygen, has airborne contaminants, chemicals, viruses, pollutants, gases, etc. If it exceeds the indicated predefined limits, it will order the HBs to leave the contaminated premises, transport disabled people and children to safety, and alert the authorities.
   5. An HR may be asked to smell a perfume, signal it if dangerous to skin (high percentages of alcohol), recognize it and inform about its name, origin and constituents. It can also intuitively comment on its goodness or badness, whether it is for men or woman, seasonal, strong or light, etc. It will classify unknown perfumes, search them on the web, ask other HRs for additional information about them, directly connected perfume vendors, etc.
8. Hear sound: internal microphones, wireless transmission through ultrasound, RF, optical, RADARs for speech detection (similar to hearing aid)
   1. Its hearing capabilities are similar to any smart-device, with a microphone that may be able to detect ultra small sounds, such as whispers, differentiate between noises with noise filtering/canceling, calculate distance(s) from speaker(s) (HB(s) or machine(s)), amplification of far-away voices if in their range, attenuation of loud voices, sound intensity and type (male, female, animal) detection and recognition, voice prioritization, type of sound (loud, whisper, urgent, pain, heavy-breathing, screams, giggles, etc.), meaning of message through AI to possibly initiate a dialogue and conversations for more clarifications (Q/A); the HR will insure of the message before proceeding. For instance, in the case of domestic violence that happens far away from the HR but where the victim's voice is still detectable but quite understood (whether it is a struggle or a game), the HR will move towards the scene and once certain of what is truly happening, will act to defend the victim and disable the aggressor. The HR is not a spy but is there to help when possible and will always insure of the certainty of the situation and its own interpretation of the facts before acting.
   2. The HR should hear every voice in his sound-range. He will though prioritize his listening to the people that are talking directly to him, in pain or having extreme emotions, trying to get his attention, his owner, etc.
   3. The precision and the accuracy of its sound detection will vary from one HR to another given its mission. A submarine-HR will use ultrasound detection devices.
   4. Additionally, it can detect and differentiate between various voices in the room, amplify them properly and make sense of them; prioritize them, deciding if he needs to take action or if the HBs are simply having personal conversation that won't need HRs interference (family private dinner that will dismiss a butler).
   5. The HR may record an audit session, a technical procedure and learn from it, report it to others, archive it, summarize it and brief others about it, etc.
   6. If not able to find the information in public/private databases and libraries, the HR may run web/cloud searches, call SiRi/Watson/Google and Alexa, if unable to understand the messages, ask other HRs/HBs, take action to approach the speakers, etc.
   7. It may use its torso to promptly display the heard message, translate it to signs for sound-impaired people
   8. It will have a single or multiple ears to hear
   9. The HR can be put to “deaf” mode if HBs need extra privacy.
   10. Employ short sentences intuitively. AI is more mechanical and will allow its users to act and to operate autonomously but NI will allow its users to think autonomously. Behavioral learning is independent of most techniques, it will allow its users to learn from other beings behavior rather than only from digital data, with no necessary coding from the users. The HRs will code itself in real time from and with the self-recorded or watched videos. Object recognition may be used to understand and decode a scene. However, the metadata of the recorded video may be decoded to automatically extract from it the main participants and the action that is being performed. There are two different ways to analyze and learn from a scene, 1) a lecture in real time, and 2) a large text such as a textbook. The HR will learn in real time and will know how to analyze, interpret information and how to store it, in his internal storage part, on a server, or a data center (cloud). It can also interpret and interact with others in real-time to mimic the viewed actions, ask and answer questions about their contents, explain and detail them to others.
   11. It can see, detect, scan and analyze if interesting events have been detected. It will know when and where to stop scanning, collecting information, and when to start interpreting them and then act on them, and coordinate with other parts of the body and its other senses to execute.
   12. An HR will be able to detect obscene scenes and confirm that both parties are in agreement with it; it will not transmit an obscene scene through its communication channels; it will insure also that both parties are in agreement with it and with its transmission; it will alert and warn the individuals that are involved in the scene of the gravity of their actions and its possible awful consequences and even if they agree with, it will not transmit. The HR will act autonomously and nothing will be transmitted. In case one of the involved individual(s) is a minor, it will alert the parents and the authorities. It will block all other connected and non-connected devices (smartphones, cameras for instance) from transmitting or recording. It will detect any foreign object such as hidden-cameras, listening devices in the room and will disable them. It will simply secure a location such as a hotel room for its guests at all times, to insure their privacy and safety. The stoppage of this transmission will be performed by its spiritual security layer, which cannot be altered even by the HR itself. That layer will always be watching for intrusions, counterfeiters, and privacy invaders, to stop hackers from turning his good intent service to a violation. The idea is to make sure that the HR is continuously safe and secure and not jeopardizing every body else safety.
   13. An HR may listen to a conversation if allowed to and provide advice if allowed to do so
9. Self-inform and train others for its use and for other subjects
10. Save and store data and information
11. Self-code and upgrade
12. Self-Diagnose, test, repair, self-maintain and self-clean and recycle
13. Project, broadcast (multimedia, sound (talk, broadcast), video, odor/fragrance/perfume, force/pressure/wind/kick/impact, etc.)
14. Self-plan, schedule and decide (autonomy),
15. Self-Protect: by avoiding HBs as much as possible during violent attack, simply climb a wall, jump to the roof, places where the attacker cannot reach him. HRs will always opt to self-protect peacefully and use force only when necessary, for instance, when the HB is armed and threatening the HR and/or other HBs.
16. Others and Additional animal/vegetation senses that are not existent in humans, such as telepathy by being able to communicate with other HRs, even when not present on the scene, get information and be alert to any potential threat. For instance, a policeman-HR may request/get information about a speeding car driver before deciding to stop or approach the car, communicate with other HRs/IoTs (passing cameras) to internally inspect the inside of the passing car for weapons, kidnapped persons or suspicious content. The HR may fine the driver w/o stopping him by simply connecting to his car and sending an alert message and detailing the reasons for his ticket or simply ordering his connected car to stop safely on the side. It can also instantly deploy other HRs to surround the car if the driver and companies are dangerous or violent. In the case of a kidnapped person, it can work with all HR road-monitors (mobile camera-HRs (smart-bees)) to inspect all passing vehicles and inform the closest HR team to stop the offender. Cars may have safety-HRs, that are installed to detect any suspicious behavior such as the captivity of someone against her will. The great HRs telepathy (powerful connectivity between all HRs) will allow the HRs to stop most crimes, in some cases before that they will occur, peacefully disable and arrest most criminals, and report secure premises after completing the job.
   1. Wings, aerodynamic turbines: It may have a single or multiple set of wings to fly, with various strengths, shapes and motors.
17. Learn (machine learning (ML)): by watching (videos, people, animals, objects), hearing sounds (music, other), smelling (gases, odors, smoke, lightwaves), thinking, asking (speech) the right questions, touching (probing, measuring, testing) and classifying images, sounds, smells, expressions, and the like to form its own ideas and make its own decisions. The newly invented behavioral learning techniques are intended to allow most people, even the ones without software programming skills, to teach and train their workforces. The newly learnt training routines will be self-programmed by the HR itself. Indeed the HR should be able to code itself after interpreting the messages, images, videos, and anything that crosses his mind through his human/animal-like senses (sound, vision, smell, taste, touch, thought) to store a routine. The longer is the HR-deployment, the stronger, and more knowledgeable it will become; and the higher are the risks for his wear out in case of misuse or operation in harsh environments (hazardous locations, extreme weathers, etc.). Note that the HR will self-protect as best he is taught to do, under the “No violence policy”. It can also recognize the parts that need to be recycled, refurbished and replaced. For instance, it can change and upgrade its Brian (computing system) at any instant.
   1. ML/Deep Learning
   2. Behavioral Learning (BL): Any body can teach HR including non-programmers. HR has a set of rules that will stop, correct and inform of any wrong BL. An HB may train an HR the same way he trains a new house-keeper, a nurse, a technician, a server. A restaurant owner may train 10s of his servers in a few hours; whether by training all of them at once, or by training one of them that will transfer the routine to others instantly. Each HR can instantly train the other connected-HRs though their private network, by simply transferring the training routine to them. No coding will be necessary. The HR will readjust automatically to new learnt routines and integrate them in his knowledge set (databases and libraries) and know where to store them autonomously (private or public network). Behavioral learning: An HB employee can train a single or a group of HR-employees to run his tasks w/o any coding skills. For instance, a restaurant chef may purchase a number of server-HRs or cook-HRs. An HR can also train an HB or an HR. When training an HR, it can transfer wirelessly his know-how (data) or simply train him the same way he was trained, while making sure that there are no violations in his training. The HR may check the training validity and efficiency and will highlight every misconduct or procedures that have infringed on the law.
18. Set and protect boundaries: In addition to his human/animal like senses, the HR has a unique set of sensors that are destined uniquely for his self-protection (in and out) as well as his surroundings. He is always alert to any attack, ready to act and protect. They are distributed throughout his body, to cover every angle of his surroundings, sense harm before it occurs and in time to be able to act and self-defend. An HR may be faster than a bullet (using his laser to disable gun before deployment), so it can deploy its armor in time, deploy or self-distribute his parts to avoid harm, surround and disable the offender. It will defend itself and others (including objects) but never attack unless to stop upcoming and imminent or current threats. It will never cause harm nor threat to anyone, but if it sees a violation, it will alert, warn and act if the offender does not stop his harm; for instance by physically disabling him, taking and securing his weapons as well as alerting the authorities. It will constantly monitor his premises. It takes no sides; it act on the common sense, so it will not serve criminals, dictators, nor aggressors. It will recognize a crime scene and instantly decide on the main aggressor(s) and act to eliminate all harms, including from the ones that are defending themselves. It will transform a war zone to a historic crime scene, report the casualties, the offenders, and the facts, independently of to whom it belongs. The HR common sense is controlled by the spiritual layer of the HR, and therefore cannot be altered by the HBs/HRs or another machine for their own interests. For instance if a population is voting above 75% for their ruler to leave, he will have to step away as the HR-force will order him to do so and will force him to do so if he does not. If it cannot stop the harmful moving target (not an HB/animal or vegetation) that can cause harm to HBs, then it will destroy it, alert and report the criminals and the HRs' actions to the authorities. In case, an offender was detected and was proven guilty, it will register him as an offender, and will be constantly on alert towards him. The felon status will switch from an HB to a potential-threat-HB and will be classified per the gravity of his crime, and restricted from ever approaching, seeing or contacting his victim/survivor or other potential victims/survivors. For instance, after having been proven guilty, a pedophile will never be allowed to approach or even see kids; he will be constantly surveilled and monitored by a security-HR to not cross these boundaries; he may also be retrained by a psychologist-HR to recognize his mistakes, ask for forgiveness and try to restart a decent life where he will no longer can be a threat to others. Such information will be stored in the spiritual/subconscious layers and simply be inaccessible to HBs, nor to the HR itself. HRs conscious layers that can be programmed by HBs, will allow the forgiveness of light felonies (shop lifting at a young age, smoking cigarettes, etc.) after a certain period of time by potentially erasing the data from its memory. In this case, the felon HB will not be continuously monitored after such crime. By monitoring previous felons, we may be able to not jail some category of criminals as long as they accept to be continuously monitored and for a certain period of time and possibly for life, to never approach their victim/survivor or commit another crime. That will allow them to continue living among their loved-ones, rebuilding their lives and be a better a person. They will simply not have our freedoms. Felons may be monitored even in jail for good behavior and possibly for early release to save the city money and reunite a family; they will not be able to approach (for instance for a distance of 1000 Kms), see or have any contact with their victims/survivors. Indeed, an HR may be simply cheaper than a bed/meal/service in jail; jail time may be imposed only on serious offenders, such as rapists, killers, etc. Basically, the HR will act similarly to a good samaritan, a good policeman, a fair judge, etc. The HR does not take any form of abuse and will always report it to the owner HB, in some cases to AZ, LLC, the manufacturing company or the authorities. The HR will autonomously defend every side and aim to stop every fight, no matter who owns him. In case it detects harassment, it will alert the authorities (parents, school supervisor, etc.), and if the harasser does not stop instantly, it will force the bully to leave the premises and record the incident for the authorities to see.
19. Self-sustain itself autonomously and by self-charging from wireless or external power supplies, or by energy harvesting techniques. The HR may be battery-operated especially for mobility purposes.
   1. An HR can estimate the power level of every part of his system at all times, the required energy to complete a single or multiple scheduled tasks. It may plan and alternate task power charging tasks to continuously be operational. It may share and ally with other HRs to complete power hungry tasks. A house-keeper-HR may autonomously complete all of its tasks and mange its power levels without the intervention of its HB owner; it may also ally with other HRs to lift and clean under furniture.
   2. An HR may entirely be autonomous by means of efficient energy harvesting techniques (solar panels, etc.) and being battery-operated.
   3. An HR may programmatically and/or autonomously find the best ways and pick the most appropriate times to recharge; it will alert HB if he is been prohibited from or incapable of doing so.
   4. An HR may charge as a single or multi-part unit from a single or multiple ports to distribute its charge evenly and get it charged faster. It can charge the legs, the hands and fingers each from its individual power port to achieve faster power charging for the entire HR.
   5. HRs may daisy-chain or organize in a given shape for wireless recharging; from a single or multiple power supply (wired or wireless). A group of HRs may distribute and share numerous power supplies (wired or wireless) for instance by holding hands or stepping on each other foot. For instance, twenty HRs may hold hands in a circle or a line with only four of them touching the power supplies for wireless recharging; the power charge will flow evenly through all of them.
   6. An HR may get charged wirelessly and/or may transfer their tasks to another HR if running out of charge; it may borrow or swap one of its parts from another HR if it has the required power charge to complete the task. It may delegate some of his tasks if he is running out of energy; 7. An HR will inform of its power levels and will ask for permission before recharging or autonomously recharge if initially allowed by the HB. An HR may autonomously look for other power supplies outside of its range by asking other HRs, if his initial power sources are unavailable.
   8. HRs will autonomously manage the use of their power supplies (when and where) if they are initially programmed to share them.
   9. HRs will dock, hibernate, standby, save energy whenever they can. They will know how to optimize their use of energy harvesting solutions.
   10. HRs will distribute charge among them if needed, will share for power-hungry, high-voltage, high-current apps 11. HRs may carry an HR to recharge him, may get power charge and recharge the disabled HR.
   12. An HR may supply various levels of voltage and current to other HRs, machines or HBs. For instance, an HR may use an electrical shock finger to stimulate muscles for physical therapy.
   13. An HR may sense, probe, measure, test current, voltage or resistance, capacitance, inductance, etc. HR fingers may be test, measurement and instrumentation probes or peripheral (remote probe patent)
   14. Multiple parts of an HR may be charged separately or simultaneously. The power may flow from various parts in the HR and specifically to a single or multiple parts while others are in sleep mode. For instance, during a power-hungry action using only the HR-hands that would last for a while, such as a secretary job, other parts in the body may hibernate to save power. It may also remove parts of his body to save power or exchange them with other HRs; it may leave some of his parts charging while he is running certain tasks.
   15. The HR may be charging and/or harvesting energy while being operational to perform a single or multiple tasks. For instance, an HR may be working at home and charging his wings; before that it gets ready to fly to buy groceries.
   16. An HR may rearrange his parts to save power; for instance, it may unplug; unhook his legs, dock and/or charge them when he is sitting down.
   17. To optimize its functionality and for better power vs. task, an HR may propose and rearrange his schedule, differ a few of his tasks to when his power supply is at best levels. For instance, it may soak in the sun during the day (harvest solar energy) and run most of his computing work at night.
   18. A single or multiple HRs may ally to power a single HR. For instance, when all HRs are operating remotely, they may ally to charge each other or one of them while others are soaking in the sun to self-charge. That way a group will practically not run out of charge and will still be able to survive autonomously and independently of any man-made facilities such as external power supplies and communication networks. It can self-repair, self-test and self-maintain, so it can surpass HBs lifetimes, as it can always upgrade and self-maintain. It knows its body (HW and SW) better than its own designers; at a certain time, the HRs will be better maintaining, upgrading and recycling some of their parts by themselves better than their own designers.
20. Dependability and versatility: single or multiple personalities and functionalities; for instance, it may be only a news presenter, a journalist, a teacher, a marketing engineer, a sales engineer, a primary care physician (PCP) or all of them at once.
21. Flexibility: An HR may perform extraordinary tasks with detachable parts. It can link its parts through magnetic connections while still being able to rotate, tilt, attach, detach safely, dock and self-power. It can take any single/collective shape and still be able to communicate and operate as one
22. It can plan, schedule and optimize, share and distribute tasks with other HR, HB, IoTs, machines and still operate as one with shared and planned schedules or independently from one another each at his own schedule.

Standard HR and HR Parts

Nerves: comm (wireless and sensor), control and data-signals (low-voltage (LV) for instance)

Muscles: electrical wires for high-voltage (HV) signals and motor control

Articulation and articulation extensions to control bones strengths

Bones: bars (PVC, metal, etc.)

Skin: Parts cover (tactical touch, etc.)
1. Detail SW std platform, (brain, nerves (neural network, fuzzy logic))
2. Detail HW std electrical platform (AZ-HW and not computer/data-center, distributed single HR system)
3. Detail SW/HW std coordination system (electro-mechanical), sensors, detectors, trackers, MEMS, navigation system
4. Detail HW mechanical system (mechanical), muscles and limps

Movements:

The HR movements are authorized and constantly monitored by the brain but once ordered by the brain, the various HR-parts can act autonomously. For instance, the task of writing on a white board, once allowed by the brain, will be running autonomously from the finger-pen, which may be getting data from the brain, other part of the HR, another HR, the cloud or other. The HR may also synchronize with its vision to speak and describe what it sees. Each HR-part may have its own mini-brain (computing system), its muscles, its bones and articulations (mechanical part), its nerves (wired/wireless data points, sensors), etc. For instance, the hand may act autonomously from the entire body and handles its fingers autonomously; it will though have to synchronize with the other parts that may be involved in its movement such as the wrist, the arm and the shoulder, and will inform the brain that it is busy running other tasks. It may also sync with other HRs' parts to operate collectively.

Various movements may even require new changes of the HR-shape, to autonomously expand/collapse, dissociate, assemble and add other parts to his body, connect with others to work collectively or simply delegate its tasks to other HRs that are more adapt to them, etc. He may ask for permission before moving or simply act if already has been given free-movement from the brain. For instance, it may be running for miles and taking turns as needed, without having to check with the brain again. The brain has to simply authorize him to run from point A to point B and the legs/arms will have to do the rest and synchronize with the HR vision system; the brain can then work with other parts of body, for instance to transmit what it sees to a computer.

He may handle objects, grab, twist, caress, embrace, touch, lift, press, (un)screw,

He may get taller, shorter, bigger, smaller, additional layers, (un)dress itself, add makeup, etc.

It is quite reliant on NI, it can have very intuitive gestures (similarly to the Italians), grimaces, etc. These gestures are randomly injected but carefully synchronized with the rest of the movements. For instance, a French person won't move his hands the way Italians do. As soon as the HR start speaking Italian, the hands start synchronizing with his speech.

To complete a movement, an HR needs to have:
1. Brain-Electro-mechanical system that will allow him to have well thought free-movement. Graph theory will be extensively used to calculate what to detect, when to act and what to do. Mechanics, sensors, electronics, MEMS, accelerometer, tracker, detector, computer vision, location services, etc. The HR will predict and plan enough of trajectory before any movement, so there will be no unnecessary discontinuities in his movement. The HR may use the concept of jumping and resting between locations to avoid full flying actions, which are power-hungry. Each action is driven by the brain or mini-brain system, and will control part of the electromechanical system, and will have a feedback system (sensors) to measure reactions to its actions and adapt its future ones in real-time. For instance, to grab a glass, an HB will measure the glass dimensions before touching it, adjust its grab first time to grab it and instantly to hold it. By being able to accurately measure from far the dimensions of an object, the HR will minimize the number of required actions and be able to run very intuitive actions similarly to an HB, without making a mistake. In other words, all of his actions are accurately-calculated and planned before any movement. The HR will be able to sense any touch (from HB, objects, etc.) through its MEMS, and estimate their force. MEMS sensors/actuators are placed in certain muscle and nerve areas. Sensors are for wireless touch while actuators are for physical touch. Various RF switches may be used and may be: Electromechanical, SSID, MEMS based.
2. Movements: It can Walk: from crawl (two to four hands/legs/articulations) to run with different types of posture, straight to twisted. Each action is categorized by type, its need for synchronization, electromechanical system, grimace, color, parts, deployments, type of required connectivity, duration, source to destination type of relationship (cause to effect), speech, pressure/force, possibility of synchronization with speech (dictation while writing on a white board). It should have basic actions, such as walk, stand, pivot, wave, lift light/heavy materials, etc. Other HR versions may be stronger and be able to lift very heavy objects, they will be called industrial HRs (light and heavy-industry).
3. Navigation system to synchronize and plan his movements with his thoughts and senses and move from point A to point B. His thought system (brain) will allow him to decide and predict on what to do while his senses/parts will allow him to gather information and act. It can predict his next movements and be prepared to act even if the event that will force them to act that way did not occur yet. For instance, they will always be ready to call authorities if they sense intrusion so the call will take a single (and not a few) clock cycles. Threatening events have SW/HW priorities over all other actions, so they are almost instant. Another example, if they are tracking a felon, they will have to predict his movements and estimate his proximities to weapons, to always be faster than him and possibly jump to secure objects that may become potential weapons such as a knife, a potential-hostage such as a civilian, before that the potential felon will get to it.
4. Motor control in articulations to sync with hips/legs/arms/elbows/knees; can be wired or wireless. The articulation motors may sync with various parts and not only its bones. For instance, an articulation-motor in the arm may intuitively sync with the legs articulations when running. An HR may have less or more articulations than an HB, given his added flexibility and the nature of his planned tasks.
5. Spine inclination and flexibility (best resting/balance position); spine ribs to control the skeleton strength; spine articulations to control tilting, rotating, flipping, spinning, etc. The spine should not stop free-movement and should have detachable articulations. Detaching a part of the HR is part of his tasks. After final assembly and deployment in the field (being sold), HBs are not allowed to do it. They may however ask (verbally or with a sign) for it so the HR does it. The HR will know how to operate its system.
6. Sync movements with senses (such as communications with HBs/HRs). The HR may start initial emergency evacuations upon the detection of an event (local and remote), if it has been informed by remote HRs that a hurricane is upcoming, if it senses a gas leak, etc.
7. The HR has a good tracking system that will allow him not only to detect a thief but to track him to his house, while monitoring with the police and informing the HB. In that case, the HR may take the shape of a small bee/ball, etc. It may also synchronize his tracking system with other HRs/HBs or the animal-robots, machines, etc., so it won't have to live the home, but to send its information to others that will track him through connectivity, so once it leaves the first perimeter, the next HR system will track him and so forth and so on, without leaving their places but simply by using connected HRs, bee-HRs, etc. If the current tracking HR does not find an HR to carry on, it will decide whether to surround and arrest the thief, track him to the next junction so other HRs can track him or simply wait for him to reappear knowing his approximate location. Most of the tracking will be autonomous and optimized, distributed between HRs that are free or specifically deployed at that instant, or simply a specialized security HR police force. It can help with most crimes including kid-kidnapping, etc. It will inform the authorities of his tracking positions at all instants. Authorities may be the police, the parents, the school supervisor, etc. Each HR will know who to call and when to call when needed; so they will call the police if a thief is detected and the parents if a kid misbehaves. Its alert system is always up to date for any possible changes in the contact system by being constantly connected to the police phone book, etc. Most of the actions are done autonomously.
8. The HR will autonomously establish and adjust his perimeters with his surroundings as well as their proximities for safety purposes. For instance, it may approach a table, a chair to sit on but not to stick to an HB, limiting his freedom of movement or making him uncomfortable. He will also insure of others' relative perimeters; in other words, a teacher/preacher/doctor cannot approach a kid inappropriately and should keep a certain distance between him and that child at all times unless certified and approved to do so. The HR will still be monitoring to insure that no moral code violation has been committed. A nurse-HR may easily be accepted in a doctor office, without attracting much attention to him and making both of them uncomfortable. Both of the detection and tracking systems should be in sync. These perimeters will be adjustable with the mobility of HBs and all surroundings objects as well as detected local or remote events. Indeed, in the case of a danger (school shooting), the HRs and HBs may get closer for active protection, etc.
9. The HR will be able to combine the skills of a technician, the cleverness of an engineer and ingenuity of a scientist, w/o offending for being a super HB or simply better, given that he is at the service of HBs. It will synchronize of all of its movements and senses accordingly, to move gracefully and speak eloquently.
10. Type and speed of his planned movements and reactions. It will optimize his movements with his available energy, capabilities and surroundings and will constantly monitor the three of them. Every movement or reaction to an event will be thought through; once the HR is decided and has insured the safety of its planned actions, it will act. For instance, it will move slowly to grab a baby but will storm to save him from falling. It may constantly walk on floors or grace them by a few millimeters to avoid dirty or wet surfaces and possibly fly to avoid obstacles, possibly coordinate and alternate all of his movements to efficiently use power, its wireless and physical resources without exhausting its energy (power). It may change shape to go through obstacles; it may collapse, climb walls, deploy wings, etc.
11. Free-movement: The goal is to have the HB capable of exercising most of the HB/animal-movements with or without their limitations. For instance, unlike an HB, an HR with wings can fly. The standard-HR will have several pre-programmed routines that mimic various body positions, so it can stand, walk, run, kneel, squad, turn, spin, lift a hand/arm/leg. All other parts should be in sync to accommodate a given action, such as lifting a hand will invoke lifting the lower and upper arm and rotating the elbow-articulation.

Capabilities

HRs have no expectations for HBs acknowledgments nor emotions; they will not expect gratification, awards, nor real emotion. But they will take note of the HB-behavior and act on it; they will be clear, concise and upfront of what they need to complete their duties. They won't complain but they will make sure to attract our attention to a real issue and get a resolution; they will not give-up before then.
1. Supply Chain: recognizing and processing objects through speech or vision or other HR-senses
2. Mobility, Connectivity, Comms, etc.
3. An HR torso may be a screen and it may open up to have a keyboard and a mouse, so it can mimic a computer. The computer-HR may be connected to a wireless keyboard, mouse, screen and to all other connected devices and IoTs. Its torso may open to display a keyboard, a mouse, and a screen.

If physical capabilities are not needed, some of the HRs may be virtual and possibly invisible to the network and/or the HBs. They may be located in computers or simply displayed as holograms, VAR, or MR (tinker-bell patent). Such HRs may be preachers, teachers, PCPs, etc. In this case, the standard platform is simply a virtual HW but a powerful and harmonious SW platform. If physical capabilities and proximities with HBs is needed, then they may come to life in any shape or form that is the most convenient for their mission including an animal shape.

Electro-mechanical: actuators with inputs/outputs that are wired, wireless (RF switches).
1. Wired, wireless connections
2. Multiple TM&I, drones, parts, sensor technologies
3. All-in-one 3D (elasticity, rechargeable with articulations similar to HBs articulations but that are more elastic to turn for instance an arm/leg/hand in all directions. An articulation may be 1) a ball that may have sliding bars or 2) a ball that would allow the sliding bars to grab into it. The ball may be limited in its turning angles similarly to HBs or simply have free-movement in all rotating and tilting angles.
4. While still functional, it can be assembled/disassembled, all possible movements with flight capabilities and all directions.
   1. Can assemble, disassemble, replace, detach, rotate its parts
   2. Can diagnose, test, repair
   3. Can multiply, store, select, adjust, reshape, improve, resize, measure, dock
   4. An HR may charge one of his hands with another HR or simply for other tasks
   5. An HR may use several articulations/parts if ordered by HBs or autonomously for his planned tasks
   6. An HR may have drone-parts that can fly. The hands may fly separately, run various actions and then dock back to their original location in the HR-body. The head that contains the eyes, may fly to monitor and inspect a location, while transferring in real time the collected data or viewed scene and then get back to its place when done, similarly to a drone. An HR-head may be checking the house roof, the neighborhood streets, while leaving its body standing at home and communicating the information the HB through its torso for instance and additional body-speakers.
   7. An HR may use particular positions, shapes to save power; for instance, it may surround the wireless power base in circle to set their hands on it and recharge. An HR may hug the power base to recharge through his torso. An HR will calculate and use the best position to recharge faster. An HR may also expose his solar panels, wherever their locations in his body, to the sun to harvest energy faster. It may hide them when operating in harsh environments to its solar panels for instance.
   8. An HR may take any single, collective shape of body; it may separate his parts and regroup them at any times
   9. Be adjustable, re-shapable, resizable, elastic, etc.
   10. Run, crawl, walk, step, spin, rotate, jump, etc. During a rotation, the articulation sliding bars (to mimic part of the bones) will clip at each rotation on a set of notches to keep theirs grips on both sides of the articulation. During detachment, the sliding bars of an articulation will compress and retract towards the center of the articulation so it can detach safely, for instance to fly as a drone. Such mechanics will allow safe assembly and detachment of the HR parts. Full rotation of the HR-parts is also possible. Rotations are then possible with rotating disks, that may be equipped with removable sliding bars for bone (and muscle) strength, or simply be wired for optimum elasticity and light weight. The sliding bars may be made of metal or other materials and their functions are similar to HBs bones. The stronger are the sliding bars (material, size, width and length) and the HR parts materials, the stronger is the HR.
   11. An HR may have various strengths and various materials. For instance, for soccer-HRs, the HRs strengths may be focused on the legs; the players may have no hands to avoid silly penalties, while the goal-keeper may have special intelligence to not step far away from his cage, etc.
   12. An HR may detach itself for self-repair, test, diagnose, charge or replace, add, remove other actions.
   13. The HR grid is controlled and driven through various graph theories and (Convolutional) neural network algorithms (CNN), fuzzy logic for decision making, etc. The HR may get to a set of decisions that are all valid or where each one of them is better at something. Unless the HR has a set of priorities that will allow him to select a unique answer, it will pick randomly a decision among the valid set of choices. Two HRs may then take two different routes at a cross-road to get to the same location.
   14. The HR will constantly be monitoring his surroundings when moving to avoid hitting obstacles. It may use computer vision technologies and/or sensors to detect moving objects or obstacles.
   15. Each brain action is enabled through smooth coordination between skin (touch), bones (parts), muscles (sliding bars), nerves (wireless comms. and sensors), brain (computer) and mini-brains (parts' computers). Each part of the HR body can operate independently of and/or collectively with the other parts, be wired or wireless, be hardly attached or be physically detachable.
   16. Know and can dance and learn all dance moves, music, etc.
   17. It can follow any routine “follow-me” concept to dance with a dance group. The HR may be learning in real-time a dance routine; it can learn from it through “watch and learn” concept.
   18. It can control every part of its body individually (using a single finger) or collectively (clapping with two hands). HRs may also exchange parts for power and functionality optimization.
   19. It can mimic the HB anatomy w/o the limitations (opt1); exactly as an HB w/ limitations (opt2).
   20. Each part of the HR may clip to another; in that case, the two clipped parts will get autonomously hooked to each other. When clipping two parts, such as the lower and upper part of an arm, both parts will act as one and harmoniously, w/o the need to be wired. All of the HR parts can communicate wirelessly so when one action is applied on one part, the other typically affected parts will be instantly alerted to cooperate, similarly to the nervous system of an HB that activate and stimulate the right muscles. Each HR action is well calculated (initial/final positions and trajectories between initial and final positions), and the set of basic actions to complete the requested task will be identified. Below we describe the main steps for pointing to a direction and then handing the HB an orange.
      1. Point to a direction:
         1. The HR brain would wirelessly order the hand to point its index to coordinates (x, y, z). It will send a wireless command directly to the hand. The hand will decide what HR-parts to use. The brain may also send all commands at once to the finger, hand, both parts of the arm and the shoulder articulation. Such action may speed the HR reaction but may create network congestions and over planning from the brain point of view. For every hand action, the brain and the hand will work together to get the most optimized action from power, functionality and network usage. In this case, we will consider the HR-hand as the delegate master for all of the hand actions, such as lifting, finger-pointing, writing and typing, so that the brain will delegate all hand-actions to the hand.
         2. The hand will then analyze and translate the brain command to actions. First, it will determine which parts should be involved in that action. For instance, given the ordinate z value, it will decide on the shoulder rotation angle, the height of the hand, the tilting of the arm articulation (lower vs upper). While, based on the x and y ordinate values, it will decide on the HR standing positions, including the head tilting and possibly the entire body turning. The entire new HR body positioning and coordinates will be calculated based on the initial action analytics, so the entire HR movement will feel natural to the HBs.
         3. Based on the brain action, the hand will decide for how long it will point its finger to a given direction, whether it should stay in that position or simply run that action for a few seconds and then move to the next one.
      2. Hand the HB an orange:
         1. The brain will locate the orange and calculate its coordinates through its vision computing system,
         2. The brain will send the orange lift action to the hand along with the orange coordinates and measurements.
         3. The brain will then order the legs to walk towards the orange so it can be reached by its hands, delegate the rest of the actions to the hand and start other processes if any, while periodically checking for the completion of the orange lift action.
         4. The hand will then interpret the lift action to: 1) measure the orange (see measure action for object measurement), 2) calculate the coordinates of the initial and final hand (palm, hand-articulations and fingers) before and after grabbing the orange as well as its trajectory during the grabbing action, 3) calculate the coordinates and the trajectory of the entire hand, arm and shoulder extension, up to the initial orange grabbing position, 4) calculate the coordinates and the trajectory of the entire hand, arm and shoulder extension, for resting the fruit in its hand (weigh MEMS may be used to estimate the orange weight), 5) calculate the coordinates and the trajectory of the entire hand, arm and shoulder retraction, to lift and hand the HB the orange, 6) extend its hand per the calculated trajectories to the initial grabbing position so it can grab the orange, grab the fruit according to the final grabbing position, lifting and handing it to the HB. The HR will accurately calculate its trajectories before moving and then act. It can also calculate while moving to not show any discontinuities in its actions. On average, the calculation of an action should be approximated to the time of its execution so most of the HR actions will seem natural.
         5. For bone strengthening, during the hand/arm extension/retraction for the orange grabbing and lifting, the HR will extend the hooks of its articulations in each attached part. During an extension, each articulation will extend within both parts and will grab on both sides for a strong physical attachment. During a retraction, the articulation between the lower and the upper arm, will slide within the two attached parts without colliding with the other side of the articulation system (upper arm and shoulder, or lower arm and hand). For instance, to lift a heavy object with its hands, the HR will contract its lower and upper arm parts so its articulations can be fully inserted and extended within both sides to make them stronger. Hence, the applied force on the HR hands may be shared and distributed throughout the ensemble of the hands, the arms (lower and upper) and the shoulder parts, so all parts will be physically stronger and operate harmoniously. The object weights and articulations angles will be calculated so coordinated movements can be arranged.
         6. If bones do not need to be strengthened then the detachment happen at the articulation only, similarly to current protheses.
         7. Each part of the HR can be detached, replaced to fulfill various functions.
      3. Some actions may not be initiated by the brain. For instance, when playing a soccer game, the legs may be equipped with sensors for motion detection, once a ball is close to the feet, the leg may spontaneously extend to throw the ball, and alert and coordinate with the HR computer vision system to calculate the position that it should aim for. Various HRs may have various topologies (sensors, parts, etc.); for instance, some may not have sensors, while others may be heavy on sensors in certain parts of its body. The inner HR wireless network of the HR hand will alert instantly each of the (potentially) affected parts.
      4. Some actions may be (in)directly invoked; for instance, kicking a ball may mean that the HR may have to calculate the coordinates of the origin of the ball relatively to the HR location, so it can detect its angle and its speed, locate all the HR or HB-players that may get the ball as well as the adversaries that may be able to intercept it, decide on the most appropriate player to throw the ball to and calculate his coordinates and finally throw the ball. Other scenarios are possible as it may be possible to run towards to ball, change inclination angle to throw a stronger ball, etc. Complex CNN algorithms should be written to calculate the most appropriate game to play in real time and possibly vs. HB-players. In other words, each action can have various subsequent scenarios attached to it but the HR will have to decide on the best option to select in real-time. The HR should operate with minimum latency, while continuously updating his calculations in realtime according to other current and predicted events such as the others players speeds in the stadium and their potential reactions to the ball. The chess game would be a good applicable case where the player has to plan for the most appropriate move to win rather than to advance. Such actions can be programmed by the developers that are skilled in programming or in a given job (BL). The developer community may increase from skilled programmers, SW engineers to include life-experienced people, such as cooks, dancers, musicians, etc.
      5. The HR soccer-player should react to the ball within a certain time-window that is greater than its latency time, otherwise all the calculations may become invalid as other players may approach him. Hence, every decision is time-dependent and is valid only within a time-window, given the past, current events, the fact that all the players are moving targets and the predicted outcomes. Hence, the HR will decide based on fuzzy logic measures: the most likely best option within a given time window and given the information that he had, the current changing reality and the possible outcomes of each possible choice. For the HR, the past is certain, the present is changing in realtime, the future is fuzzy and he should get to the best decision within a certain time window.
   21. NI: Some of the HR actions may not have been programmed but are learnt on the fly or simply created and needed to complete the HB request. For instance, when an HR is asked to spin like a ballerina, she will need to inspect the surroundings and if not, it may open its hands but if there are then it may choose to step away and spin to open its hands, or spin without opening the hands. Her choice may be unexpected by the HB but the HR will decide based on its surroundings, its balance, and the most beautiful scene that it can create at that instant while looking natural and artistic. In other words, if all previous spins were with hands opened, the ballerina may opt to stay in the same locations and spin w/o opening the hands rather than move to a freer location that will allow it to spin with open hands. Truly, all of the HRs reactions and future movements are fuzzy and based on very fast computing calculations that will allow it to impress and surprise w/o being boring, overdoing it, lost or looking for the next move. If the HR needs more time to complete his calculations then it will have to improvise; for instance, if the ballerina decides that it has to open its hands no matter what then it will step gracefully to another location, change choreography and then perform its spin w/o that it has been asked to do so, nor been programmed to do so; it will simply improvise. Hence the need for intuitive intelligence (II), where both of the HR and HB did not ask for the action initially but the HR had to do it so it can perform the requested action. NI is the random intelligence that differentiate one HB from another and that will differentiate an HR from another as well, even if both have had the same path and learning experience, when faced with the same challenge. Indeed, the time at which they were challenged, their basic DNA, structure and intelligence may change their reactions and future behaviors. Indeed, since the HRs are deciding between various options that may seem all possible, feasible, and good, two identical HRs at exactly the same time and exactly the same conditions, may choose two different options, simply given their different DNAs (unique serial number for instance) and potential other factors, such as the breeze on their faces, their view angle or any other phenomenon that they are self-aware of. Parts of the NI is controlled by the spiritual layer and no matter what, the HRs will not go off-limits, as they will be trained to have values, principles, guidelines and boundaries never to cross, even when everything may go wrong. NI is all intelligence that is not artificial (AI). Both AI and NI represent the HR intelligence. NI will make every HR different from another and unique, even if everything about them is physically identical in their SW/HW.
5. Appearance:
   1. An HR may look like HBs and have their limitations or be a super-HR with absolutely no limitations other than the ones due to its design such as its materials, sliding bars (bones) and computing powers, etc.
   2. An HR should always be able to keep its balance and equilibrium without hurting his surroundings such as other HBs, unless it has purposely or intuitively opted to fall. For instance, a soccer player-HR may intuitively choose to score a goal even if it will lead to its fall after throwing the ball; a drunk actor-HR may simulate unstable random body positions that may simply lead to his fall or purposely plan to fall at a certain time.
   3. If an HR chooses to keep its balance at all times, then it may deploy its wings to fly to avoid falling. For instance, a policeman-HR may have wings to deploy if faced with aggressions for instance.
6. An HR should be able to handle its surroundings
   1. It should multitask w/o ignoring its reality by having some of his parts constantly surveilling and monitoring its surroundings. In case of a danger, the HR will always be ready to interrupt all other tasks, protect itself and others.
   2. The HR should be able to multitask w/o congesting its resources, and if that is the case, it should delegate, delay but inform, propose an execution plan and communicate with others.
   3. The HR should be able to use various parts for various tasks; for instance, it should be able to walk on his feet as well as on her hands if doing a head-stand. In other words, the action “walk” does not mean that the HR should walk on his feet or that it should do it. For instance, when standing at the edge of a cliff, an HR may choose to fly rather than to walk and may inform the HB. Such reactions are sync'd between AI and NI. Each action is then calculated based on the current HR position, location and such, what makes sense in that current situation, and what can be done. “What makes sense” will mean that if an HR that is standing on one leg, is ordered to jump, it will jump on that leg only and won't drop the other one, unless it is specifically asked to set both feet on the floor and jump. In other words, “what makes sense” will mean that it will look to the action of walking as an action of moving forward with what is available to him in his current condition. For instance, someone that is standing on his hands will walk on his hands rather than on its feet, someone that is faced with obstacles may fly rather than walk, etc. It is called the FSM behavior as it takes in account the HR previous/current state, potential states and the status, input, outputs that is getting at that instant and the predictive states if it decide to execute a specific action, the analytics of the action possible outcomes and the calculation of the best outcome at that instant and given all of the acquired information.
   4. The HR should be able to multiprocess and multi-schedule tasks in a sequential or pipeline manner for individual or collective purposes and task sharing. For instance, an HR may be asked to clean a room, vacuum the house, wash the dishes, take off the trash and within a certain time. The HR will then start by insuring that he can do it within the indicated time frame by calculating the timeframe to perform each action, what he needs to get it done, setting a schedule and communicating with the HB to let him know that it is okay with him to get it done within that timeframe or that he will need more time. He will precisely indicate how much he will need and offer/display the proposed schedule verbally, with signs or visually through his torso. In the HR language, such step is called time-estimation, planning and scheduling. Upon the HB's approval of the planned actions, the HR will act autonomously and will inform the HB of any unforeseen changes in the schedule, for instance due to a broken dishwasher in the middle of its wash, and propose changes to the schedule or simply repair the dishwasher. In the case of the absence of the HB, the HR may choose to 1) text him and wait for his response (if agreed in advance to never change the schedule w/o permission), 2) carry on with other tasks while waiting on the HB response to decide on what to do with the dishwasher, or 3) autonomously repair the dishwasher or call and schedule for repairs, and then carry on with his tasks if his orders were to manage any situation on his own during the absence of the HB. The HR will behave as naturally as possible.
   5. The HB may also ask the HR to simply “clean the house everyday and do not disturb”, the HR will then act autonomously everyday to inspect the home cleanliness and decide on what needs to be done, get it done and then inform that it is done with a status report. It will include the start and finish times, how it did it and what it discovered while doing it, but won't expect any follow-up from the HB; it will make sure to not disturb any HB during its cleaning procedure.
   6. The HR will schedule and optimize his tasks, while taking in account the time in which it should complete its tasks, its available energy/power-charge, its accessibility to recharge, the priority of each task and its capabilities (SW/HW).
   7. An HR knows how to study its environment (computer vision, ask the right questions, access unlimited source of information (the web), etc.), estimate the time to execute an action within that environment and its response time to this environment. His calculations are an estimate and subject to changes as random and unforeseen situations may always occur. The HR should be able to accommodate at any time.
   8. An HR knows and plan on where, when and how to engage in an action. As it learns about his environment and his actions, it may pick autonomously (not only programmatically) the best time to react, and can predict the most outcome of his reactions. For instance, on a Saint Valentine evening, it can choose to buy flowers in the morning, to turn-on the heater in the afternoon, prepare a nice meal and light candles at the dinner table in Paris. While, it will open the windows and set the dinner-table at the terrace facing the beach in Kono, Hi., on the same night. The next year, it may select autonomously a different schedule given the mood of his HBs such as making them reservation in a nice restaurant and getting them a ride back and forth from home. The HR may surprise both spouses and take-off the load of planning, picking and choosing from each one of them, so they can both relax on that day. It won't need to be explicitly programmed but it will learn how to plan events, surprise and amaze.
   9. The HR will always refresh, update but not overload its memory with new information. It will learn how to dispose of data when needed, where to store it for future use, for how long it should keep it and what data to collect in real-time or acquire from another machine or web site, etc.
   10. It knows how to estimate its power and pace its energy, when to harvest and delegate, and when to schedule additional power charging before or after an action or between actions. It will also know how many and what actions should be scheduled for the current power charge and what actions should be delayed after additional power charging or to wait till it can harvest more energy, for instance from its solar panels. It will also know what actions can be run while charging or harvesting energy. For instance, it will face the window that has the most sun exposure whenever it can, or simply to clean the yard during the maximum solar activity. It will touch a power charging base whenever it can to recharge, for instance when reading a book.
   11. It will know when to share power with other HRs to achieve a common task, or simply if they are running out of power. Some HRs may be harvesting energy while charging other active HRs, or simply to create a daisy-chain to keep HRs continuously powered even when they are operating in areas where they cannot harvest energy. HRs can be static or mobile wireless power charging-bases, data-center and other functions. They may be moving with the sun from east to west, to get the most sun exposure during the day. They will locate and place themselves autonomously in a home to be able to easily charge themselves and harvest the most energy in the shortest times.
   12. An HR will know how to readjust in realtime to his outside world, even when already running other actions, through his very active computer vision and MEMS/sensors, actuators.
   13. It will know when to hibernate, standby, be in active mode, and be charging power or harvesting energy. It will know when to shut down some of his parts when not needing or using them. It will know when to restart them and stop them, when to turn them off/on, what parts to charge and when, etc.
   14. Given his task and available power and his surroundings, it will know if it should walk, jump, run, fly or crawl for instance.
   15. The HR may have several locations for its MEMS/sensor cards and sensors, etc. For instance, to play a volleyball match, it will set most of his sensors in his hands/fingers, while when playing a soccer game, it will place his sensors in his legs/feet and prepare himself for the game by downloading the appropriate game-routine. The HR may have card slots to reliably add sensors/cameras in his body whenever and wherever needed the most; he may also swap parts (hands and feet) for the planned game.
   16. The HR will be able to see in all directions thanks to its computer vision, optional sensors, mobility, and the possibility to detach its parts. For instance, an HR may have two eyes in the front and sensors in the back of his head; once it detects an approaching object, it will turn his head instantly and see it. It can also have two eyes in front and two in the back. It can also detach and fly to inspect all areas that are in his surroundings or that are remote. It may send his head on top of the roof to inspect the neighborhood, while leaving the rest of his body home, sync'd with his head for instructions.
   17. An HR can interact with touch-screens the same way HBs do. To use touch-screens, an HR may wear gloves with special fingers that have conductive fingertips to provide universal touch screen compatibility or simply replace his index with one that has a conductive fingertip. The HR can also connect and control wirelessly these devices.
   18. An HR can also have the same perception that HBs have when touching objects. Indeed, an HR may have special fingers, be equipped with various sensors and LIDARs, that can differentiate between various materials, detect their ruggedness or flexibility. An HR may also synchronize with his computer vision to recognize materials by simply approaching them to his eyes, or zooming into them. The HR will then be able to differentiate between wood and iron. It can also have weighing hands so it can differentiate between two pieces of iron even if they have the same image. The hands and other parts of the body may have MEMS that can measure pressure and calculate weight from it. His fingertips may also be equipped with LIDARs that can immediately calculate and report the material constituents.
   19. An HR may also synchronize with his computer vision to detect the HB/object reaction to his touch. For instance, it will know that he has successfully turned a machine ON, or that grip of an HB did not hurt him, by simply recognizing his emotions and calculating the infiltration impact in the HB skin. For instance, a grip to help a blind man cross a street is quite different from a grip to arrest a felon. The HR will have a low impact infiltration in the blind man skin and expect gratitude, but a stronger infiltration in the felon shoulder and would expect dissatisfaction feelings such as anger.
   20. An HR will know where, how and when to touch an object, an HB, an animal, etc.
   21. An HR will also react differently to a finger tap, a handshake or an aggression. It can recognize both with his optional sensors and computer vision. It will also be able to differentiate between different types of handshakes (weak to strong) using 1) his MEMS to measure pressure, and/or 2) computer vision.
   22. The electro-mechanical capabilities of an HR may be flexibly selected and assembled so an HR can fulfill various tasks, switch in record times from a doctor to a house-keeper, from a teacher to a baby-sitter, a surgeon to a technician, a bus driver to a pilot, etc. The HR may use different types of sensor technologies, MEMS, piezo-electric devices, electronics, mechanics, etc.
   23. It can have various combined strengths such as a hammer-hand and a soft-hand. It can also use a hammer. An HR can be as sensitive to be able to lift a needle and as strong to lift a big rock.
   24. An HR can operate in light and heavy industries by simply changing his parts and updating his software and connecting with the right clouds, similarly to the parts of a vacuum to clean a carpet, a hardwood floor or a rough surface.
   25. An HR can use magnetic hands/fingertips.
   26. An HR can have a name such as Kai, Kais, Leila, etc, that he can answer to. Equipped with voice recognition, he can recognize its name when called from his HB; only the so-called HR from all HRs will answer to the HB call then. The HR naming process is similar to the DNS naming of IPs but it can be enhanced with voice/face/etc. recognition. So an HR/HB w/o being located in the same location of the called HR, can call the HR by his name and the HR will answer the call only if coming from his owner.
   27. Sensors/MEMS may be single, multiple, configured in a certain way, for instance in a hand to detect a handshake. They can recognize motion, light, pressure, speed, acceleration, time, smell, temperature, sound, etc. and will be used as needed.
   28. An HR can be resistive, capacitive, inductive, etc.
   29. An HR can sense wirelessly electricity (transformers), energy, etc.
   30. An HR can differentiate between grabbing, shaking, pointing, lifting a baby or a kid, making a fist to play box or karate, etc.
   31. An HR can sense, probe, test electricity (remote prober patent) and other parameters (environment, etc.).
   32. An HR will know how to use scooters, bicycles, motorcycles, cars, fly helicopters, airplanes, etc. He can also replace each one of these functions, for instance with wings, rollerblade feet, etc. He can add a locomotive and ally with other HRs to transport his owners.

Autonomy
1. An HR will know how to select and execute his tasks at the appropriate times, estimate the time that it will take to complete a task. It will know how to delegate, delay and share tasks. It knows how to work with his group.
2. An HR will know how to learn new tasks, and forget others, how to prioritize, etc.
3. It will know how to load and unload itself from unused tasks, it will remember where it did unload a new learnt task and restore it if needed.
4. Actions can be assembled by the interpretation of its sentences. In other words, “hand me a fork”, may be interpreted as verb=hand; a fork=an object that is associated with the image of a fork; me=who to hand the fork to, in this case the HB, the type of a sentence is an order. If a “please” is added then it will be a request. The HR may use a face grimace instead of the word “please” to indicate that he is requesting a fork. Requests and orders are interpreted differently, orders are to be executed promptly while requests are to be thought through, etc. Even when the action is executed prompted, in pipeline the HR will always have to check the sanity of the action and that it does not infringe on the moral code. The action won't be executed if it does.
5. Actions can be executed by a simple command that summarizes the wholesome of an action such as “prepare the food”. The HR will then ask if the HBs would prepare a certain receipt and propose a few given what it is available at home. The HBs may pick one or simply say “surprise me”. The HR will then act autonomously and take all the necessary actions to prepare the food, purchase what is missing, set/clean the table and wash the dishes even that it was not specifically asked to do so. Furthermore, if the HR get the same answer from the HB then it will not ask again what to prepare but it will simply inform that it will prepare a particular recipe, for instance it will say: “Lunch will be served in the terrace in half an hour”, excuse himself and will get going. If the answer of the HB was “pick one” from the proposed list of recipes instead of “surprise me”; the HR would have said: “Lunch will be served in the terrace in half an hour, we will serve a fiesta salad”.
6. An HR will know how to switch himself to autonomous mode from manual mode. For instance, when the HB asks the HR to cut the vegetables, the HR may suggest to prepare the food instead. If the HB agrees, then instead of being driven to perform every action per the HB request, it can take the lead and get it all done by itself w/o any guidance. It will intuitively complete the other tasks w/o having mentioning them to the HB such as cleaning the dishes after the HBs finish eating w/o that they would have asked for it. An action may then intrinsically provoke another single or multiple consecutive actions or cause the HR to multitask. The mind of an HR will operate as an (in)finite state machine (FSM) that will take inputs, take in account previous states and transition to other states if all the right conditions are in place. If not, it may choose to stop and ask the HB (manual mode), or carry on with resolving the issues (autonomous mode).
7. An action may be in process for a while or forever. For instance, an HR that is learning a recipe, will get done after a few seconds or less, while an HR that is leaning to be a 4 star Michelin chef, will forever be learning, but will learn how to schedule other tasks in between. Additionally, a housekeeper-HR will know how to not prepare the same thing for dinner as it prepared for lunch and when to prepare it given when the HRs have finished eating lunch, count the calories and keep a strict diet, subscribe to weight-watchers, and follow their diet regime, so an action can intuitively become a life-style, without that the HB has explicitly asked for it or that it even knew that it needed it; it will then incite them to ask for more and inspire them to want and think of more of that new feature. The FSM behavior has then become recursive and self-creative w/o any prior planning or programming. It is different from ML, as it is simply build on HB/HR interactions and exponential FSM build-up that is. to only based on what the HR is learning but on what it can learn by asking the right questions and interacting with the right people; the ML has then transition from passive to active ML. It can be guided (DL, BL) or spontaneous (SL). New FSMs will be designed on the fly.
8. The HR will know when to ask, inform, or confirm with the HB, when to work autonomously and when to stop. It will know if it should operate in free autonomous mode, always inform and confirm with the HBs, or to simply stay operating in manual mode. It will learn from the HBs habits and get used to always accommodate his needs and requests, as long as that does not violate the moral code.
9. The HR may ask for clarifications, such as how to cut the potatoes: rounds, French fries, for baking, etc.? An HR may guess that it should be fries given what it remembers from the HB preferences, and for instance, if it sees the HB preparing a hamburger. It should still inform the HB to avoid conflicts, for instance, it will say: “I think that you are preparing a hamburger, so I will cut the potatoes for French fries, let me know please if that is not okay with you” and will get going. The idea is to help as best as possible and without overloading the HBs/machines with questions.
10. An action is like a process for a computer, it can run simultaneously with other processes, in a multithread manner, sequentially or at predefined times or upon a trigger or per certain conditions. It can have a priority, multiple steps that are executed at different times, that will need teamwork and synchronization with other HRs, multiple changes of parts.
11. A standard HR will have an initial platform (SW/HW) that is equipped with the basics senses and capabilities (how to connect, how to self-protect, how to move w/o causing harm, how to speak, talk, see, etc.). The standard platform should be autonomous and capable of performing the basic tasks. It should be incremental, upgradable, reconfigurable, reprogrammable, etc. It should be intelligent and ready to learn fast from digital data or from watching others. It should be able to grow intellectually and physically to be able to perform various physical tasks, etc. It should then be equipped with AI, NI/II/GI, ML, be rugged, SWAP, agile, etc.
12. It should know the basic tasks (power itself, connect, stand, etc.), be able to adapt as much as possible to other tasks, be able to learn and grow, be able to ask for help to be able to fulfill a certain task and refuse politely and firmly certain tasks as a last resort if it simply cannot do it, such as lift a mountain.
13. An HR should know its capabilities, body, boundaries and limits at the current time and operate accordingly; it should also know how to get better, learn and improve through ML techniques. It should know also how to spontaneously learn without having been explicitly asked to do it. This type of learning is called spontaneous learning (SL) and can use all traditional ML techniques such as DL or BL (defined in this patent). For instance, it will know that the HB would like to drink coffee in a certain cup, so it will select that cup from 10s of other cups to serve coffee to the HB, when asked for the first time to serve coffee. It will simply learn HBs habits by observing them and adapt whenever possible to their needs w/o having been asked to do so. It will learn when the HB will drink a coffee and spontaneously suggest a coffee around that time, even if it never was asked to do so.
14. An HR should know what it can accomplish, prepare and upgrade to at its current state. In other words, an HR that knows how to fly but has not enough energy (power) to do it nor wings to use, won't fly but it will charge itself, equip its body with wings and then fly. The HR knows its body and what it can do through an unlimited amount of information that is available in various stored libraries and databases (cloud, public, private, personal). It knows its architecture and how to down/up grade it when needed.
15. An HR will know how to download additional software, how to purchase new hardware using bitcoin, digital wallets, cryptocurrency, block-chained digital wallets, etc. It also know how to handle financial transactions that are digitally acquired or behaviorally learnt to be digital as well. It will know how to lend, borrow equipment for his body and his group of HRs or HBs. It will know how to advertise his capabilities and market his offerings to the family, the city and others, that are for instance visible on the web and/or the HR-networks.
16. It will know how to make use of other machines whether connected or not, plan and request for additional resources. For instance, at home, a housekeeper-HR will know how to use the microwave, the dishwasher, the washer/dryer, etc. It will know also how to wash dishes if dishwasher is unavailable and how to locate a great deal on the web for it and advise the HB to purchase it, and buy it if HB accepts it, handle its delivery, install it and operate it, in a blockchain manner and all w/o HB interference, but permission if initially agreed on it.
17. HRs know how to use computers similarly to HBs, so they can use them immediately even when not equipped with connectivity hardware, because of their ability to communicate similarly to HBs. The better HRs are the ones that can communicate, connect and network.
18. It knows how to hold personal and private information of HBs, prevent its misuse promptly, and alert the HBs and if needed the authorities.
19. An HR knows how to work in a supply-chain and how to use blockchain, to gain certifications, approvals, licenses and track HBs/HRs execution and progress.
20. An HR knows how to provide the right response, and how to combine it with the appropriate facial and body expressions. For instance, it cannot laugh when delivering bad news. It should be compassionate and supportive at all times.
21. It knows how to show emotion and have an attitude when needed. Examples of emotions are happiness, anger, sadness, etc. It knows how to be negative, positive, ambitious, reserved, etc. Such capabilities are required for instance for a psychologist-HR or an actor-HR. The HR should never loose its temperament unless it is demonstrating such feeling.
22. An HR should know how to display and alternate its emotions w/o seeming unnatural or fake. For instance, it should not go from extremely sad to extremely happy instantly.
23. It is autonomously scalable
24. It knows how to react to HBs, animals, environment and weather changes, as well as emergencies, catastrophic or chaotic situations. It knows what to do first and what to prioritize and how to execute them w/o the HB. For instance, it will start by evacuating the house-inhabitants in case of emergency, and simultaneously alert the authorities and attempt to connect with other HRs to locate the issues. It will instantly multitask for emergencies and make them the most priority actions. It will know how to notify and alert. For instance, it will notify of breaking news, alert of anomalies and physically act during emergencies.
25. It will know what actions need follow-up, termination or acknowledgment, notifications, alerts, additional actions, etc.
26. It knows what it can and cannot do, because of its current limitations or because it is impossible for him to do it.
27. The HR should never be overwhelmed, because it knows what it can and cannot do in advance. If it cannot perform a task, it will simply inform and try to find a way to resolve it. If that task is impossible then it should simply refuse to do it and go back to its normal chores or to resting position if it has no other tasks to do, but will inform HB of it. Being overwhelmed is equivalent to being lost and not knowing what to do or that its FSM is in unknown state. The HR will always know what it should resolve to. It may use the word “overwhelmed”, but it will mean that it will need help to get this task done and he should follow-up by what it will do to get this issue resolved or simply concede to not being able to do it.
28. An HR should never ask for help that it does not really need, but only for what it needs; it should have a clear objective, plan, schedule and expected delivery time and a backup plan in case of unexpected events.
29. It should know how to organize, plan, ask for help, team with others, share, adapt, etc.
30. It should know how to ask for more and alert of its schedule, reschedule its tasks in case of unforeseen events (airplane delayed), prioritize and change plans if newer intelligence has been acquired (canceled meeting).
31. In case of change of plans, it should know how to notify and alert the HB, in some cases, discuss them with HBs, negotiate future actions, inform and recommend the best schedule.
32. An HR can operate autonomously in disaster and emergencies situations with its private/public network, such as Wildfire and other natural disasters
33. Blockchain: Supply-chain (Financial (FinTech), Cryptocurrency, Cybersecurity, supply-chain (blockchain), metered network data (network, cloud)). They literally can be entirely autonomous financially, functionally, intellectually, and operationally; and rather that they need our help; they will help us, as they are designed to fulfill our needs.
34. Zero-configuration high-speed wireless communication system, SW/HW platform in each HR
   1. Zero-Configuration Wireless Systems (besides computers, data-centers and servers), plug and play type
   Standard platform (IoTs and IIoTs, smart-systems, smart-cities, smart-grids, smart-manufacturing and machine design)
   Autonomous systems (ML, etc.), Robotics, Mobile systems
   1. Task routines (SW/HW, HW/SW)
   2. Notifications
   3. Scalability (# HRs)
   4. Miniaturization for light weight and easy mobility for bee-HRs for instance, HR-fingers
   5. Modularity (big-data)/HR and HR-parts automated multiplication/reconfigurability
   6. DSP technologies
   7. Autonomy
   8. High-performance, high-precision for instrumentation (TM&I), robotics, IIoTs
   9. HRs interaction among themselves and with the outside world (human-beings and other machines)
   10. (Autonomous) Network Connectivity and communication (transportation vehicles (private and/or public), connected vehicles, IIoTs, etc.), for instance for an autonomous subway transportation system, autonomous connected taxi-system, so taxis can autonomously plan and organize to resolve traffic congestions (it is not connected cars). It is about the autonomous network planning for many HRs and for a single HR (for its parts), w/o mandatory HBs interactions. Connected means connected to the internet; connected for HRs is being connected to each other and to the network of HRs/HBs/internet/etc.
   11. Highly-sustainable for long operation w/o external power supply.
   12. AZ Product line that need zero-cfg network systems for channel quick and efficient insertion and removal on the fly (hot-swap) and safely
   13. high-speed for big-data and high-speed signals
   14. high-performance DSP/compression/big-data/storage technologies
   15. Networks may be Inner-HR, local/remote WiFi 802.11 b/g/n/x, cellular (5G, etc.), bluetooth (single, mesh)
   16. Cloud (on/off-premises, public/private clouds)
   17. Adaptable
   18. zero-cfg (publicly available) network; easy insertion of channels/connection points
   19. HRs can autonomously get equipped with TM&I channels with visual mechanisms (LEDs, etc.), autonomous ch. selection, addition, removal such as HR-fingers
   20. More features detailed in other parts

Actions:
1. Type: Basic, combined/not to be combined/can be combined, elaborate, sequential, sophisticated, optimized, etc.
2. Transition: evolved to (crawl, walk, run, jump, fly), conditional (walk only on clean floors, graze on dirty floors)
3. Restricted with boundaries, certifications, guidelines, instructions, etc.
4. Analytics to calculate, estimate and inform about power consumption, resources, effects, task-sharing and execution, the changes that it needs to make, the action that it needs to take, etc.
5. The HR will have spontaneous behavior (SB) deduced from SL learnt from the HBs' habits, the society customs, etc.: Well-being actions to generate good-smell, to greet, to create good-ambiance, to plan and prepare, to entertain with live-concerts, natural dance-routines, live talks (news or other), live exercise routines, etc.
6. An HB may schedule the HR task-routines or let him do it autonomously
7. An HR may schedule autonomously their task-routines (journalist to alert of the news at the appropriate times, daily-routine: breakfast, cleaner, entertainment, worker, lunch, worker, dinner, watch TV, recharge, etc.)
8. HRs may autonomously schedule when to work individually or collectively, combine efforts, accept, refuse (and explain the reasons) tasks and how to inform the HBs of its/their progress, express doubts with face expressions, etc.
9. HRs know how to autonomously coordinate facial/body expressions, grimaces, gestures with their actions, thoughts and events.
10. HRs know how to autonomously reorganize requested tasks (by HBs for instance) by priority, their relative power consumption, most appropriate time for their execution, common sense, etc. For instance, the HR will always dust before vacuuming, emptying dishes before setting them in the dishwasher, etc, unless specifically requested from the HB to do otherwise. He may then argue his case with the HB and then if convinced, it does it. It can reject it if it does not make any sense or if it thinks that it is wrong to do so; it may alert the authorities if the task is offensive, violent or illegal. This is new feature as the HR has a mind on its own and is not there to execute only.
11. The HRs know how to multitask; two hands can run two different tasks, such as writing and typing. He can be using the head for monitoring the outside of the home and the body to display what it sees, or simply to run other chores. HB may for instance be jogging or sitting in the yard with his smartphone or headset or a finger/hand of his HR while communicating with some parts of his HR to run home-tasks. The HR can operate properly with less limps.
12. The HB may monitor and control the HR(s) at anytime through an app or simply by directly communicating with them locally or remotely; they may request that HRs inform them of every action and their progress.
13. An HR will be able to recognize an HB by facial recognition, other HRs by their serial numbers, nemoji, etc. He may call other HRs by their unique names.
14. An HR may take requests and orders only from recognized/known HRs/HBs and may ignore all others. He may give privilege communications and connectivities to various HR-groups and HBs.
15. An HR may disable others (HRs/HBs) from touching him, recognized or not.
16. An HR may limit all communications with other HBs and HRs if it has detected erroneous behavior or misconduct
17. An HR will be able to recognize his owner HB, his family HB, other HBs and HRs, follow them and work close to and with them
18. An HR may be a talking computer, with a mindset, intuitive actions and reactions. It can communicate with all HBs, animals and machines, independently of their levels of education, maturity, expertise or experience on the subject. HRs will initiate the talks if the HBs don't know how, simply by telling and suggesting and/or teaching them how to best use them.
19. Each HB may have its own HR. A group of people/animals/area may have its own HR(s). A family may share a house-keeper HR, a teacher-HR, a doctor-HR in “all in one HR” configuration that can switch functions/jobs rapidly or in a configuration where each job is fulfilled by a single HR. Combined configurations are also possible, where the news reporter, the journalist, the teacher, the spy are all combined in one.
20. An HR may have privileged access for recognized people so parents have the right to change certain HR settings, make it accept more tasks, run chores, limit kid access, etc.
21. May allow other HBs to access its network, communicate with him if they answer certain security questions.
22. May allow other HBs/guests to privately communicate with him if they answer certain security questions.
23. Other individuals will be treated as strangers so all HR communications with them will be courteous and restricted, such as greeting them and taking messages.
24. An HR will self-protect and will protect his surroundings (HBs, HRs, objects, nature, etc.)
25. The HR may power-charge other HRs, other IoTs, machines, etc., simply be a power-base to others.
26. HRs may program, reconfigure other HRs.

HR Mechanical and Materials
1. A standard HR has an anatomy that is similar to an HB's but is not limited to that shape as it can take other shapes and extend to include other anatomies and capabilities. The HR may look like an HB but it may have additional organs, parts; it may also have his organs located at different places than for the HB. For instance, his heart may be in his head, etc.
2. An HR may not have skin or plastic cover. The bars may be the bones while the PVC is the skin. The muscles are the wires, wireless contact points or sensors that allow the contact with bones at multiple locations. They may channel the power and some of the communication signals as well, in addition to the nerves, they are mostly used for the motor control. The nerves are however used for the wireless comm. etc. The muscles may have various nodules/charging contact points to charge the HR.
3. The nervous system may have various points to wirelessly connect with others (HR-parts, HRs, IoTs, etc.).
4. Their surfaces (PVC, ABS, rubber) should be cleanable with a cloth.
5. Each HR should be set with an initial, standard system configuration, rest position (to always go back to), that is reconfigurable, reprogrammable, cloud-connected to perform and run various tasks.
6. Each HR-part can be autonomous, with different levels of flexibility, strength (applied force, pressure), with various tactical contact points that have different response and reaction times. HR-parts may be replaceable, etc.
7. A typical standard HR resembles an HB; in analogous manner, an HR should have a skeleton (a set of bones), nerves, muscles, articulations, skin, brain, heart, lungs, organs, etc. Each of the HR constituents may be single, multiple or distributed throughout the body.
   1. An architecture: Sole with various architectural layers such as the spiritual, subconscious, and conscious layers.
   2. A skeleton: spine, bones, bone-articulations that are detachable. The HR will have to tilt, bend, squad, etc. Its system should accommodate such movements; various articulations, spine, muscles, etc. are then needed. The spine has articulations and extensions (ribs); its articulations are different from all other articulations (similar to HBs); its extensions allow the distribution of the HR force throughout his torso, and are crucial for his equilibrium, to execute various movements. A covered rugged skeleton that is detachable at certain locations. HR anatomy may be different from HB anatomy. Bones and articulations may be intensified in various body-parts to make them stronger.
   3. Each HR part has skin, bones (bars), articulations, motors, muscles, nerves, computing system, comm./connectivity system, control system, etc. It may also have aerodynamic system to fly as a drone.
   4. An architecture for its various movements and operations: respiratory (power) system (breathing in (consumption) and breathing out (dissipation, air exhaustion, evacuation, air circulation)), computing, networking (nerve system), communication, connectivity, security, surveillance, monitoring, control, drive, touch (tactical, magnetic, wireless (wireless power charging), wave generation, or other), storage (static and dynamic), fan/evacuation/exhaustion system, acquisition, processing, analytics, AI/II/GI/NI, ML (BL, SL, DL), muscle control system through relays and motor-control for the articulations, aerodynamic system (flying, docking, deploying), etc.
   5. Security system: Intimacy, privacy, cybersecurity, reliability, etc.
   6. Surveillance system with various inputs/outputs: detectors, LIDARS, RADARs, ears (inputs), touch, mouth (talk to output), reflex reaction if approached, etc.
   7. Touch and Contact System: MEMS (opposite of actuators (mechanical/EM/etc. action to electrical) to feel pressure), conductive fingertips (capacitive, etc.)
   8. The nerve system: networking, communication, connectivity, security, surveillance, monitoring, nerves are the electrical wires, the sensors, the wireless transmitters, the network system, etc. They will enable the detection and the sensing of others, the communication with others, the inner-network of communication, the telepathic (connectivity) network comm. system, etc. An HR may also have various comm. ports. The nerves may have several sensor/MEMS points (to sense wireless and physical touches), and comm ports.
   9. The muscles system: wires and relays. They control the bars (bones) within the HR parts that may be fixed or movable (sliding). The muscles may have several sensor/MEMS points (to sense wireless and physical touches), and contraction ports.
   10. The bones are part of the HR parts (limps) and along with the articulations form the skeleton.
   11. The articulations are the rotating disks; they are controlled by the articulation-motors. They have different sizes, different functionalities, levels of flexibility, speeds, agility, safety, etc. They should have a bone (metal)/muscle (wire, relay) articulation. The muscles are the electrical wires and relays that allow the control of the articulation-motors. Unlike for HBs, some of the articulation-motors may have no HW limitations but will be limited by SW. For instance, the knee-articulations may be able to tilt to the front in HW, but are held by SW that control angle/rotation-sensors in those motors. The motor-articulations may also be limited by HW blockers, to minimize programming and the use of sensors. The articulations should be safely and autonomously detachable to hook and unhook to both parts. When detached, each part will take its muscle(s) ((flexible, sliding) bars), mini-computer, mini-comm system, nerves, skin, etc, but will leave the articulation.
   12. The skin is not required but can be the PVC, ABS, rubber plastic material, the cushions, the airbags, the conductive touch devices, etc. Each part may be covered with the skin; various skins may be used to create various ruggedness levels. HRs may be covered with a suit of rubber material (skin) that make them softer and possibly keep them clean and protected. The skin should be breathable for fan operations. The skeleton may be covered with strong plastic material, such as thermoplastic polymers (Acrylonitrile butadiene styrene (ABS)). An HR may not have a skin.
   13. The power supply, energy harvesting and sustainability, and the ventilation systems are analogous to the combination of the heart, the lungs, the stomach and the skin. The power charging system may be wireless or through dedicated charging ports that are analogous to an HB mouth, nose and skin pores to breath-in and eat. The same ports may be used as air evacuation pores (breath-out), while other ports such as the natural digestive system of the HB may be used for evacuation of the dissipated energy that could not be consumed.
      1. The HR heart is analogous to the power supply system and its Power Management System (PMS) and will autonomously/automatically supply, regulate and supervise the power stream-lines the same way that a heart would pump and regulate the blood streams in the HB body. The power supply/PMS activities may be distributed throughout the body. The power supply is split in consumed power and dissipated power. The latter is the power needed to operate the power-supply system itself, while the former is the one that is been consumed by the HR body (organs, etc.). The energy resulting from the dissipated power will be evacuated through dedicated ports (digestive system). The HR bloodline are the power lines, while its respiratory channels are for thermal regulation that allow the HR to breath (circulate air), etc.
      2. The HR stomach is analogous to the combination of the HR batteries and its battery-management system (BMS), which can also be distributed throughout the HR body, so each HR-part may have its own battery and mini-BMS. A single BMS may also supervise the entire distributed battery system throughout the HR body. A BMS constantly monitor and supervise the battery charge levels during operation and the autonomous/automated scheduling of the battery-charging routines in realtime. The blood is similar to a voltage supply, while the oxygen is similar to a current source. The batteries are similar to the stomach that need to be constantly fed/charged and will run out of charge at a certain time if not fed again. The HR may have various charging ports for power, etc.
      3. The HR lungs are analogous to the air circulation and evacuation systems that help regulate the HB power system to avoid thermal runaways and allow energy regulation, similarly to the lungs of an HB that constantly regulate the HB breathing system and inject oxygen (current drive) in the blood stream. It is analogous to the respiratory system containing exhaustion areas for air circulation and evacuation. The HR can self-clean its own respiratory system similarly to the cleaning of an air duct system. Each HR-part may have its own battery. The lungs activities may be distributed throughout the body to cultivate and evacuate air in efficient manners. The lungs are responsible of injecting oxygen in the bloodstream, similarly to the HR power/battery system. An HR without lungs is similar to a power supply w/o current drive and energy.
      4. The skin is not required but can be made of rugged covers, such as thermoplastic polymers, PVC or Acrylonitrile butadiene styrene (ABS) materials to cover the skeleton. It may have cushions, airbags, conductive touch devices, and pores (breathing and evacuation ports), etc. Each part may be covered with skin; various skin types may be used to create various ruggedness levels and fulfill different functions. The head may have higher numbers of pores to allow air circulations and evacuations. HRs may be covered with a suit of rubber material (skin) that make them softer and possibly keep them clean and protected. The skin should be breathable for air circulations and evacuations.
      5. The charging ports: The skin pores and the mouth(s) will be respectively analogous to 1) the energy harvesting solar cells (or any other energy harvesting technique) and 2) the battery (stomach) charging ports.
   14. The brain holds the HR computer system with processor(s), memories (volatile (dynamic and for short-durations) and non-volatile (SSD, flash, etc. for longer durations)). An HR may have more than one brain. Each brain has mainly two parts: right and left. The brain activities may be distributed throughout the body, so each part or organ of the HR will have a mini-brain and may be autonomous.
      1. The brain right side will primarily handle the mechanical thinking of the HR such as the HR-AI tasks, the ML (DL and BL) that may result from the AI experience, the basic operation of the HR (muscles and nerves control) and the synchronization with most of the HR senses.
      2. The brain left side will handle the HR intuitive thinking such as the NI/II/GI/SB tasks.
   15. The organs are the various mini-computers and processors that allow autonomous operation of each part. Examples of organs are the mini-BMS/mini-PMS, the self-diagnosis, self-test, self-repair and self-maintenance engines, the ML engines. The ML engine may be distributed, so it can efficiently gather data from every part of the HR.
   16. The HR may have special exhaustion systems (similar to the digestive system of an HB) that would allow the distillation of materials.
   17. An HR may have various contact points that have different levels of sensitivities and sensibilities (different skins), different nerves and nodules of nerves (contact points).
   18. The HR-face may have ears (hearing-aids), nose (air-breathing, LIDAR, sensor, etc.), mouse (speakers, microphone), eyes (computer vision system). An HR may have a distributed acquisition and delivery system throughout his body. He may also coordinate with other IoTs, speakers, wireless microphones to broadcast, etc.
   19. An HR may have other organs/parts for decoration purposes or for additional functionality such as the aero-dynamic systems (wings, turbines, etc.), flash lights to be able to see in the dark, light a place, etc.
   20. An appearance (nemoji, face, etc.)
   21. An attitude, a personality, a job, a function/task
8. An HR should be using green technologies to ease its recycling, its upgrade,
9. The HR will be interacting, co-habitating and co-existing on daily basis with HBs and others. It should not cause a bad feeling or be abrasive or intrusive.

### Example HR-Jobs/Tasks

The next part will aim to describe an HR job; main examples are for teacher, doctor, car-giver, house-keeper, police-officer. Each HR job includes from the start the basic standard HR computing powers, networking, etc. and then is trained, learning to fulfill a particular single of multiple jobs/functions.

Keywords: HR senses (computer vision with autonomous camera control system, speech, etc.), connectivity/telepathy (cloud, IoTs, others), HR-outside world communications, AI/II/GI, ML (SL, BL, DL), autonomy, graph theories (CNN, fuzzy logic, etc.), data-science (statistics (estimation, calculation, etc.), classifications, clustering, prediction, recommendations, decision-making, NLP, remembering information, scheduling), LIDARs/RADARs/sensors/MEMS (sense, probe, touch, etc.), prediction/detection/action/reaction, mobile private/public networks, zero configuration application configuration networks independently or with minor dependance on network physical layers, autonomy, mobility, motor-control, HR anatomy (muscles, nerves, bones, skin, brain, heart, lungs, organs, etc.), recognition through all HR senses, security/safety/surveillance, training/learning, psychology (emotions, behaviors, grimaces, gestures, etc.), detachable parts, drones-like parts, swarm-type, safety, security, cybersecurity, cloud, private mobile networks, standard, incremental, scalable, upgradable, reconfigurable, reprogrammable, repair, diagnosis, test, maintenance, etc. An HR can be fully autonomous; all actions are done by HR. Distributed architecture and network (internal and external with other HRs). Internal/External: with muscles, nerves, organs, respiratory (power regulation, air/fun evacuation system), blood (power), energy sustaining and harvesting techniques, wireless smart-screen, electro-mechanical actions, mechanical strength, flexibility, adaptability, etc.
1. Teacher/Security guard

Furthermore, students are sometimes discouraged by not doing well during their first schooling days and end up thinking that certain courses, such as Math is a foreign science that is simply not for them. Offering them a teacher that is tailored to their needs, that follow their progress and education level may help resolving such issues and facilitate the constant monitoring of the student progress in school. Such teacher may work with the student to encourage him relentlessly to find what does truly interest him and what he might excel at. He will make recommendations to the parents and proceed based on their recommendations and the current educational system (the school administration) to implement the needed changes.
1. It can do all what a standard teacher would do
2. The computing system (AI/SL/GI) as well as all ML techniques; it includes the Interpreter app (book to contents)
3. Synchronize the app with the basic HR functions. For instance, the HR will be able to read the book, and will project it on a TV, its torso and point to the figures in line with its display. The HR will be able to explain a course, similarly to a teacher/lecturer HB.
4. It can use its fingertip to write, point, go through slides, etc.
5. It can perform all lecturer actions
6. It can display new writings, other that what is in the book, to explain it further (see book-content patent)
7. It can download an ebook, read it
8. It can read a physical book (not digital) in realtime (scan, interpret, understand and explain), page by page
   1. It can read similarly to an HB (no need for the HB to digitalize the book (scan it and translate it to digital format)). The HR will do it with its computer vision scanning system (OCR).
   2. It can interpret chapters instantly, summarize them and teach them in real-time. It will do a teacher job in record times.
   3. It can explain simultaneously on a screen, a white board,
   4. It can give tests to students, automated exams, quizzes, Q/A, based on the taught course and other docs, and correct them instantly
   5. It can do all the (book to contents) patent work and teach it
9. It can grab objects similarly to a teacher, etc.
10. An HB teacher can teach the Teacher-HR a course (BL); the latter will then be able to teach it to students at anytime and anywhere.
11. It can use smart pens or it can replace them with its finger pen.
12. It can multitask; it can hold a smart tablet in one hand and write on it with the other; it can hold a book in one hand and write on a white board with the other, walk in the classroom, teach (talk), etc.
13. Can move w/o hitting obstacles, recognize students, store information,
14. It knows the right information at anytime, just by connecting to the web/cloud with or w/o using a computer.
15. It can communicate wirelessly with smart device to write w/o pen. It can replace a wireless keyboard, by writing directly to a computer (speech recognition); it can write w/o talking as well.
16. It can locate and interpret text on digital screen and whatever it did write on a white board
17. A good option would be to sync a teacher with a smart screen; teacher can dictate/write/erase/point wirelessly and away from screen w/o a projector and use digital pointers to the text
18. Multiple teachers (HRs/HBs through their HRs) can collaborate offline or in realtime
19. Reproduce teacher+student relationship in real life
20. Speech+movement are sync'd
21. It can sync autonomously and wirelessly with Siri, Watson, Alexa, Google, etc.
22. It can sync with smart devices
23. An HR can read a book and display its contents (contents patent, such as its movie) in realtime on its torso or on a wireless smart-screen. In the movie case, the HR(s) can play the actors roles and voices. The HR can also explain and detail in realtime the book.
24. The teacher-HR can operate as a data/computer-center, and more, as it can connect and communicate with each machine, HBs, HRs, in the classroom, home, on the network, the web, etc. It links all of them similar to a teacher.
25. It can grab objects, talk to students, principal, other teachers, etc.
26. It can see, decide, inspect, survey exams, open/close doors, recognize objects, etc.
27. It can work close to students, teachers, move around and between them.
28. It self-protects, protects students, teachers, classrooms, etc. It can fulfill a security-guard-HR tasks simultaneously and/or alert authorities if any issue.
29. A teacher-HR can be the perfect teacher assistant
30. A teacher-HR can switch to security mode instantly if needed. It will aim to disable the threat and alert the authorities, the principal, the security guards and the police if necessary instantly.
31. It can predict harm (through 360 degrees computer vision, extra hearing/smell capabilities, connectivity with other HRs, etc.) and multiply as soon as needed. It can alert the authorities and other HRs in case it needs help to disable the threat/harm.
32. It can disable and alert about a threat faster than any HB. It can dissociate and fly to protect itself and others
33. It can distribute itself to surround danger better than a Ninja, call for help from other HRs till arrival of authorities
34. Build armor/shield for gun shots (his bones are made of metal). It can collapse in one small part and hide behind an armor.
35. The security HR can scan for weapons, even in classroom. It can detect metal
36. The security HR can detect new entrants and whether they are armed, recognize students by their faces, voices, etc., similarly to a teacher
37. An HR can deploy, plan and protect and be an asset in classrooms, schools, homes, cities, etc. The security HR is an addition to the existing security HBs. It will do what a security HB cannot do currently. It is invented for added safety. Current security systems can see harm but cannot react to it.
38. It may reduce the number of HBs to survey before approval for major actions, till maturity of the HR technology.
39. If an HR is hit, it will go off grid and other HRs will detect it instantly and come to its rescue, while alerting for help as well. All HRs, at least the master-HR can see each one of his group at all times.
40. It can detect all moving objects (see std. HR)
41. Multiple HRs may ally to disable harm and work collectively to help innocents; they can shield innocents with their armors. It is not a killing machine. It is there only to help, disable threat and alert authorities.
42. Computer vision+sensors to detect moving objects including bullets; it can be equipped with laser weaponry to automatically disable armed people, for instance by hitting them in their hands or their guns.
43. Security HRs may take various shapes such as the shape of bees so they can fly faster and blind attackers for instance. They can be hidden in a school to survey, deploy, protect when needed. They can disable the harm and have the security-HRs (in the shape of HB) or HBs arrest the attackers; a team HR may assemble quickly when a threat is detected and work collectively to disable it.
2. Doctor-HR (surgeon, doctor, assistant, nurse, medical technician, etc.): On the other hand, a new care-system that is always watching over us to provide the right support (health monitoring, etc.), alert loved ones if it senses danger to our health and take the right actions in dangerous situations (CPR).
   1. Similar concept to lecturer; great access to all web, doctor know-how, PCP, etc.
   2. HB/HR interactions per doctor-patient code; he can sense his pulse, check his breathing, run all PCP/specialist tests on him
   3. Sense all HBs locations (monitoring points), pulse, x-ray, check breathing, check O2 levels,
   4. HR may directly transfer data to other doctor-HRs, communicate it with other doctor-HBs, store data in common storage area (cloud, etc.)
   5. Run all technician actions and replace some of the machine-computer action such as breathing tests, eye doctor, laser eye reconstruction
   6. The doctor should be able to apply the right pressure w/o hurting (infiltration impact), being able to sense multiple points at once, better EKG experience. The HR may use place and leave his fingers on the patient for probing points or use wireless probers (remote probe patent).
   7. During monitoring tests (heart exercise tests for instance), the HR may be demonstrating the same test routines that he would like his patient to run.
   8. Make recommendations to doctor-HB; decide with the doctor on the right actions and act to implement them
   9. A doctor-HR can get promoted to surgeon, through ML (DL, BL, SL) or through intensive programming.
   10. A doctor-HR can be a technician, nurse, doctor all at once as well as security guard
   11. A doctor-HR can schedule appointments, run diagnoses, recommend treatment, order prescriptions, plan specialist visits, etc.
   12. A surgeon-HR can run all actions, including cleaning after the surgery (blood, etc.), planning follow-up tests, etc.
   13. A doctor-HR can connect to all hospital machines; for instance a surgeon-HR can control all machines in the surgery room, it can monitor all readings in realtime, and coordinate subsequent steps accordingly; he can for instance wirelessly prescribe and apply more anesthesia, when needed to the patient w/o leaving the patient or looking elsewhere. It can monitor heart beats, respiratory system, movement, the surgery progress, etc. It can display, inform, alert, project the VAR view on wall, and display it for instance on doctors' VR glasses. Two or multiple HRs may face each other and project the VAR view in the middle by opposing the light waves to create light stoppers for each other (TB patent). An HR may coordinate with its projected view wirelessly to zoom in/out with hand gestures that are coordinated with its computer vision system (TB patent).
   14. A doctor-HR can provide precision, accuracy, visibility, and virtual augmented reality (VAR) during the surgery. For instance, the HR will zoom in open-heart surgery to see and inspect the main issue, inspect the vocal cords during a thyroid surgery and explain what it needs to be done. The HR can be an assistant or simply run the entire surgery.
   15. It can make calls by wirelessly connecting to a smartphone or directly by connecting to cellular network. It can wirelessly call many HRs, IoTs at once.
   16. It can transport, prepare, monitor and take care of the patient w/o interruption. This may be quite useful for patients post-surgery, post giving birth to a baby, etc. The HR can provide help and healthcare assistance post surgery, home-monitoring, free more hospital rooms, relief HB personal.
   17. The doctor-HR may transfer the post-procedure monitoring routine to the home/personal-HR to carry on with the HB care procedure. All HRs understand basic language (programming language) in realtime. Each HB comms (French, English, Arabic, Spanish, etc.) will be translated to the HR language that all HRs will be able to understand.
   18. The personal-HR will then take care of updating the hospital personal (doctor) of the HB condition, progress, monitor his needs, get prescriptions, prepare food, etc.
   19. HBs and HRs can work together
   20. Nurse-HRs will plan all work before/after doctor-HBs/HRs and will alert all staff of the progress of his patient and work procedure.
   21. The entire HR health care system may be connected and communicating with the HB personal.
   22. The HR personal can operate in blockchain/supply chain manner for all task sharing, monitoring, planning and execution; the HRs can handle digital transactions through digital wallets and among themselves.
   23. HRs can record surgeries w/o having to have special planning for it, react fast and change course of the surgery instantly if needed. HR can monitor on its own the entire operation because of its extraordinary connectivity.
   24. HRs can work collectively and remotely throughout the world. For instance, an American-HR/HB can connect with another African-HR in Ebola contaminated areas, to treat a patient. HRs will be able to work in contaminated and hazardous areas, self-clean and communicate data to others (HRs, HBs, etc.) in realtime. They won't need to have or to plan in advance for vaccines, pre or post treatment, to wait till vaccine takes effect. They will self-clean. They can deploy instantly in contaminated areas w/o having to wait for HBs safety preparations or for a vaccine to be found.
   25. They will be able to operate autonomously; they can complete the entire procedure and will inform of the procedure progress and record the sessions for offline or realtime verification by HBs. HR autonomy and offline recorded sessions are useful in remote locations where the connection to the public network is unavailable or unreliable. The HR will know how to work with an HB in assistive manner and how to take over in autonomous mode.
   26. An HB can instruct an HR in realtime on what to do directly or indirectly (through his HR). A doctor-HB may ship his HR programmed with the right routine to run the right surgery.
   27. HRs know how to prepare procedure required tools (for surgery or other), clean and sterilize them before and after using them. It can recognize, differentiate them through its computer vision and classify them. It can detect contamination, using its LIDARs and operate to remove it, report on it and get insights on how to clean it if they don't know how (new virus for instance).
   28. It can monitor relentlessly contaminants while being mobile, to cover more area. A mobile DHR (distributed HR) can move from one location to another autonomously to inspect entire hospital with multiple rounds for contaminants. It can periodically run environmental testers, driven by HBs or autonomously.
   29. The HR may be able to transport the patient. He may be able to ally with other HRs/HBs to lift patients.
   30. The HRs can weigh (using weigh MEMS) and measure (using computer vision) patient and plan help from other HRs if it cannot lift him.
   31. An emergency HR can instantly recognize the medical situation of the patient. It can help provide the right CPA in record times, detect broken bones to decide on the best way to transport the patient, fix displaced broken nose instantly, etc. It can use x-ray machines and have part of the x-ray machine in his scanning computer vision system or other parts of his body.
   32. An emergency HR can fly directly to the accident location with the right urgent care equipments.
   33. It can fulfill many jobs at once: emergency, security, policeman, nurse, technician, doctor, surgeon, health care financial agent, etc.
3. The House-Keeper
   1. It knows how to disinfect, scrub, purify areas (contaminated, dirty, etc.). It knows how to dust, vacuum
   2. It can wash with waterproof hands/body. It can use cleaning cloth and soaps to dust and clean.
   3. It knows how to target an object; for instance, it knows how to pour water without spilling, to measure and use a glass, differentiate between water and glass, recognize an empty, partially full and overflown glass of liquid, hand the glass to a patient, etc. For instance, it knows how to sense the water level (w/o necessarily seeing it), using LIDAR in its fingertip. It can push the fingertip further in the glass to sense the level of approaching water when filling a glass. It can also recognize the water level with computer vision, by taking multiple consecutive pictures and decoding them to know where it is pouring water in the glass. The same would apply when emptying a glass of water.
   4. It can recognize all of its environments by seeing them, taking consecutive pictures or videos, analyzing them to differentiate HBs from objects, etc and in realtime. It knows how to understand their actions, by decoding their movements' angles, positions, directions, etc. It can recognize the shape of HBs, animals, most objects, etc. It can recognize most movements, such as running, walking, twisting, etc. Each recognized movement will be learnt for future use (BL).
   5. It knows how to sync his parts to perform a given task; such as holding a vacuum, vacuuming, etc. It knows how to measure, hold, use, tilt, decide what angle it should be at, etc.
   6. It knows how to recognize and avoid dirt; it knows how to recycle, to differentiate objects and to classify them for future use.
   7. It knows how to use existing machines, such as vacuum, washer, etc. It knows how to connect to their IoT parts if available. If the HR is connected to the home network in addition to its HR-network, it will automatically find and learn how to use the home IoT devices. It can use them wirelessly (through bluetooth for instance).
   8. The HR will know how to operate non-connected devices, similarly to HBs. It will know how to turn them off/on.
   9. The HR can work with an HB to clean a home, a workspace, the city streets, etc. Also, it can autonomously work solo or with other HRs, machines, etc. It knows how to recognize dirt, a dirty space, etc. If such environment is detected, it will schedule, plan and work towards cleaning it; it can be guided by an HB to do it and/or do it autonomously.
   10. A cleaner-HR can be programmed and taught by HB to perform cleaning tasks. The HR can then store them for future use. It can learn further on its own by watching HBs, TV channels, searching the web for the best procedures to clean a surface for instance.
   11. Idem for cooking, the HR can learn how to buy groceries, cook, set the table, serve and clean afterwards.
   12. The HR knows how to recognize, prepare food and measure its calories; it knows how to prepare food.
   13. It can understand ingredients and prepare them, such as spices, types of pasta, etc. It can remember and cook spicy or mild food; it can cook medium rare and well done steaks. It can calculate its level of spiciness per the amount of food. It knows how to calculate time, portions, etc. It can recognize the time when it should start cooking, stop and when to remove food in case there is an error in the recipe, by knowing how to taste with its LIDAR finger, smell, and see.
   14. It can quantify food, weigh food, using weighing machines or with its hands. It can clean itself at anytime.
   15. It can interpret food recipes, and cook per their guidelines.
   16. The house-keeper HR can make use of all of its senses such as its acute computer vision, object-classification, recognition, monitoring. It can adapt to its environments (new home for instance) instantly again through computer vision, sensors, MEMS, etc. It can learn indefinitely and in case overloaded, it can reorganize its memory to adapt to new situations.
   17. It knows the basic home-chores, city garbage collector tasks, etc.
      1. Such tasks may be object-grabbing, handling, recycling, dusting, vacuuming, cleaning kitchens and bathrooms (washing sinks, toilets, etc.), preparing the bed, etc.
      2. It can recognize and measure space geometries (walls, chairs, tables, piano, etc.).
      3. It can use the fridge, the stove, the washer and the dryer, etc. It knows how to do the laundry, prepare the food, etc. It can do it relentlessly or only when the level of detected dust/dirt/mess has reached a certain limit.
      4. It knows how to minimize using other machines such as the kitchen timer, as it has its own. It knows how to turn a lamp or use its own, etc.
      5. It knows how to chop, cut, peel, etc. It knows how to use the trash w/o spreading germs, etc.
      6. It knows show to use a user guide, how to get and download it from the internet, how to interpret it and follow it. It knows how to assemble and disassemble objects (for instance new cabinets) per user guide.
      7. It knows how to hold clothes with two or multiple fingers.
      8. It knows how to rearrange home per a certain configuration; it can replace misplaced objects/furniture/dishes. It can autonomously select a new configuration (remodeling). It can remodel the home on daily basis.
      9. It knows how to dissociate every sophisticated movement to basic movements. For instance, filling a glass will mean to 1) grab a clean empty glass, 2) measure its size and shape, 3) place the glass under the faucet at the right distance, 4) turn on the faucet, 5) detect the water pouring speed and the water level continuously and 6) turn off the faucet when the water level reaches a certain level in the glass or a predefined amount. Each of the previous actions can also be dissociated into basic tasks, such as lift hand, twist faucet, etc. Each of these actions can initially be programmed and/or taught. So, the HB may say, “learn how to twist faucet” and demonstrate how to do it; the HR would then learn and store it for future use. The HR can then build and continuously update its database and library of actions.
      10. The house-keeper is one of the most tedious jobs as it will mean that the HR has to move in close proximity to and around HBs in unforeseen and continuously changing spaces. Most of the actions may be unpredictable and the HR should be able to react to them on the fly with its computer vision system, sensor and radar technologies, etc. The HR will have to learn how to operate without jeopardizing the HB comfort zone. It will mean that it should walk when it can, and avoid it when it cannot. In the latter case, it may opt to wait, climb a wall/fly/use another longer route if it cannot, or simply ask for permission to pass through.
      11. The HR will learn how, where and in what direction to apply the right pressure/force
      12. The HR knows also what not to do, what it cannot do and if it has to reject a task if for instance it cannot ally with other HRs to do it. In the latter case, it will explain the reason for its rejection to the HB, for instance: “it is too heavy for me, I need your help lifting it”.
      13. The HR will know how to act autonomously without bothering the HB for each task. It will know how to build its know-how over time, so it can gain further autonomy with time and learn how to optimize its time for future tasks.
   18. The HR will always go back to rest and safe position after completing its task while having the basic security alert on.
   19. The HR can always communicate with the HB even when in the middle of a task, w/o loosing track of things or being distracted.
4. City-Inspector/Contractor/Seller/homeowner: for home/workplace-inspection and city permits
   1. The HR can run all needed inspections (electricity, plumbing, sewage, ventilation, construction, etc.).
   2. It can issue permits to start construction work; it can validate them if passing inspections. If not then it will explain the reason for it not passing, make recommendations on how to fix it and then issue official response with guidelines for future steps. It can work in blockchain manner (from architectural plans to plumbing to electricity to sewage till job completion) till it can issue a permit and take records of each step and get the team paid in cash or digitally (digital wallets, bitcoin, etc.).
   3. It can (re)draw, generate automated architectural plans of existing homes as it can recognize and measure walls, spaces, rooms, bathroom, pipes, see through walls for electric wires (x-ray), by knocking on walls to detect studs, etc.
   4. In a blockchain manner, it can generate new architectural plans from user-guidelines and requests, and exiting spaces. It can propose as many layouts as needed per customer request w/o additional costs. It can legalize them at the city building department and get permits for contractors to start and follow them till they get done.
   5. Automated home designs from existing or from new generated architectural plans for renovation or remodeling reasons till the best design has been attained. It can automatically detail steps, signal errors, provide guidance to contractors and issue plans. It can recommend repairs, alert of when they are needed. It can automatically take in account new inputs, recursively redraw the plans for updates in record times, and issue permits. All steps can be issued in a blockchain manner and with minor inputs from user, relentlessly and w/o being overwhelmed by the (un)foreseen tasks or additional delays but for the officer signatures if they are required by the city HB officials. It will result in cost savings as the architect/city officer job can be paid once, as most of the planning will be done by the HR.
   6. Automated drawings with or w/o assistance from HB.
   7. City-inspector-HR may schedule visit home to finalize its job, w/o the need for HBs.
   8. They all need computer vision, object recognition through efficient computing vision and object classification, such as garbage collection for plastic recycling.
   9. The homeowner-HR can plan all tasks for his home innovation and relief homeowner from task-planning and scheduling. It can gain full autonomy or work with each individual in a blockchain manner to get permits, certifications, plans, schedules, contractors, etc. It can select autonomously the most suited contractors to complete the job such as the suppliers to deliver the home-materials and equipments, the best dates to arrange for the interviews (city checkups) w/o any HB interference but while informing them at each step of its progress. The homeowners/contractors/city-officials can interfere at each step and make new requests and adjustments to the process. The HR can also make all adjustments, make recommendations, similarly to a program manager or a general contractor. It can sync with the web searches, etc. It can make all payments with digital wallets, bitcoin, crypto-currency, in a blockchain manner to automate and regulate the home construction business.
   10. The same process can be applicable in chip design process, manufacturing, packaging, production tests, marketing, sales, with each step from beginning till end being monitored and controlled (VDC patent). It can be applied also in hospitals, cities, countries with most life aspects are monitored and controlled by HRs.
   11. IoT meters for car parking, static HR: remote reservations, remote alerts to car owners to add money if their parking time will soon expire. Parking monitors can be used to monitor cars for security and safety with cameras; car owners can pay for additional protection. They can face-recognize and talk to a person and ask if they would like to pay their parking time, w/o having to enter a credit card or swipe, and for how long, if they need the monitoring protection, the alerts to the owner-HB and to the police in case of an issue or etc. The personal HR can also handle all parking transactions for the HB. An HR that works for the city may also arrange all transactions for the entire street, so a driver can park its car and sync with the city-HR through its phone notifications or through its HR his parking time; in other words, there will be no need for parking meters, the mobile-HRs will handle all transactions and will circulate around to charge drivers for their parking time; it alert them if they exceeded their time. An HR can take the shape of a bee. Instead of looking for parking, the personal HR can synchronize with the city-HR to find the best spot through location services to park the HB car; the HR won't have to do any thing then other than say how long it would like to stay and where it needs to go. The HR will do the work and the HB will simply drive its car to the recommended location selected by the HR. In the case of connected cars, the HR will do it all.

Social Impacts: With the HRs, seniors will be able to stay in their homes while having all the care that they need at affordable costs. It should be cheaper for them to purchase an HR then to necessarily move to a nursery. The HR will also help them stay connected with the rest of the world (their family, neighbors, etc.) and gain back their autonomy and freedom of movement. The HRs can be monitored by the HB care-givers or the HBs themselves. They are not there to permanently replace an HB care-giver but to help whenever possible and take over when an HB care-giver is simply not available. With growing populations, such HR may be very needed and appreciated so all elders can get all the help that they need and that HB care-givers cannot simply fulfill. HRs are usually employed to fulfill a need that is simply not served or badly executed in our society usually because of the lack of human and/or financial resources.

Additional Specifications
27. A new type of robotic machine, called herein Human-Robots (HR), that is agile, autonomous, and intelligent and that can run most of the human-beings actions and tasks and function as a human-being (HB), an animal, a vegetation, a machine, etc.
   1. An HR may take various shapes in realtime of offline,
   2. An HR may be detachable, in realtime or offline
   3. An HR may be equipped with a similar anatomy to an HB, an animal and/or the like
   4. An HR may have all of the HB senses, organs, anatomy, actions, emotions, feelings and/or the like
   5. An HR may have a combination of body-parts that may be human, animal-like
   6. An HR may be used for scientific, engineering, medicinal, healing and/or the like purposes
   7. An HR may combine machinery and human-parts
   8. An HR may combine various technologies
   9. An HR may have a standard electric/electromechanical/mechanical SW/HW system with basic functionalities
   10. An HR may have a programmable and reconfigurable platform that is driven, controlled and monitored by an SDK and/or GUI
   11. A standard HR platform may be modular, expandable, re-shapable, modified, pliable, scalable and distributed.
   12. An HR may belong to a group and organize in a society. An HR group is part of a DHR (Distributed HR)
   13. An HR may be private, secure, safe, connected, networked, communicative, social, and independent
   14. An HR may have every being/vegetation/natural qualities
   15. An HR may be a handicap,
   16. An HR may look like other beings, with similar or different anatomies
   17. An HR may have multiple organs (brains)
   18. An HR may be employed and have a wage. It may grow to fulfill a single or multiple job-functions individually and/or collectively with other HRs.
28. An HR may mimic human, animal and vegetation senses, such as human vision, touch, smell, sound detection, and/or the like
29. An HR may have extended and limitless senses/actions/capabilities, based on their extended connectivity to the internet and other connected devices (HRs, IoTs, data-centers, and/or the like).
   1. They may see/touch objects, hear sounds, and/or the like that are outside of their vision sights, hearing ranges, and/or the like using their remote connectivities.
   2. They may see from all directions and all of their surroundings (front, back, sides, top, beneath them), at anytime and from any angle.
   3. They may hear from a selective and/or all of their frequency and amplitude spectrums
   4. An HR may have telepathic capabilities through connectivity; it may communicate (see, speak, touch, and/or the like) with another HR on the other side of the world as if they are in the same room
   5. An HR may predict and foresee future events before getting to a site by connecting to other HRs that are already onsite
   6. An HR may predict in realtime the movement and the trajectory of a moving HB, animal or other, given its calculated speed, mass and the current environmental conditions
   7. An HR may notify and alert others (HRs, HBs, machines, and/or the like) of upcoming events
   8. An HR may have extended and limitless capabilities through connectivity (distributed, routed, networked and bridged) with added mobility for flexible configurations, resulting in extraordinary predictive technologies
   9. An HR may have psychic capabilities based on its capacity to sense and feel remote objects. By being able to sense further, sooner and faster than anyone, HRs may predict outcomes before that they can physically sense them or being at their geographical perimeters.
   10. HRs may track an object/HB/event/etc. by synching various distributed object detection and recognition-HRs with their analytical systems for instance to track an event, criminals, a parade, friends, family members, and/or the like, in realtime.
   11. HRs may follow an object/HB and/or the like from point A to pint B by means of connected, distributed and mobile HRs. They may combine their information realtime and retrace the detected eject trajectory with or w/o discontinuities.
   12. An HR may know the past, the present and the future of all stored and/or to be stored information
30. An HR may combine its (extended) senses/actions/capabilities, with computerized/electronic/optical/electromechanical and/or the like capabilities, such as facial, image, sound, tone, gender, object, emotion, movement and/or the like recognitions such as predictive capabilities of environmental conditions
31. An HR may combine/coordinate and synchronize various parts of its senses with its detectors (motion, light, gas, smoke, and/or the like) to detect an event before seeing it.
   1. An HR may see smoke by sensing/detecting the gas chemical constituents first, then zooming its cameras on its location.
   2. An HR may be awaken from its various detectors to use its senses
32. An HR may be distributed in time and space.
   1. An HR may distribute its parts in various locations and be in sync with all of them
   2. An HR may collect information in realtime or offline from different parts of its body and/or other HR
   3. An HR may be part of a distributed group; a distributed group may be local or remote with VPN access. An HR group, community, workforce or society may have various temporary or permanent privileges. An HR that is a member of an HR-group may remain remotely connected through VPN access to a local DHR-group.
   4. An HR may enter and exit an HR-group (DHR) at anytime and anywhere. An HR may schedule his connectivity times and plan ahead his tasks and jobs.
   5. An HR may seek/reject connectivity and/or communication with others.
   6. An HR network may be inner (between its parts), local (within a group that is geographically local (within the range of connectivity)), remote (connected through other routers, with or w/o special privileges with VPN).
   7. A DHR group may serve as a mobile network system that can adapt autonomously and on the fly to a population dynamics and connectivity needs
   8. An HR/DHR network may be local, remote, private, and/or public, dynamic and/or a combination of all cases
33. An HR may be equipped with different types of equipment at different locations, times and occasions.
   1. HR may be equipped with replaceable, detachable parts, with detectors, radars, LIDARs, IMUs (Inertial Measurement Units), microelectromechanical systems (MEMS)/nano-electromechanical systems (MEMS) equipments, various radio-frequency (RF) & microwave switches (electro-mechanical, solid-state, MEMS-based), linear actuators, cameras, accelerometers, gyroscopes, sensors, transducers and actuators and/or the like.
   2. An HR may sample and decode consecutive images from various angles and videos to detect and decode movements. An HR may take multiple camera snapshots to detect a movement, with controllable-speeds and angles to reduce collected data amounts relatively to videos. An HR may detect a sound with variable sampling times, to not overload its memories. Most beings are slower than the speed of light; videos are not always necessary.
   3. An HR may sense and measure various energies: mechanical (force, pressure, velocity, acceleration, position), thermal (temperature, entropy, heat, heat flow), Chemical (concentration, composition, reaction rate), radiant (electromagnetic wave intensity, phase, wavelength, polarization, reflectance, refractive index, transmittance), magnetic (field intensity, flux density, magnetic moment, permeability), electrical (voltage, current, charge, resistance, capacitance, polarization) and/or the like.
   4. An HR may be guided programmatically, verbally, with gestures/signs, sounds and/or the like. An HR may move, navigate, follow a route, programmatically and/or autonomously.
34. An HR may move in all directions guided, programmatically and/or autonomously with 360 degrees and detachable, and free-movement articulations
35. An HR is equipped with self-maintenance, self-diagnosis, self-test, self-repair, self-power (energy harvesting techniques, self-power management), self-conditioning, self-plan, self-protection, self-taught, self-behave, etc.
   1. An HR is equipped with self-recognition, self-docking in realtime or offline
   2. An HR or an HR-part may be drone-like, classified and recognized by HR, self-tested as an internal or a separate part
   3. An HR may touch and be touched by means of wireless sensor and physical MEMS and actuators
   4. An HR physical reshaping may be automated and/or autonomous, through touch (wireless or physical), or through communications (CAD tool part of the HR-GUI)
   5. An HR shape may be drawn on the GUI and transferred in realtime to the HR so it can reshape itself
36. An HR may have different sets of behaviors and autonomy that follow certain regulations
   1. Finite State Machine (FSM) behavior: An HR takes into account the HR previous/current state, potential states and the current state, inputs, outputs and the predictive states if it decides to execute a specific action, the analytics of the action possible outcomes and the calculation of the best outcome at that instant and historical data to decide on a most appropriate action (behavior/move/gesture and/or the like).
   2. An HR may be equipped with behavioral-learning (BL) engine from simply watching others to specifically learn
   3. An HR may be equipped with spontaneous learning (SL) (spontaneous BL)
   4. An HR may be equipped with Intuitive Genuine Intelligence (II/GI), natural intelligence (NI) that is complementary to AI
   5. An HR may communicate with all beings, vegetation and all machines (even the non-connected ones) using the HR-HB-like senses. An HR may communicate similarly to other beings using their gestures, languages and/or the like.
   6. An HR does not require digital connectivity to communicate with others
   7. An HR may communicate as any other being and/or digitally
   8. An HR may learn digitally, on the internet or from its surroundings by observing their behaviors/gestures and listening to them, watching TV, listening to radio, and/or the like.
   9. An HR is operational even when not connected to the internet, the network and/or the like, using its own intelligence. He may speak every language and dialect
   10. An HR may be exclusive (no connections to the outside world) and/or inclusive (keen to digital information).
   11. An HR may download his job tasks and routines from the cloud on daily basis and then disconnect from the network before starting his job to keep private and remain secure at all times. It may go off-grid at anytime and/or remain connected only with his close HRs.
   12. An HR may be part of an independent routed HR-networks (private, public, hybrid)
   13. An HR may be a router-HR, dedicated to connect and bridge out of range HRs and/or buffer their communications
37. An HR may be equipped with zero configuration for assembly and connectivity
   1. For its parts: HR can autonomously assemble its parts for every job (electric hands, strong hands, standard of fast legs, wings, etc.). The HR body will recognize and connect autonomously (physically and wirelessly) the needed parts. HRs will assemble its parts, use other tools and reshape itself, the same way we dress up for work, training, etc. It will put on its wings if it needs to fly, its strong hands if it needs to lift boxes, its fast legs if it needs to run, and/or the like.
   2. With other HRs and IoT devices (Face/DNA recognition, one for all/all for one: one HR can connect all HRs in its group, with Zero-Configuration) for multi-tasking and multi-sharing
   3. HRs may recognize people that it has never met (through social media portfolio, photos, etc.) and pull their information on the fly (may be used to track wanted people).
   4. An HR may connect with zero configuration within static or mobile networks independently of their physical network infrastructures
   2. Distributed HR (DHR) mobility with continuous connectivity that can be clustered in 1) close-proximity, 2) expanded and 3) using medium routers. 1) close-proximity: HRs may assemble to run high-speed or big-data comms, 2) expanded: spread to execute their tasks autonomously while still being connected and in range, 3) using routers to allow a single or multiple HRs to leave the group (defined by the master-range and (slave-HR)-(slave-HR) range if the latter comms are allowed).
   3. HR self-recognition w/o SSID/password, simply through face recognition (HB photo, (n)emoji or DNA (SN #), etc.), security questions, secret code (gesture, sign, etc.), etc.
   4. Optimization connected HR topography taking in account (relative) proximities, organization chart (who is who, master, router, slave, etc.), moving locations, HR distribution, tasks. HRs will keep their relative positions and look for each other to not leave network unless pre-authorized from master. All HRs or a designated HR (master or router) will be notified of each HR position, define resolution of movement.
   5. Optimization of cluster HR configurations, multi-tasking, and multi-sharing. HR as part of a group (DHR), HR as an individual (a single unit), HR as a collection of parts (inner network). Each HR in the group knows each of the group-HRs capabilities. Each HR can use and work with another HR/HR-part locally or remotely.
38. An HR understands group-work, tracking systems and may operate in a blockchain manner (supply chain, digital wallets, etc.)
39. An HR may have a privacy, safety, security and cybersecurity guideline that is standardized with various criticality levels. An HR may be open with standard open communications, secure (professional-like) or critical (high-security level).
40. An HR may use various energy harvesting and sustaining schemes and power charging designs
   1. An HR may use daisy-power or routed-power charging (wireless or physical), inner distributed power, power-distribution between HR parts and between HRs or HR-HR power charging for multi-sharing and multi-tasking
   2. An HR may be a power-charging-HR that can be used to recharge other remote HRs
41. An HR may use mixed-reality and be a virtual-HR [5, 6], virtual objects/views/HBs and/or the like combined with physical reality
42. An HR may have full autonomy. An HR does not need to be powered, it can harvest energy for its self-power; it does not need to be connected, it can communicate without it; it does not need maintenance, it can take care of itself; it does not need teaching, it can learn on its own, etc.
43. An HR may be a wearable-HR, similarly to a suit or a part of it that is equipped with sensors, MEMS, and/or the like such as an astronaut suit
44. An HR may be a health-monitor attached to a smart-cart, or a smart-bee/butterfly that monitors food, purchases, and budget
45. An HR may be a personal, professional, residential, commercial, business and/or the like of identification/certification device.
   1. It may store, operate and function as the manger of or a worker at the certified entity. It may operate as the entity manager with an address (real or virtual), run financial/judicial and all sort of transactions (human and/or digital).
   2. An HR may be employed and have a wage. It may run financial transactions (human and/or digital). It may collect money from customers in cash and/or digitally.
   3. It may advertise the entity merchandise, take purchase-orders, and proceed with orders.
   4. It may detect proximity of subscribed HRs to their business (virtual-HRs on smart-devices or real HRs) and launch special advertising campaign with personal or general promotions and retail options, notifications and alerts.
   5. An HR
46. An HR may be a System on a Switch (SoS) that is static or mobile.
   1. An SoS may include light, virtual-assistant, speakers, microphone, IoT-devices (environmental-detectors), surveillance, safety, privacy system and other features that is all-in-one typical light switch or electricity plug.
   2. An SoS-HR can be removable and may take various shapes and have several receptacles.
   3. It may be connected to the cloud, the internet, smart-devices and/or the HRs

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A robotic machine, called herein Human-Robots (HR), comprising:
a standard electrical/electromechanical/mechanical SW/HW system/platform that is capable of running basic and standard predefined tasks and/or functions;
a programmable and configurable platform that is driven, controlled and monitored by a single or multiple application-based GUI(s);
equipped with a single or multiple Software Development Kit (SDK) to adapt, upgrade and/or modify the HRs application-based user-interfaces (UI) or GUIs;
taking various shapes in realtime and/or offline that may be human, animal and/or machine-like;
combining various and several senses, body-parts organs, anatomies, actions, emotions, feelings and/or the like that may be human, animal and/or machine-like;
detaching and reattaching its network-connected parts;
combining various computer, cloud and/or network technologies;
being modular, expandable, re-shapable, modifiable, pliable, scalable and/or distributed;
belonging to a group and organizing in a community or society individually or in a distributed HR (DHR) manner;
being private and/or publicly accessible, secure, safe, connected, networked, communicative, social, and independent;
having some or every being/vegetation/natural qualities, features and characteristics;
operating with missing and/or additional parts, and/or change functionality mode in realtime or offline;
resembling other beings, with similar or different anatomies; and
being employed with or without a wage, to fulfill a single or multiple job-functions individually and/or collectively with other HRs.

2. The HR of claim 1, further comprising;
having human, animal and vegetation like senses, such as human vision, touch, smell, hearing, and/or the like;
having extended (connected) and limitless senses/actions/capabilities, using their extended connectivities to the internet and other connected devices (HRs, IoTs, data-centers, and/or the like);
being able to see/touch/sense objects, hear sounds, and/or the like that are outside of their sight seeing and/or hearing ranges, and/or the like, using their remote and network connectivities;
being able to see and detect their surroundings from all directions, from a given set of angles or all directions;
being able to hear from a selective and/or all of their frequency and amplitude spectrums;
having telepathic capabilities through their network connectivities to communicate, see, speak, touch, and/or the like, with other HR(s) that are geographically remote (outside of sight);
predicting and foreseeing events, before getting to a site by connecting to other HRs that are already onsite;
notifying and alerting others (HRs, HBs, machines, and/or the like) of upcoming events;
predicting in realtime the movement and the trajectory of a moving target, given its calculated speed, mass and the environmental conditions;
employing predictive technologies with extended and limitless sense and network capabilities through various HR-configuration and connectivity schemes;
tracking an object/HB/event and/or the like by synching various distributed object detection and recognition-HRs and/or other connected devices with their analytical, navigation and mapping systems;
following virtually and/or physically a moving target and/or the like from departure to arrival locations by communicating with connected, distributed and mobile HRs and/or connected devices; and
knowing the past, the present and predicting the future of all stored and/or to be stored information by exchanging information with connected, distributed and mobile HRs and other connected devices.

3. The HR of claim 1, further comprising;
combining/coordinating and synchronizing various parts of its senses with its detectors (motion, light, gas, smoke, and/or the like) to detect an event;
combining and enhancing an HR (extended) senses/actions/capabilities, with computerized/electronic/optical/electromechanical and/or the like capabilities, such as facial, image, sound,
tone, gender, object, emotion, movement and/or the like recognition technologies to predict, analyze and comprehend an event;
sampling and decoding multiple consecutive images, snapshots from various angles and/or videos to detect and decode movements; and
sensing and measuring various types of mechanical, thermal, radiant, magnetic, and/or electrical energies and/or the like.

4. The HR of claim 1, further comprising;
modifying its architecture/system with various types of equipments at different locations, and times;
replacing, detaching and adding parts given his needs;
being guided programmatically, verbally, with gestures/signs, sounds and/or the like;
moving, navigating, following a route, guided, programmatically and/or autonomously;
moving in all directions using its detachable, and free-movement articulations; and
using and/or integrating parts that may be drone-like.

5. The HR of claim 1, further comprising;
employing self-maintenance, self-diagnosis, self-test, self-repair, self-power, self-conditioning, self-plan, self-protection, self-taught, and/or self-behave protocols and technologies and/or the like;
employing self-recognition, and/or self-docking technologies;
classifying, categorizing and recognizing its parts, other parts belonging to other HRs, beings and/or machines by means of object detection and recognition methods; and
employing automated and/or autonomous physical reshaping techniques, through touch (virtual and/or physical), and/or by employing CAD tools as part of the HR app-based GUIs.

6. The HR of claim 1, further comprising;
using various power charging designs and configurations (daisy-chain or networked);
using various energy harvesting and sustaining technologies, and power charging designs;
distributing power/energy between HRs and HR-parts using daisy-power and/or networked-power charging techniques;
using power/energy distribution for multi-sharing and multi-tasking; and
operating as a power-charging-HR to recharge other HRs.

7. The HR of claim 1, further comprising;
creating, displaying, projecting and/or broadcasting virtual-HR(s) from its original form and/or the combination of other HRs, HBs, animals, vegetation, objects, nature and/or the like; and
using mixed-reality technologies to combine virtual-HR(s) with physical and/or virtual entities and/or the like.

8. The HR of claim 1, further comprising;
operating as a wearable-HR that can cover parts or the entirety of an HB/animal/object and/or the like.

9. The HR of claim 1, further comprising;
being a personal, professional, residential, commercial, business and/or the like of identification/certification device/agent;
operating at a physical or virtual address;
run financial/judicial/business and all sort of transactions (human and/or digital).

10. An HR that is autonomous, intelligent and self-learner, comprising;
being mobile, autonomous, connected and intelligent to execute a single or a combination of various actions and tasks, and to function as a single or a combination of human-being(s) (HB), animal(s), vegetation(s), or other machine(s);
operating in full autonomy with and/or w/o outside intervention;
harvesting energy for its self-power;
communicating with and/or without connectivity (human and/or digital);
connecting and/or disconnecting freely and/or autonomously;
self-maintaining;
self-teaching, self-learning and/or the like of autonomous tasks using various machine language methods;
performing different sets of actions and functions while being guided, programmatically, and/or autonomously and following a predefined set of rules and regulations;
implementing a Finite State Machine (FSM) behavior guideline allowing an HR to take into account its previous/current/potential/predictive states, actual inputs and/or outputs, to select the most suitable action to execute;
predicting and analyzing the possible outcomes of various HR actions in realtime and historical data to decide on the most appropriate actions to take;
employing behavioral-learning (BL) technologies to purposely learn from simply watching and/or listening to others and/or the like;
being equipped with spontaneous learning (SL) (spontaneous BL) to learn spontaneously w/o being explicitly pre-programmed to do so, and by self-coding itself to add new tasks;
learning from its surroundings such as HBs, HRs, machines and/or other beings by observing their behaviors/gestures and listening to them, watching TV, listening to radio, and/or the like;
being equipped with Intuitive Genuine Intelligence (II/GI), natural intelligence (NI) that is complementary to AI;
communicating with all beings, vegetation and all machines (even the non-connected ones) using the HR-like communication skills and senses;
communicating similarly to other beings using their gestures, languages and/or the like;
communicating similarly to any other HB, with gestures, verbally and/or digitally by means of connected devices;
learning through connectivities to the internet, other HRs and/or other connected machines;
being fully-operational even when not connected to the internet, the network and/or the like, using its own on-premise intelligence;
speaking and understanding a given and/or every language and/or dialect; and
being exclusive (no connections to the outside world) and/or inclusive (connected to the internet, other connected devices and/or the cloud to access additional digital information).

11. The HR of claim 10, further comprising;
understanding group-work;
teaming with others such as HBs, animals, machines, connected devices and/or the like;
tracking moving objects and navigating its way; and
operating in a blockchain manner.

12. The HR of claim 10, further comprising;
following a privacy, safety, security and cybersecurity guidelines that are standardized with various criticality levels; and
being open with standard open communications, secure (professional-like) or critical (high-security level).

13. A distributed HR system, called herein DHR, comprising:
allowing HRs and/or HR-parts to communicate, network, socialize and/or multitask privately, publicly, locally and/or remotely (out-of-range);
distributing and/or deploying HR parts (legs, brains, and/or the like) and/or multiple HRs that are part of a DHR in time and space;
collecting and analyzing information from different parts of its body and/or other HRs;
being part of a distributed group that may be local and/or remote with VPN access and/or the like;
being part of a community, workforce and/or society that may have various temporary or permanent privileges;
entering and/or exiting an HR-group (DHR) at anytime and anywhere;
scheduling and/or planning ahead an HR or a DHR connectivity times, tasks and jobs;
seeking/rejecting connectivities and/or communications with others;
forming a HR/DHR network that may be local, remote, private, public and/or hybrid, static and/or dynamic and/or a combination of the previously-mentioned network options;
equipped with various networks that may be inner (between its parts), local (within a group that is geographically local (within the range of connectivity)), remote (connected through other routers, with or w/o connectivity privileges);
serving as a mobile and reconfigurable network system that can adapt autonomously and on the fly to a population dynamics and connectivity needs;
forming an independent routed HR-networks from all other networks;
assigning various tasks to HRs to function as master/slave/task/power/router-HRs, to connect and bridge “out-of-range” HRs and/or buffer HRs' communications; and
connecting to static or mobile networks independently of their physical network infrastructures, using router-HRs if needed.

14. A DHR of claim 13, further comprising:
moving with continuity or intermittent connectivities to a DHR, in close-proximity (locally) and/or in remote manner using router-HRs or bridge-HRs;
moving without connectivity to a DHR (independently);
assembling in close-proximity to share tasks such as exchanging high-speed and/or big-data;
spreading and expanding to execute their tasks autonomously while still being connected and in range through router-HRs and/or independently (with no connectivity to a DHR);
recognizing other HRs using various detection and recognition techniques, security codes, and/or the like;
optimizing the topography of their connectivities by calculating their relative proximities, accounting for their organization charts, destinations, paths, assigned tasks and/or the like;
notifying HRs of other HRs' positions, speeds, destinations, tasks and/or the like; and
optimizing cluster HR-configurations, multi-tasking, and/or multi-sharing.

15. A DHR of claim 13, further comprising
being equipped with and/or w/o special configuration for assembly and connectivity, autonomously, programmatically and/or guided, comprising;
assembling its parts;
recognizing, assembling, connecting its parts;
reshaping its configuration, organization charts, tasks and/or the like;
connecting to other HRs for multi-tasking and multi-sharing, through various detection and recognition technologies (face, serial number, and/or the like); and
recognizing people by researching from the HR on/off-premise databases and pulling their information from their social media portfolio, photos, and/or the like.
